(19) United States
(12) Patent Application Publication
(10) Pub. No.: US 2007/0026344 A1
(43) Pub. Date: Feb. 1, 2007

(54) Infrared-sensitive planographic printing plate precursor

(75) Inventor: Noriaki Watanabe, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/494,600

(22) Filed: Jul. 28, 2006

(30) Foreign Application Priority Data
Jul. 28, 2005 (JP) 2005-219601
Sep. 20, 2005 (JP) 2005-272816
Sep. 27, 2005 (JP) 2005-280829

(51) Int. Cl. G03C 1/00

(52) U.S. Cl. 430/270.1

(57) ABSTRACT

The present invention provides an infrared-sensitive planographic printing plate precursor including: a support; a recording layer on one surface of the support, which recording layer contains a water-insoluble and alkali-soluble resin, an infrared absorber and a long-chain alkyl group-containing polymer, and is capable of forming an image by infrared irradiation; and a back coating layer on the other surface of the support, which back coating layer contains an organic polymer and has a thickness of 0.3 μm or more.

### CROSS-REFERENCE TO RELATED APPLICATION

This application claims priority under 35 USC 119 from Japanese Patent Application Nos. 2005-219601, 2005-272816 and 2005-280829, the disclosures of which are incorporated by reference herein.

### BACKGROUND OF THE INVENTION

1. Field of the Invention

The present invention relates to an infrared-sensitive planographic printing plate precursor. In particular, the invention relates to an infrared-sensitive planographic printing plate precursor which suppresses abrasion of a photosensitive layer when stacked.

2. Description of the Related Art

Laser technology has been highly developed in recent years, and in particular, with respect to solid lasers and semiconductor lasers which have a light emitting region from near infrared to infrared, high output and small size lasers are readily available. In particular, in the field of planographic printing, as a light source for exposure when a printing plate is made directly from digital data of computers, these lasers are very useful.

A recording layer in a positive-type planographic printing plate precursor for such direct plate-making using an infrared laser contains, as essential components, an alkali-soluble resin, and an infrared absorber which absorbs light and generates heat. In an unexposed area (image area), this infrared absorber acts as a dissolution inhibitor to substantially reduce the solubility of the alkali-soluble resin by interaction with the alkali-soluble resin. In an exposed area (non-image area), the generated heat weakens the interaction between the infrared absorber and the alkali-soluble resin, whereby the resin is dissolved in an alkali developer to form an image. However, in this positive-type planographic printing plate precursor, mechanical strength of the recording layer is not sufficient. As a result, when the recording surface thereof and other members are strongly contacted at the time of manufacturing, transportation or handling, defects are generated on the recording surface, whereby missing portions are generated in the image area after development.

In order to alleviate such a problem, planographic printing plate precursors are usually packaged with interleaving sheets therebetween. However, since interleaving sheets have the problems of 1) increase in cost, and 2) disposal of the interleaving sheets, an “interleaving sheet-less” process using no interleaving sheets is desired. In particular, recently, along with the spread of computer-to-plate (CTP) systems, more and more exposure apparatuses are equipped with a printing plate (precursor) autoloader. Accordingly, in order to avoid problems such as the troublesome work of extracting interleaving sheets manually in advance, and abrasion due to rubbing caused when extracting interleaving sheets in a case where an automatic interleaving sheet extracting mechanism is provided, demand for an interleaving sheet-less process has considerably increased.

As a technique directed to an interleaving sheet-less process, it is known to apply a surface treatment on the back surface of a support so as to alleviate mechanical damage to a photosensitive layer resulting from contact between the photosensitive layer and the back surface of the support.

For example, a recording material for offset printing having a radiation-sensitive layer and an organic polymer-containing back coating layer has been described, which material is provided with a back coating layer containing a pigment such as silica gel and an organic polymer having a glass transition temperature of at least 35° C. and thereby allows stacking without interleaving sheets (Japanese Patent Application Laid-Open (JP-A) No. 2002-46363). However, in the case where an inorganic pigment such as silica gel is contained in a back coating layer, there is a problem that, when products which have been stacked and packaged without using interleaving sheets are transported, since the hardness of the inorganic pigment is high, abrasion due to rubbing is easily caused on a photosensitive layer.

Alternatively, a technique of providing a matte surface on a side opposite to a photosensitive layer side by electrostatic spraying has been proposed (for example, see JP-A No. 2003-63162). It is described that stacking without interleaving sheets becomes possible. However, according to this construction, in the case of stacking and storing without interleaving sheets, adhesion between plates occurs in some cases, particularly under high humidity conditions such as in summer. In addition, since a support surface has been subjected to hydrophilization treatment, there is a problem that, when attempting to provide a matte surface directly on the support, a matte surface-forming material tends to be completely evenly spread on the support due to hydrophilicity of both the support surface and the matte surface-forming material, so that it becomes difficult to effectively form a satisfactory matte surface.

Further, a photosensitive planographic printing plate wherein a back coating layer including at least one resin selected from the group consisting of a saturated copolymerized polyester resin, a phenoxy resin, a polyvinyl acetal resin and a vinylidene chloride copolymer resin, having a glass transition temperature of 60° C. or higher, is provided on a side opposite to a photosensitive layer side (for example, see JP-A No. 2005-62456), and a photosensitive planographic printing plate wherein a back coating layer having a coarse surface is provided on a side opposite to a photosensitive layer side (for example, see JP-A No. 2002-254843) have been proposed.

However, with respect to a photosensitive planographic printing plate having a back coating layer including an organic polymer such as polyester, it has been found that, when an autoloader for automatically feeding printing plates to a laser exposure apparatus is used without interleaving sheets, abrasion is easily caused on a photosensitive layer due to rubbing, in the case where the autoloader has a structure in which a photosensitive layer and a back surface are pressed against each other. Also, in the case where a back coating layer having a coarse surface is provided on a side opposite to a photosensitive layer side, it has been found that, when stacking is performed without interleaving sheets and a photosensitive layer is contacted with a back surface of a support, sufficient mechanical strength is not necessarily obtained, so that abrasion is easily caused in the photosensitive layer.

### SUMMARY OF THE INVENTION

The present invention has been made in view of the above circumstances and provides an infrared-sensitive planographic printing plate precursor (hereinafter, simply referred to as “planographic printing plate precursor” in some cases).

A first aspect of the invention provides an infrared-sensitive planographic printing plate precursor comprising: a support; a recording layer on one surface of the support, which recording layer contains a water-insoluble and alkali-soluble resin, an infrared absorber and a long-chain alkyl group-containing polymer, and is capable of forming an image by infrared irradiation; and a back coating layer on the other surface of the support, which back coating layer contains an organic polymer and has a thickness of 0.3 μm or more.

A second aspect of the invention provides an infrared-sensitive planographic printing plate precursor comprising: a support; a recording layer on one surface of the support, which recording layer contains a water-insoluble and alkali-soluble resin and an infrared absorber, and is capable of forming an image by infrared irradiation; and an organic polymer layer on the other surface of the support, which organic polymer layer contains a long-chain alkyl group-containing polymer and an organic polymer that is different from the long-chain alkyl group-containing polymer.

A third aspect of the invention provides an infrared-sensitive planographic printing plate precursor comprising: a support; a recording layer on one surface of the support, which recording layer contains a water-insoluble and alkali-soluble resin and an infrared absorber, and is capable of forming an image by infrared irradiation; and an organic polymer layer on the other surface of the support, wherein the precursor comprises a matte surface on at least one of a surface of the recording layer and/or a surface of the organic polymer layer.

### DETAILED DESCRIPTION OF THE INVENTION

The planographic printing plate precursor of the first aspect of the invention is an infrared-sensitive planographic printing plate precursor comprising: a support; a recording layer on one surface of the support, which recording layer contains a water-insoluble and alkali-soluble resin, an infrared absorber and a long-chain alkyl group-containing polymer, and is capable of forming an image by infrared irradiation; and a back coating layer on the other surface of the support, which back coating layer contains an organic polymer and has a thickness of 0.3 μm or more.

The recording layer in the planographic printing plate precursor of the first aspect of the invention is provided by dissolving a long-chain alkyl group-containing polymer, and a polymer compound which is not compatible with the long-chain alkyl group-containing polymer, in a coating solvent, coating the solution on a support, and drying this. In this process, it is considered that, while the coating solvent is removed in the drying step, phase separation occurs between the long-chain alkyl group-containing polymer and the polymer compound due to non-compatibility originally possessed thereby, the long-chain alkyl group-containing polymer is self-aggregated in the recording layer to form fine particles, and fine projections made of the fine particles are formed on a recording layer surface. In the first aspect of the invention, it is considered that since such fine projections reduce frictional force on a recording layer surface, stress which causes scratching abrasion or rubbing abrasion (abrasion stress) is relaxed.

A polymer containing a long-chain alkyl group which forms fine projections as described above is considered to be a relatively soft polymer, and when the hardness of a member giving abrasion stress is low, sufficient abrasion resistance is obtained with the aid of stress relaxation resulting from the member itself. However, in the case of a member having high hardness, relatively weak force can reach the limit of stress relaxation resulting from deformation of the fine projections. For this reason, there is concern that abrasion may be caused on a recording layer surface when planographic printing plate precursors are stacked and packaged without using protecting paper (interleaving sheets) therebetween (hereinafter, referred to as “interleaving sheet-less packaging” in some cases), and a recording layer surface and a support back surface having high hardness are contacted, for example, during long distance transportation.

However, in the first aspect of the invention, it is considered that, by providing a back coating layer which has a thickness of 0.3 μm or more and contains an organic polymer on a support back surface, the hardness of the support back surface becomes lower than that of an aluminum surface having no back coating layer, the stress is relaxed, and the abrasion resistance of the recording layer is dramatically improved in conjunction with the aforementioned effect exerted by the recording layer according to the first aspect of the invention.

The planographic printing plate precursor of the second aspect of the invention is an infrared-sensitive planographic printing plate precursor comprising: a support; a recording layer on one surface of the support, which recording layer contains a water-insoluble and alkali-soluble resin and an infrared absorber, and is capable of forming an image by infrared irradiation; and an organic polymer layer on the other surface of the support, which organic polymer layer contains a long-chain alkyl group-containing polymer, and an organic polymer that is different from the long-chain alkyl group-containing polymer.

In the second aspect of the invention, it is required that the precursor has an organic polymer layer on a support at a side opposite to a side having a recording layer.

The organic polymer layer contains, as essential components, a long-chain alkyl group-containing polymer, and an organic polymer that is different from the long-chain alkyl group-containing polymer as a base polymer contained in the organic polymer layer.

As the organic polymer, a polymer which is not compatible with the long-chain alkyl group-containing polymer is suitably used. On the other hand, the long-chain alkyl group-containing polymer is a polymer which easily undergoes self-aggregation.

In the second aspect of the invention, the precursor has an organic polymer layer on a support at a side opposite to a side having a recording layer, and the organic polymer layer contains a long-chain alkyl group-containing polymer and an organic polymer that is different from the long-chain alkyl group-containing polymer. Therefore, both polymers cause phase separation from each other and the long-chain alkyl group-containing polymer (organic matte surface-forming agent) is self-aggregated, whereby fine projections are formed on an organic polymer layer surface, resulting in the excellent effects of the second aspect of the invention.

Hereinafter, a polymer constituting fine projections formed on a surface of a plate such as a long-chain alkyl group-containing polymer is referred to as an “organic matte surface-forming agent” in some cases.

The second aspect of the invention is based on the following study and finding by the present inventor.

The organic polymer layer in the planographic printing plate precursor of the second aspect of the invention is provided by dissolving a long-chain alkyl group-containing polymer, and an organic polymer which is not compatible with the long-chain alkyl group-containing polymer in a coating solvent to obtain a coating solution, coating the coating solution on a support, and drying. It is considered that the long-chain alkyl group-containing polymer and the organic polymer are both dissolved in a coating solvent in a coating solution, but while the coating solvent is removed in the drying step after coating, phase separation occurs between the long-chain alkyl group-containing polymer and the organic polymer due to non-compatibility originally possessed thereby, the long-chain alkyl group-containing polymer is self-aggregated in the organic polymer layer to form fine particles, and fine projections made of the fine particles are formed on an organic polymer layer surface.

In the second aspect of the invention, it is considered that, frictional force is reduced when such fine projections and a recording layer surface are contacted, and thus stress which causes scratching abrasion or rubbing abrasion (abrasion stress) is relaxed when planographic printing plate precursors are stacked.

In addition, it is considered that a long-chain alkyl group-containing polymer constituting the fine projections is a relatively soft polymer. Accordingly, it is considered that when the fine projections and a recording layer are contacted, stress relaxation resulting from deformation of the fine projections is also obtained, and thus sufficient abrasion resistance is exhibited.

The planographic printing plate precursor of the third aspect of the invention is an infrared-sensitive planographic printing plate precursor comprising: a support; a recording layer on one surface of the support, which recording layer contains a water-insoluble and alkali-soluble resin and an infrared absorber, and is capable of forming an image by infrared irradiation; and an organic polymer layer on the other surface of the support, wherein the precursor comprises a matte surface on at least one of a surface of the recording layer and/or a surface of the organic polymer layer.

In the third aspect of the invention, the precursor has a matte surface on a recording layer surface and/or an organic polymer layer surface. Due to the presence of this matte surface, fine projections are formed on a layer surface. It is considered that the fine projections relax stress which causes scratching abrasion or rubbing abrasion (abrasion stress) when planographic printing plate precursors are stacked. In addition, it is considered that when the matte surface is formed of a resin, stress relaxation resulting from deformation of the fine projections is also obtained, and thus sufficient abrasion resistance is exhibited.

In the infrared-sensitive planographic printing plate precursor of the third aspect of the invention, it is essential that the precursor has a matte surface on at least one of a recording layer surface and/or an organic polymer layer surface.

From a viewpoint of prevention of plate lifting in setter exposure, it is preferable that a matte surface is provided on a recording layer surface.

Herein, “to have a matte surface” means to have fine projections formed of a matte surface-forming material on a layer surface. Hereinafter, these fine projections are referred to as “matte” in some cases.

By having such a matte surface on a recording layer surface and/or an organic polymer layer surface, stress can be relaxed which is exerted on a contact surface between a recording layer and an organic polymer layer when planographic printing plate precursors are stacked without interleaving sheets.

Details of each element constituting the planographic printing plate precursor of the invention will be successively explained below.

[Matte Surface]

The “matte surface” in the third aspect of the invention will be explained below.

In the third aspect of the invention, from a viewpoint of exerting the aforementioned effects, it is preferable that fine projections (matte) formed of a matte surface-forming material satisfy the following respective conditions.

A diameter of the fine projection formed of a matte surface-forming material is preferably in a range of 0.1 to 50 μm, more preferably in a range of 0.5 to 20 μm, further preferably in a range of 1.0 to 10 μm.

A diameter of the fine projection means a diameter in a width direction (planar direction). As a method of measuring this diameter, generally, there is a method of measuring diameters of particles present on a surface by observation with an optical microscope or an electron microscope, and calculating an average thereof. That is, the diameter of a fine projection referred to herein is obtained by measuring diameters of a plurality of fine projections projecting on a recording layer surface, and taking an average value thereof.

A density of the fine projection formed of a matte surface-forming material is preferably in a range of 1 to 1000/mm², more preferably in a range of 5 to 700/mm², further preferably in a range of 10 to 500/mm².

As a method of measuring this density of fine projections, for example, a method using a three-dimensional roughness measuring apparatus with an analyzing device (manufactured by Kosaka Laboratory Ltd.), or a method of observation using an electron microscope or a metal microscope may be used.

A height of the fine projection formed of a matte surface-forming material is preferably in a range of 0.1 to 20 μm, more preferably in a range of 0.5 to 10 μm, further preferably in a range of 1.0 to 7 μm.

Examples of a method of measuring a height of a fine projection include a method of measuring a height of a projection by observing a cross-section of a planographic printing plate precursor with an electron microscope, and a method of measurement using an atomic force microscope (AFM).

In the third aspect of the invention, examples of the factor for controlling the diameter, the density and the height of the fine projections include the kind of the matte surface-forming material, the matte surface forming method, and the condition of controlling the pressure and the humidity after matte surface formation.

It is preferable that the fine projection formed of a matte surface-forming material is formed, mainly, by the following two methods.

That is, (1) a method of applying fine liquid droplets of an aqueous solution or an aqueous dispersion of a resin (matte surface-forming material) to a layer surface, and drying this, and (2) a method of applying a fine solid powder (matte surface-forming material) to a layer surface, and heating (fusing) this.

The methods (1) and (2) will be explained more specifically.

In the method (1), a desired resin is dissolved or dispersed, and the resulting liquid is applied to an objective layer surface, for example, using a spray coating method such as air spray, airless spray, electrostatic air spray, and electrostatic coating method using an electrostatic atomization manner, a gravure coating method, or a coating method using a coating roller having irregularities.

At this time, when the spray coating method is used, fine liquid droplets are locally applied to a layer surface. Thereafter, by drying the liquid droplets, fine projections can be formed.

Alternatively, when the coating roller having irregularities is used, a layer having a suitable thickness is formed in advance, and, by rolling the coating roller having irregularities on the layer, a coated film shape depending on the irregularities is obtained, and, by drying this, fine projections can be formed.

In the method (2), a fine solid powder is applied to an objective layer surface using a scattering method such as a pressurized air supplying method, a powder supplying method, an ejector method, a distributor method, or a cyclone method, or an electrostatic powder coating method.

Like this, by using a scattering method or an electrostatic powder coating method, a fine solid powder is locally applied to a layer surface. Thereafter, by heating the fine solid powder, the layer and the powder are fused to form fine projections.

A matte surface-forming material used in the methods (1) and (2) will be explained. As the matte surface-forming material in the third aspect of the invention, it is preferable to use various resins from a viewpoint of relaxation of stress at a contact surface between a recording layer and an organic polymer layer.

In particular, it is required that the matte surface-forming material, if applied to a recording layer surface, can be removed with a developer. Inter alia, a resin which can be dissolved in a developer or removed by peeling is preferable.

Examples of such a resin include gum arabic, glue, gelatin, casein, celluloses (e.g. viscose, methylcellulose, ethylcellulose, hydroxyethylcellulose, hydroxypropylmethylcellulose, carboxymethylcellulose etc.), starches (e.g. soluble starch, modified starch etc.), polyvinyl alcohol, polyethylene oxide, polyacrylic acid, polyacrylamide, polyvinyl methyl ether, epoxy resin, phenol resin (in particular, a novolak-type phenol resin is preferable), polyamide (e.g. polyamides which are soluble in an alcohol having 1 to 6 carbon atoms such as methanol, ethanol, isopropanol, butanol, t-butanol, acyl alcohol, and hexanol), and polyvinyl butyral.

These resins may be used alone, or two or more kinds thereof may be used together.

Alternatively, as the matte surface-forming material, an aqueous liquid resin may be used. Examples include the copolymers described in Japanese Patent Application Laid-Open (JP-A) No. 57-34558 (Japanese Patent Application No. 55-109984) such as copolymers of acrylic acid ester and acrylic acid or methacrylic acid; copolymers of styrene, acrylic acid ester, acrylic acid or methacrylic acid; copolymers of acrylic acid ester, styrene or acrylonitrile with acrylic acid or methacrylic acid, maleic acid, or itaconic acid; vinyl polymers such as polyvinyl alcohol, polyvinyl acetate, and polyvinylpyrrolidone.

Alternatively, as another aqueous liquid resin, latex of copolymer of vinylidene chloride and acrylic acid ester or acrylic acid, latex of copolymer of vinyl chloride and vinyl acetate or styrene, latex of styrene-butadiene copolymer, or water-soluble polymer of maleic anhydride and acrylic acid ester may be used.

Further, as the matte surface-forming material, if necessary, in addition to the aforementioned resins, a hydrophobic polymer compound may be used. As this hydrophobic polymer compound, for example, polybutene, polybutadiene, polyamide, unsaturated copolymerized polyester resin, polyurethane, polyurea, polyimide, polysiloxane, polycarbonate, epoxy resin, chlorinated polyethylene, alkylphenol-aldehyde condensed resin, polyvinyl chloride, polyvinylidene chloride, polystyrene, acryl resin and copolymer resin thereof, hydroxycellulose, polyvinyl alcohol, cellulose acetate, and carboxymethylcellulose are suitable.

Examples of a suitable hydrophobic polymer compound include copolymers which usually have a weight average molecular weight of 10 thousand to 200 thousand and contain, as constitutional units, the following monomers (M1) to (M12).

(M1) Acrylamides, methacrylamic acid, acrylic acid esters, methacrylic acid esters and hydroxystyrenes having an aromatic hydroxy group, for example, N-(4-hydroxyphenyl)acrylamide or N-(4-hydroxyphenyl)methacrylamide, o-, m- and p-hydroxystyrene, and o-, m- and p-hydroxyphenyl acrylate or methacrylate;

(M2) Acrylic acid esters and methacrylic acid esters having an aliphatic hydroxy group, for example, 2-hydroxyethylacrylate or 2-hydroxyethylmethacrylate;

(M3) (Substituted) acrylic acid esters such as methyl acrylate, ethyl acrylate, propyl acrylate, butyl acrylate, amyl acrylate, hexyl acrylate, cyclohexyl acrylate, octyl acrylate, phenyl acrylate, benzyl acrylate, 2-chloroethyl acrylate, 4-hydroxybutyl acrylate, glycidyl acrylate, and N-dimethylaminoethyl acrylate;

(M4) (Substituted) methacrylic acid esters such as methyl methacrylate, ethyl methacrylate, propyl methacrylate, butyl methacrylate, amyl methacrylate, hexyl methacrylate, cyclohexyl methacrylate, octyl methacrylate, phenyl methacrylate, benzyl methacrylate, 2-chloroethyl methacrylate, 4-hydroxybutyl methacrylate, glycidyl methacrylate, and N-dimethylaminoethyl methacrylate;

(M5) Acrylamides or methacrylamides such as acrylamide, methacrylamide, N-methylolacrylamide, N-methylolmethacrylamide, N-ethylacrylamide, N-ethylmethacrylamide, N-hexylacrylamide, N-hexylmethacrylamide, N-cyclohexylacrylamide, N-cyclohexylmethacrylamide, N-hydroxyethylacrylamide, N-hydroxyethylmethacrylamide, N-phenylacrylamide, N-phenylmethacrylamide, N-benzylacrylamide, N-benzylmethacrylamide, N-nitrophenylacrylamide, N-nitrophenylmethacrylamide, N-ethyl-N-phenylacrylamide and N-ethyl-N-phenylmethacrylamide;

(M6) Vinyl ethers such as ethyl vinyl ether, 2-chloroethyl vinyl ether, hydroxyethyl vinyl ether, propyl vinyl ether, butyl vinyl ether, octyl vinyl ether, phenyl vinyl ether;

(M7) Vinyl esters such as vinyl acetate, vinyl chloroacetate, vinyl butyrate, and vinyl benzoate;

(M8) Styrenes such as styrene, methylstyrene, and chloromethylstyrene;

(M9) Vinyl ketones such as methyl vinyl ketone, ethyl vinyl ketone, propyl vinyl ketone, and phenyl vinyl ketone;

(M10) Olefins such as ethylene, propylene, isobutylene, butadiene, and isoprene;

(M11) N-vinylpyrrolidone, N-vinylcarbazole, 4-vinylpyridine, acrylonitrile, and methacrylonitrile;

(M12) Unsaturated sulfonamides, for example, acrylamides such as N-(o-aminosulfonylphenyl)acrylamide, N-(m-aminosulfonylphenyl)acrylamide, N-(p-aminosulfonylphenyl)acrylamide, N-[1-(3-aminosulfonyl)naphthyl]acrylamide, and N-(2-aminosulfonylethyl)acrylamide; methacrylamides such as N-(o-aminosulfonylphenyl)methacrylamide, N-(m-aminosulfonylphenyl)methacrylamide, N-(p-aminosulfonylphenyl)methacrylamide, N-[1-(3-aminosulfonyl)naphthyl]methacrylamide, and N-(2-aminosulfonylethyl)methacrylamide; acrylic acid esters such as o-aminosulfonylphenyl acrylate, m-aminosulfonylphenyl acrylate, p-aminosulfonylphenyl acrylate, and 1-(3-aminosulfonylphenylnaphthyl)acrylate; and methacrylic acid esters such as o-aminosulfonylphenyl methacrylate, m-aminosulfonylphenyl methacrylate, p-aminosulfonylphenyl methacrylate, and 1-(3-aminosulfonylphenylnaphthyl)mathacrylate.

Further, monomers which are copolymerizable with the aforementioned monomers may be further copolymerized.

Further, those obtained by modifying copolymers obtained by copolymerization of the aforementioned monomers, for example, with glycidyl acrylate or glycidyl methacrylate are also exemplified.

These hydrophobic polymer compounds may be contained in formed fine projections in an amount of 50% by mass or smaller, and preferably in an amount of 30% by mass or smaller from a viewpoint of adherability to a surface to be coated (organic polymer layer surface or recording layer surface) and solubility in a developer.

In addition to these resin materials, for the purpose of imparting flexibility to a matte (fine projection) or adjusting slidability, a plasticizer and a surfactant, and other additives may be used in combination, as necessary. Examples of the additives include fillers of inorganic powders such as carbon black and colloidal silica, and lubricants of fatty acids or fatty acid esters, or fats and oils.

Further, for the purpose of controlling tight adherability, strength or electrification property, other additives may be used.

As the plasticizer which is an additive, phthalic acid esters such as dimethyl phthalate, diethyl phthalate, dibutyl phthalate, diisobutyl phthalate, dioctyl phthalate, octylcapryl phthalate, dicyclohexyl phthalate, ditridecyl phthalate, butylbenzyl phthalate, diisodecyl phthalate, and diallyl phthalate, glycol esters such as dimethylglycol phthalate, ethylphthalylethyl glycolate, methylphthalylethyl glycolate, butylphthalylbutyl glycolate, and triethylene glycol dicaprylic acid ester, phosphoric acid esters such as tricresyl phosphate, and triphenyl phosphate, aliphatic dibasic acid esters such as diisobutyl adipate, dioctyl adipate, dimethyl sebacate, dibutyl sebacate, dioctyl azelate, and dibutyl maleate, polyglycidyl methacrylate, triethyl citrate, glycerin triacetyl ester, and butyl laurate are effective.

The plasticizer is added in such a range that a glass transition point of a whole fine projection is not 20° C. or lower, and this is approximately 30% by mass or smaller based on the resin.

The surfactant which is an additive is desirably added for the purpose of improving slidability, coated surface state, and adherability with a support.

Examples of a preferable surfactant include anionic, cationic, nonionic and amphoteric surfactants.

The aforementioned resins and the optional additives are used as components in an aqueous solution or an aqueous dispersion in the method (1), or as components in fine solid particles in the method (2).

An aqueous solution or an aqueous dispersion used in the method (1) is prepared as follows.

That is, resins are appropriately selected, and dissolved or dispersed in water by a conventionally known method to obtain an aqueous solution or an aqueous dispersion. A solvent used herein may contain an organic solvent which does not dissolve a recording layer or an organic polymer layer in addition to water as a main component.

In addition, in the case of an aqueous dispersion, like a conventional method of synthesizing a latex, a method of emulsifying raw material monomers in water with a surfactant, and performing emulsion polymerization using a polymerization initiator such as potassium persulfate to prepare an aqueous dispersion may be used.

Further, in the case of an aqueous solution, a part of acrylic acid, methacrylic acid, maleic acid or itaconic acid may be converted into a sodium salt, a potassium salt or an ammonium salt to obtain an aqueous solution.

The above-obtained aqueous solution or aqueous dispersion is preferably applied for a method of electrostatically adhering fine liquid droplets tb a layer surface and drying this. As the electrostatically adhering method, an electrostatic coating method using electrostatic air spray or an electrostatic atomization manner may be used.

Like this, by electrostatically adhering liquid droplets, fine projections can be uniformly formed on a layer surface.

The step of forming a matte surface as explained above is preferably performed as early as possible in order to effectively suppress occurrence of abrasion on a recording layer or an organic polymer layer during manufacturing steps. In view of simplicity in manufacturing, it is preferable to form a matte surface on an organic polymer layer and/or a recording layer immediately after formation of both of an organic polymer layer and a recording layer.

[Recording Layer]

In the invention, when a recording layer has a multi-layered structure, a layer situated nearest to a support in the recording layer is referred to as “lower layer”, and a layer situated furthest from a support is referred to as “uppermost layer”.

(Recording Layer in the First Aspect of the Invention)

A recording layer used in the planographic printing plate precursor of the first aspect of the invention is a layer which can form an image by infrared irradiation, and may be any of a monolayer or a multi-layered structure. In the case of a monolayer-type recording layer, the recording layer contains a water-insoluble and alkali-soluble resin, a long-chain alkyl group-containing polymer, and an infrared absorber. In the case of a multi-layered-type recording layer, the recording layer has a multi-layered structure which can form an image by infrared irradiation, comprising a lower layer containing a water-insoluble and alkali-soluble resin, and an uppermost layer containing a water-insoluble and alkali-soluble resin and a long-chain alkyl group-containing polymer, and at least one of the lower layer and/or the uppermost layer contains an infrared absorber.

A recording layer in the first aspect of the invention contains a long-chain alkyl-containing polymer which can perform phase separation from a polymer compound (preferably, a water-insoluble and alkali-soluble resin) contained in a coating solution, to form projections on a most superficial surface.

The long-chain alkyl-containing polymer is dissolved in a coating solvent together with other polymer compounds in a coating solution, but in a drying step after coating, with removal of a solvent, the polymer is phase-separated from other components, and self-aggregated to form projections on a most superficial surface. Therefore, fine projections made of this long-chain alkyl group-containing polymer is different in both of the process for preparation and physical property from previous surface projections which is formed by adding a fine particle dispersion of inorganic particles, metal particles or organic particles to a coating solution, and in particular, the fine particles (fine projections) have an advantage that adherability with a polymer compound constituting a matrix is excellent.

The Fine projections present on a recording layer surface in the first aspect of the invention can be easily confirmed by observing a recording layer surface with a microscope.

An average particle diameter of fine particles which form surface projections is preferably 0.05 μm to 50 μm, more preferably 0.1 μm to 20 μm, more preferably 0.3 μm to 10 μm. When the average particle diameter is smaller than 0.05 μm, there is concern that formation of irregularities on a recording layer surface may be insufficient, and the effect of improving abrasion resistance may not be sufficiently obtained. On the other hand, when projections exceeding 50 μm are present, there arises fear that resolution of a printed matter and adherability with a lower layer are reduced, and there is a possibility that particles present near a surface is easily removed with an external stress, and uniformity is deteriorated.

Examples of a method of measuring an average particle diameter of surface projections include a method of measuring diameters of particles present on a surface generally by observation with an optical microscope or an electron microscope, and calculating an average thereof. That is, an average particle diameter of fine particles referred to herein is obtained by optically measuring a plurality of particle diameters of fine particles made of a long-chain alkyl group-containing polymer projecting on a recording layer surface, and taking an average value thereof.

A height of a fine projection present on a recording layer surface is preferably 5.0 nm to 2000 nm, more preferably 10 nm to 1000 nm, most preferably 20 nm to 800 nm.

Examples of a method of measuring a height of a surface projection include a method of measuring a height of a projection by observing a cross-section with an electron microscope, and a method of measurement using an atomic force microscope (AFM). In addition, it is preferable that a fine projection is softer as compared with a smooth part, and this hardness can be measured using a hardness meter.

In the first aspect of the invention, examples of an factor for controlling a particle diameter and a height of a fine projection made of a long-chain alkyl group-containing polymer existing on a recording layer surface include polarity of a long-chain alkyl group-containing polymer, polarity of a polymer compound to be used in combination, an addition amount of each component, the kind of a coating solvent, other additives contained in a recording layer, and drying condition (temperature, time, humidity, pressure etc.).

For example, as a difference in polarity between a long-chain alkyl group-containing polymer and a polymer compound having no compatibility to be used in combination grows greater, a particle diameter of a fine projection grows larger and, by elevating a drying temperature and shortening a time necessary for drying, a particle diameter of a fine projection is reduced.

It is preferable that a long-chain alkyl group-containing polymer in the first aspect of the invention is a long-chain alkyl group-containing polymer containing, in a composition ratio range of 20 to 99 mol %, a vinyl monomer having a carboxyl group.

Herein, a long-chain alkyl group in a long-chain alkyl group-containing polymer refers to a group having 6 or more carbon atoms, preferably 12 or more carbon atoms. More specifically, it is preferable that a long-chain alkyl group-containing polymer is a copolymer of a monomer having a long-chain alkyl group and a vinyl monomer having a carboxyl group, and it is preferable that the polymer contains, in a composition ratio range of 20 to 99 mol %, a vinyl monomer having a carboxyl group.

(Recording Layer in the Second Aspect of the Invention)

A recording layer of the second aspect of the invention is a layer which can form an image by infrared irradiation, and may be any of a monolayer and a multi-layered structure. In the case of a monolayer-type recording layer, the recording layer contains a water-insoluble and alkali-soluble resin, and an infrared absorber. In the case of a multi-layered-type recording layer, the recording layer contains a water-insoluble and alkali-soluble resin, and at least one of a layer situated nearest to a support (hereinafter, referred to as “lower layer” in some cases) and/or a layer situated furthest from a support (hereinafter, referred to as “uppermost layer” in some cases) contains an infrared absorber.

(Recording Layer in the Third Aspect of the Invention)

A recording layer used in the planographic printing plate precursor of the third aspect of the invention is a layer which can form an image by infrared irradiation, and may be any of a monolayer, and a multi-layered structure. In the case of a monolayer-type recording layer, the recording layer contains a water-insoluble and alkali-soluble resin, and an infrared absorber. In the case of a multi-layered-type recording layer, the recording layer contains a water-insoluble and alkali-soluble resin, and at least one of a layer situated nearest to a support (hereinafter, referred to as “lower layer” in some cases) and/or a layer situated furthest from a support (hereinafter, referred to as “uppermost layer” in some cases) contains an infrared absorber.

(Long-Chain Alkyl Group-Containing Polymer)

It is preferable that the long-chain alkyl group-containing polymer is a copolymer, for example, represented by the following formula (I).

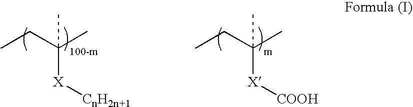

In the formula (I), X and X′ each represent independently a single bond or a divalent linking group. And, m represents an integer of 20<m<99, preferably an integer of 30<m<90, further preferably an integer of 45<m<80. And, n represents an integer of 6 to 40, more preferably an integer of 12 to 30, further preferably an integer of 14 to 20. A bond represented by a dotted line means that a methyl group or hydrogen is present at the end thereof.

Examples of the divalent linking group represented by X and X′ in the formula (I) include a straight, branched or cyclic alkylene group having 1 to 20 carbon atoms, a straight, branched or cyclic alkenylene group having 2 to 20 carbon atoms, an alkynylene group having 2 to 20 carbon atoms, an arylene group having 6 to 20 carbon atoms (monocycle, heterocycle), —OC(═O)—, —OC(═O)Ar—, —OC(═O)O—, —OC(═O)OAr—, —C(═O)NR—, —C(═O)NAr—, —SO₂NR—, —SO₂NAr—, —O-(alkyleneoxy, polyalkyleneoxy), —OAr-(aryleneoxy, polyaryleneoxy), —C(═O)O—, —C(═O)O—Ar—, —C(═O)Ar—, —C(═O)—, —SO₂O—, —SO₂OAr—, —OSO₂—, —OSO₂Ar—, —NRSO₂—, —NArSO₂—, —NRC(═O)—, —NArC(═O)—, —NRC(═O)O—, —NArC(═O)O—, —OC(═O)NR—, —OC(═O)NAr—, —NAr—, —NR—, —N⁺RR′—, —N⁺RAr—, —N⁺ArAr′-, —S—, —SAr—, —ArS—, a heterocyclic group (3 to 12-membered monocycle or fused ring containing, for example, at least one of nitrogen, oxygen and/or sulfur as a hetero atom), —OC(═S)—, —OC(═S)Ar—, —C(═S)O—, —C(═S)OAr—, —C(═S)OAr—, —C(═O)S—, —C(═O)SAr—, —ArC(═O)—, —ArC(═O)NR—, —ArC(═O)NAr—, —ArC(═O)O—, —ArC(═O)S—, —ArC(═S)O—, —ArO—, and —ArNR—. Herein, R and R′ each represent independently a hydrogen atom, or a straight or branched, linear or cyclic alkyl group, alkenyl group or alkynyl group. Ar and Ar′ each represent independently an aryl group.

Two or more kinds of linking groups listed herein may be combined to form a linking group.

Among such linking groups, an arylene group having 6 to 20 carbon atoms (monocycle, heterocycle), —C(═O)NR—, —C(═O)NAr—, —O-(alkyleneoxy, polyalkyleneoxy), —OAr-(aryleneoxy, polyaryleneoxy), —C(═O)O—, —C(═O)O—Ar—, —C(═O)—, —C(═O)Ar—, —S—, —SAr—, —ArS—, —ArC(═O)—, —ArC(═O)O—, —ArO—, and —ArNR— are preferable, and an arylene group having 6 to 20 carbon atoms (monocycle, heterocycle), —C(═O)NR—, —C(═O)NAr—, —O-(alkyleneoxy, polyalkyleneoxy), —OAr-(aryleneoxy, polyaryleneoxy), —C(═O)O—, —C(═O)O—Ar—, —SAr—, —ArS—, —ArC(═O)—, —ArC(═O)O—, —ArO—, and —ArNR— are more preferable.

The linking group may have a substituent, and examples of the substituent include a straight, branched or cyclic alkyl group having 1 to 20 carbon atoms, a straight, branched or cyclic alkenyl group having 2 to 20 carbon atoms, an alkynyl group having 2 to 20 carbon atoms, an aryl group having 6 to 20 carbon atoms, an acyloxy group having 1 to 20 carbon atoms, an alkoxycarbonyloxy group having 2 to 20 carbon atoms, an aryloxycarbonyloxy group having 7 to 20 carbon atoms, a carbamoyloxy group having 1 to 20 carbon atoms, a carbonamide group having 1 to 20 carbon atoms, a sulfonamide group having 1 to 20 carbon atoms, a carbamoyl group having 1 to 20 carbon atoms, a sulfamoyl group having 0 to 20 carbon atoms, an alkoxy group having 1 to 20 carbon atoms, an aryloxy group having 6 to 20 carbon atoms, an aryloxycarbonyl group having 7 to 20 carbon atoms, an alkoxycarbonyl group having 2 to 20 carbon atoms, a N-acylsulfamoyl group having 1 to 20 carbon atoms, a N-sulfamoylcarbamoyl group having 1 to 20 carbon atoms, an alkylsulfonyl group having 1 to 20 carbon atoms, an arylsulfonyl group having 6 to 20 carbon atoms, an alkoxycarbonylamino group having 2 to 20 carbon atoms, an aryloxycarbonylamino group having 7 to 20 carbon atoms, an amino group having 0 to 20 carbon atoms, an imino group having 1 to 20 carbon atoms, an ammonio group having 3 to 20 carbon atoms, a carboxy group, a sulfo group, an oxy group, a mercapto group, an alkylsulfinyl group having 1 to 20 carbon atoms, an arylsulfinyl group having 6 to 20 carbon atoms, an alkylthio group having 1 to 20 carbon atoms, an arylthio group having 6 to 20 carbon atoms, an ureido group having 1 to 20 carbon atoms, a heterocyclic group having 2 to 20 carbon atoms, an acyl group having 1 to 20 carbon atoms, a sulfamoylamino group having 0 to 20 carbon atoms, a silyl group having 2 to 20 carbon atoms, a hydroxy group, a halogen atom (e.g. fluorine atom, chlorine atom, bromine atom etc.), a cyano group, and a nitro group.

It is more preferable that the long-chain alkyl group-containing polymer is an acryl copolymer, for example, represented by the following formula (II).

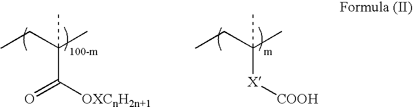

In the formula (II), X and X′ each represent independently a single bond or a divalent linking group. X and X′ in the formula (II) have the same meanings as those represented by X and X′ in the formula (I), and preferable examples thereof are as defined above. And, m represents an integer of 20<m<99, preferably an integer of 30<m<90, further preferably an integer of 45<m<80. And, n represents an integer of 6 to 40, more preferably an integer of 12 to 30, further preferably an integer of 14 to 20. A bond represented by a dotted line means that a methyl group or hydrogen is present at the end thereof.

It is further preferable that the long-chain alkyl group-containing polymer is an acryl copolymer, for example, represented by the following formula (III).

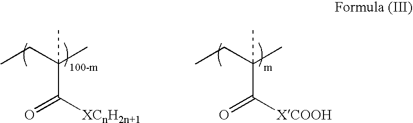

In the formula (III), X and X′ each represent independently a single bond or a divalent linking group. X and X′ in the formula (III) have the same meanings as those represented by X and X′ in the formula (I), and preferable examples thereof are as defined above. And, m represents an integer of 20<m<99, preferably an integer of 30<m<90, further preferably an integer of 45<m<80. And, n represents an integer of 6 to 40, more preferably an integer of 12 to 30, further preferably an integer of 14 to 20. A bond represented by a dotted line means that a methyl group or hydrogen is present at the end thereof.

It is most preferable that the long-chain alkyl group-containing polymer is an acryl copolymer, for example, represented by the following formula (IV) or formula (V).

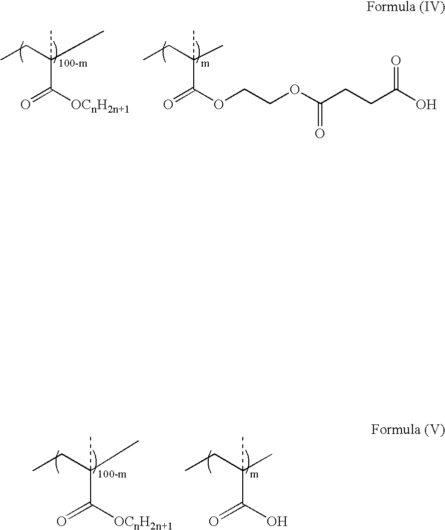

In the formula (IV) and the formula (V), m represents an integer of 20<m<99, preferably an integer of 30<m<90, further preferably an integer of 45<m<80. And, n represents an integer of 6 to 40, more preferably an integer of 12 to 30, further preferably an integer of 14 to 20. A bond represented by a dotted line means that a methyl group or hydrogen is present at the end thereof.

Further, in the first aspect of the invention, it is most preferable that the long-chain alkyl group-containing polymer is an acryl copolymer represented by the formula (V) from a viewpoint of balance between abrasion resistance and alkali solubility.

The long-chain alkyl group-containing polymer may be a copolymer of one or more kinds selected from the following hydrophilic monomers and other monomers, in addition to a monomer having a long-chain alkyl group and a vinyl monomer having a carboxy group. In that case, a mole composition ratio of other monomers in the copolymer is preferably 40 mol % or less, more preferably 30 mol % or less, further preferably 25 mol % or less, from a viewpoint of formation of surface fine projections.

<Hydrophilic Monomer>

The monomer to be copolymerized with a monomer having a long-chain alkyl group and a vinyl monomer having a carboxy group is preferably a hydrophilic monomer from a viewpoint of solubility in an alkali developer, and sensitivity.

As such a hydrophilic monomer, monomers having an acidic group listed in the following (1) to (5) are preferable in respect of solubility in an alkaline developer, and sensitivity.

(1) Phenol group (—Ar—OH)

(2) Sulfonamido group (—SO₂NH—R)

(3) Active imido group (—SO₂NHCOR, —SO₂NHSO₂R, —CONHSO₂R)

(4) Sulfonic acid group (—SO₃H)

(5) Phosphoric acid group (—OPO₃H₂)

In the (1) to (5), Ar represents a divalent aryl linking group optionally having a substituent, and R represents a hydrocarbon group optionally having a substituent.

Examples of a monomer having the (1) phenol group include acrylamide, methacrylamide, acrylic acid ester, methacrylic acid ester, and hydroxystyrene which have a phenol group.

Examples of a monomer having the (2) sulfonamide group include compounds having one or more sulfonamido group of the aforementioned structure and one or more polymerizable unsaturated group in a molecule. Inter alia, a low-molecular compound having an acryloyl group, an allyl group, or a vinyloxy group, and a sulfonamido group in a molecule is preferable. Examples include compounds represented by the following formulas (i) to (v).

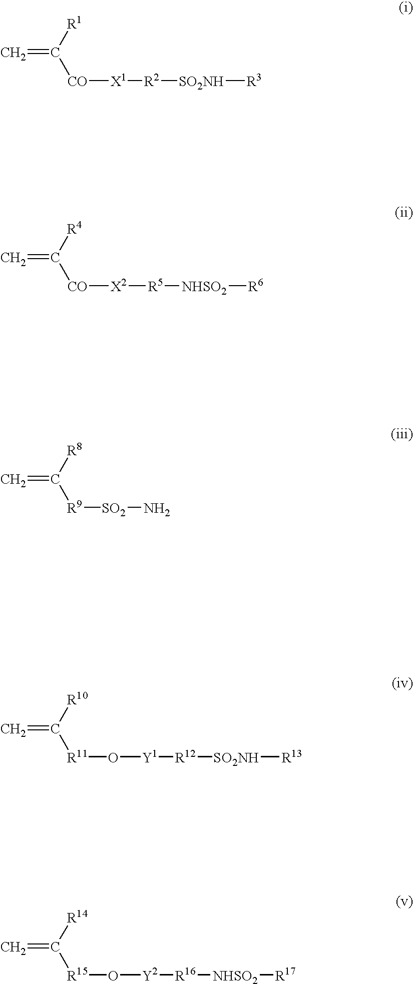

In the formulas (i) to (v), X¹ and X² each represent independently —O— or —NR⁷—. R¹ and R⁴ each represent independently a hydrogen atom or —CH₃. R², R⁵, R⁹, R¹² and R¹⁶ each represent independently an alkylene group, a cycloalkylene group, an arylene group or an aralkylene group, each having 1 to 12 carbon atoms and optionally having a substituent. R³, R⁷ and R¹³ each represent independently a hydrogen atom, or an alkyl group, a cycloalkyl group, an aryl group or an aralkyl group, each having 1 to 12 carbon atoms and optionally having a substituent. R⁶ and R¹⁷ each represent independently an alkyl group, a cycloalkyl group, an aryl group or an aralkyl group, each having 1 to 12 carbon atoms and optionally having a substituent. R⁸, R¹⁰ and R¹⁴ each represent independently a hydrogen atom or —CH₃. R¹¹ and R¹⁵ each represent independently a single bond, or an alkylene group, a cycloalkylene group, an arylene group or an aralkylene group, each having 1 to 12 carbon atoms and optionally having a substituent. Y¹ and Y² each represent independently a single bond, or —CO—.

In the planographic printing plate precursor of the invention, among compounds represented by the formulas (i) to (v), in particular, m-aminosulfonylphenyl methacrylate, N-(p-aminosulfonylphenyl)methacrylamide, and N-(p-aminosulfonylphenyl)acrylamide can be suitably used.

Examples of a monomer having the (3) active imido group include compounds having one or more active imido group represented by the above structural formula and one or more polymerizable unsaturated group in a molecule. Inter alia, a compound having one or more active imido group represented by the following structural formula and one or more polymerizable unsaturated group in a molecular is preferable.

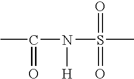

Specifically, N-(p-toluenesulfonyl)methacrylamide, and N-(p-toluenesulfonyl)acrylamide can be suitably used.

Examples of a monomer having the (4) sulfonic acid group include compounds having one or more sulfonic acid group and one or more polymerizable unsaturated group in a molecule.

Examples of a monomer having the (5) phosphoric acid group include compounds having one or more phosphoric acid group and one or more polymerizable unsaturated group in a molecule.

Among hydrophilic monomers, monomers having (1) a phenol group, (2) a sulfonamido group, or (3) an active imido group are preferable, and in particular, monomers having (1) a phenol group or (2) a sulfonamido group are most preferable from a viewpoint of solubility in an alkaline developer, development latitude, and sufficient film strength.

<Other Monomers>

Examples of other monomers which are copolymerizable with a monomer having a long-chain alkyl group and a vinyl monomer having a carboxy group include compounds listed in the following (6) to (16).

(6) Acrylic acid esters and methacrylic acid esters having an aliphatic hydroxy group such as 2-hydroxyethyl acrylate and 2-hydroxyethyl methacrylate.

(7) Acrylates such as methyl acrylate, ethyl acrylate, propyl acrylate, amyl acrylate, benzyl acrylate, 2-chloroethyl acrylate, glycidyl acrylate, N-dimethylaminoethyl acrylate, polyethylene glycol monoacrylate, and polypropylene glycol monoacrylate.

(8) Methacrylates such as methyl methacrylate, ethyl methacrylate, propyl methacrylate, amyl methacrylate, cyclohexyl methacrylate, benzyl methacrylate, 2-chloroethylmethacrylate, glycidyl methacrylate, N-dimethylaminoethyl methacrylate, polyethylene glycol monomethacrylate, and polypropylene glycol monomethacrylate.

(9) Acrylamides or methacrylamides such as acrylamide, methacrylamide, N-methylolacrylamide, N-ethylacrylamide, N-hexylmethacrylamide, N-cyclohexylacrylamide, N-hydroxyethylacrylamide, N-phenylacrylamide, N-nitrophenylacrylamide, and N-ethyl-N-phenylacrylamide.

(10) Vinyl ethers such as ethyl vinyl ether, 2-chloroethyl vinyl ether, hydroxyethyl vinyl ether, propyl vinyl ether, butyl vinyl ether, and phenyl vinyl ether.

(11) Vinyl esters such as vinyl acetate, vinyl chloroacetate, vinyl butyrate, and vinyl benzoate.

(12) Styrenes such as styrene,α-methylstyrene, methylstyrene, and chloromethylstyrene.

(13) Vinyl ketones such as methyl vinyl ketone, ethyl vinyl ketone, propyl vinyl ketone, and phenyl vinyl ketone.

(14) Olefins such as ethylene, propylene, isobutylene, butadiene, and isoprene.

(15) N-vinylpyrrolidone, N-vinylcarbazole, 4-vinylpyridine, acrylonitrile, and methacrylonitrile.

(16) Unsaturated imides such as maleimide, N-acryloylacrylamide, N-acetylmethacrylamide, N-propionylmethacrylamide, and N-(p-chlorobenzoyl)methacrylamide.

As a method of copolymerizing the above-listed monomer having a long-chain alkyl group, vinyl monomer having a carboxy group, hydrophilic monomer and other monomers, a conventionally known graft copolymerization method, block copolymerization method and random copolymerization method can be used. In this copolymerization, two or more kinds of respective monomers may be mixed and used. When two or more monomers having a carboxy group are mixed and used, the sum of the mole composition ratios of the two or more monomers is preferably 20 to 99 mol % in a long-chain alkyl group-containing polymer in the invention.

Examples of the long-chain alkyl group-containing polymer are not limited to, but include the following polymers.

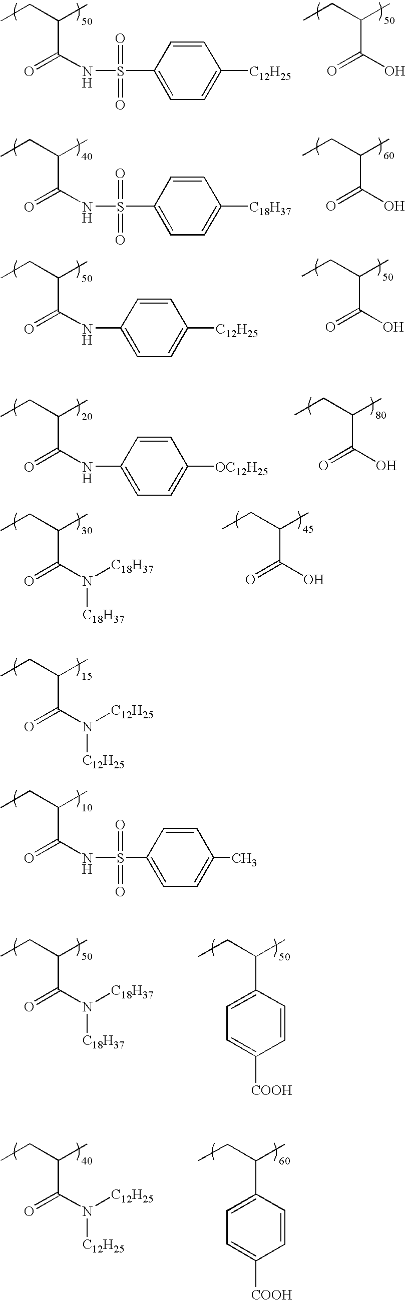

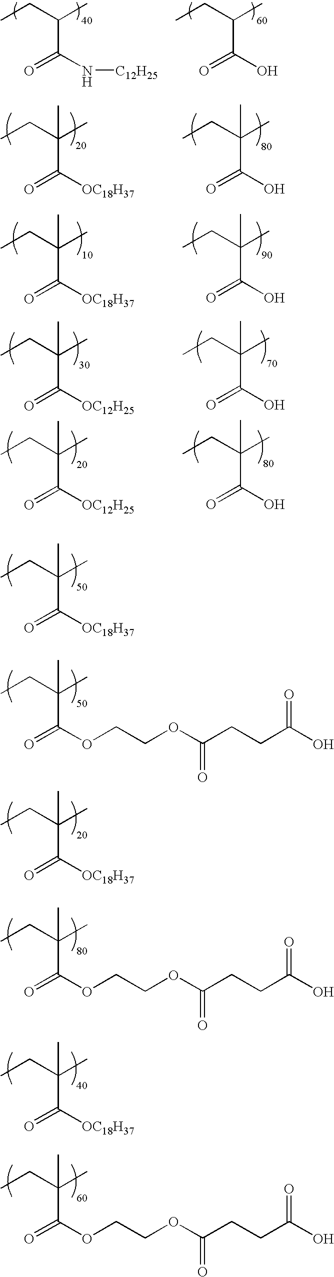

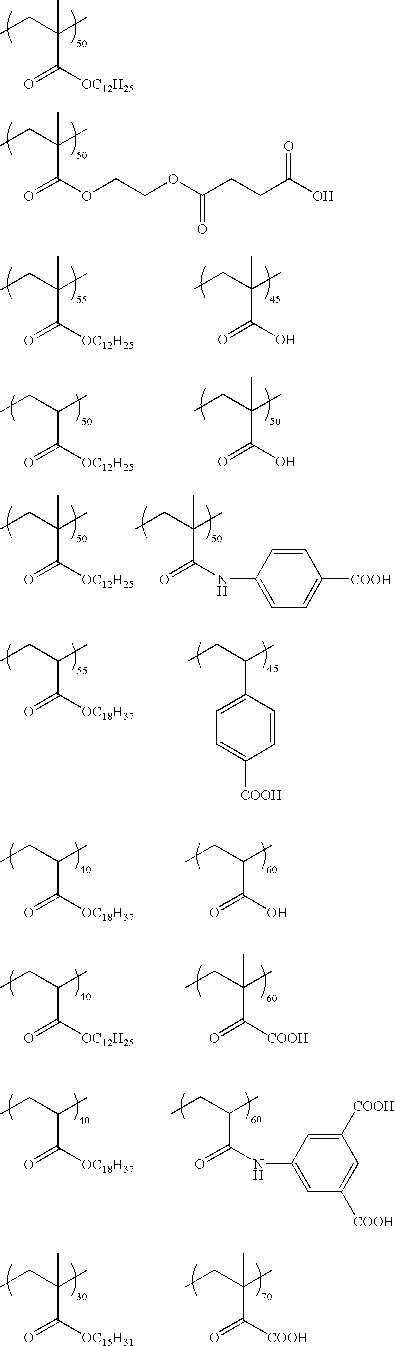

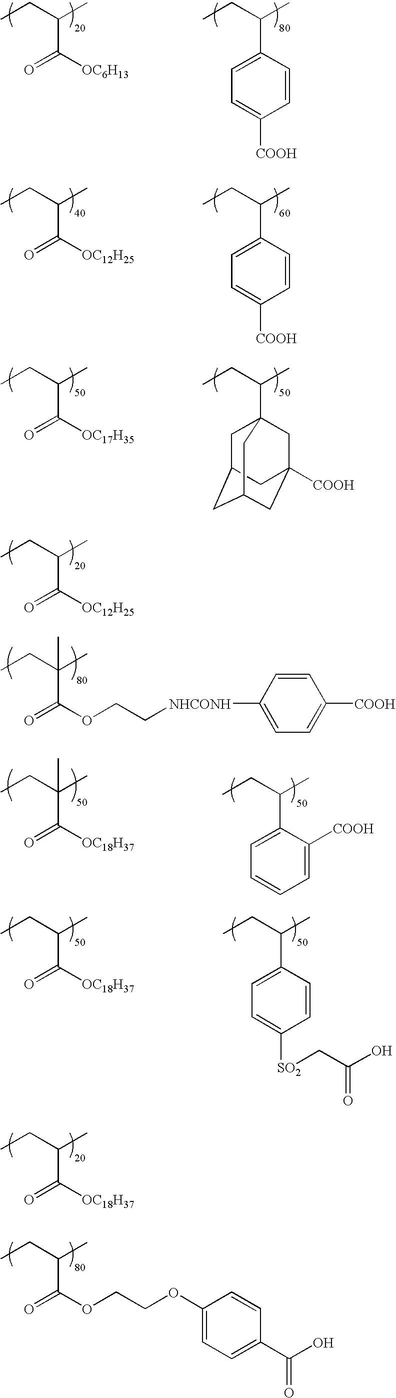

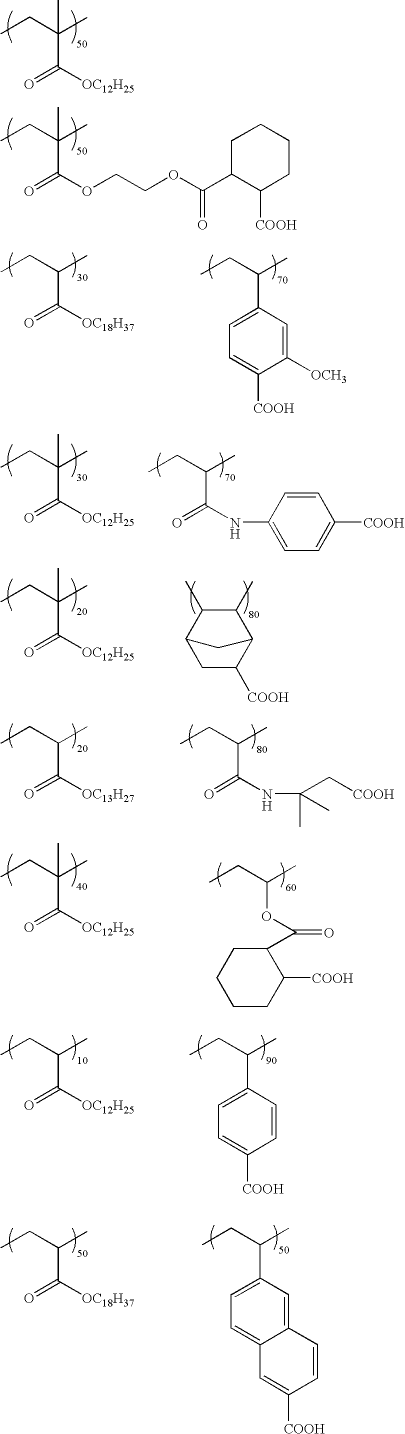

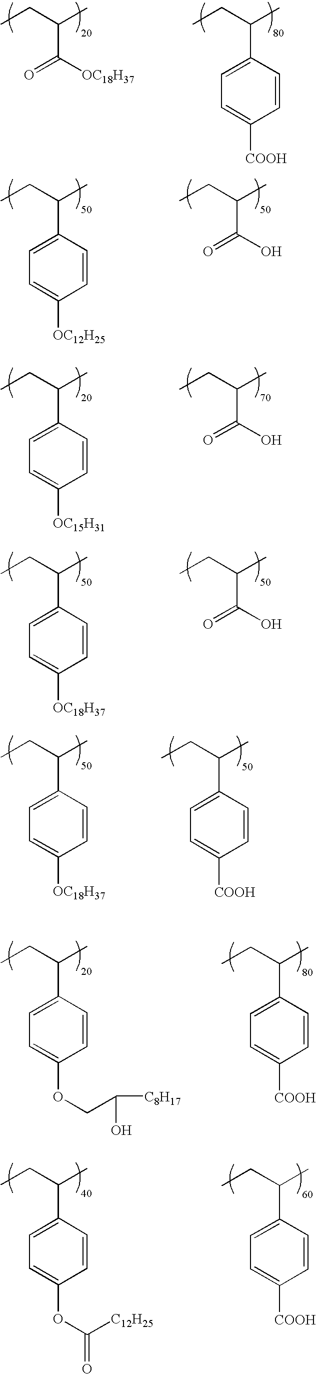

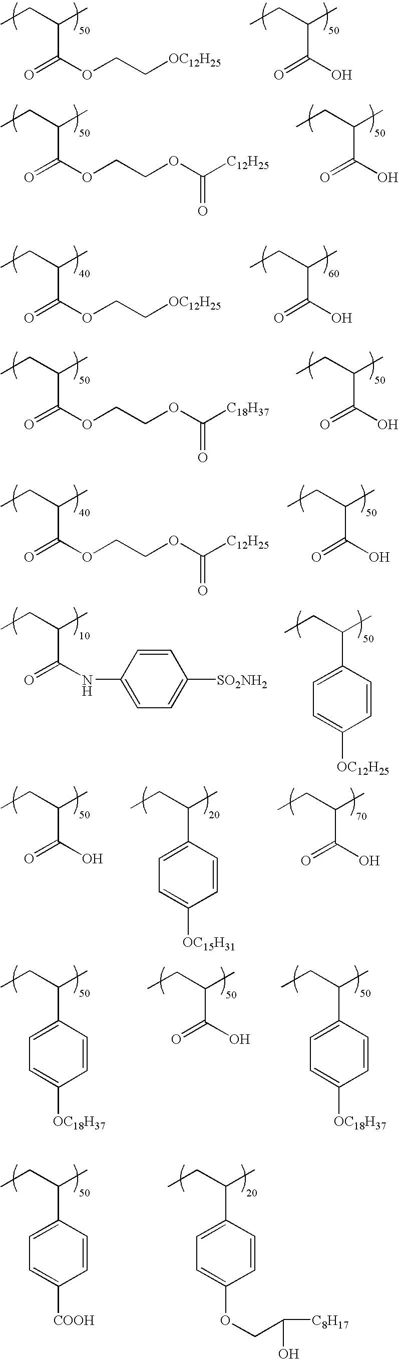

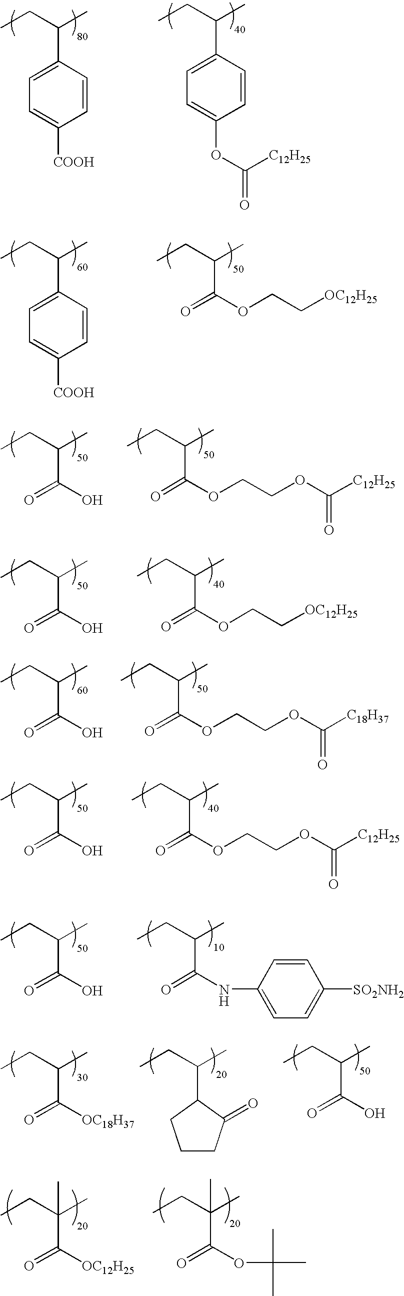

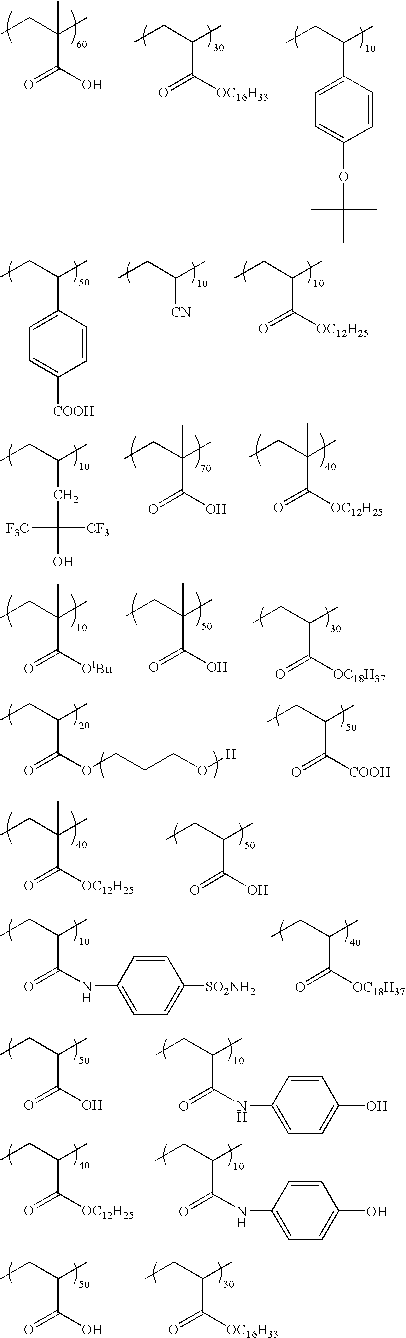

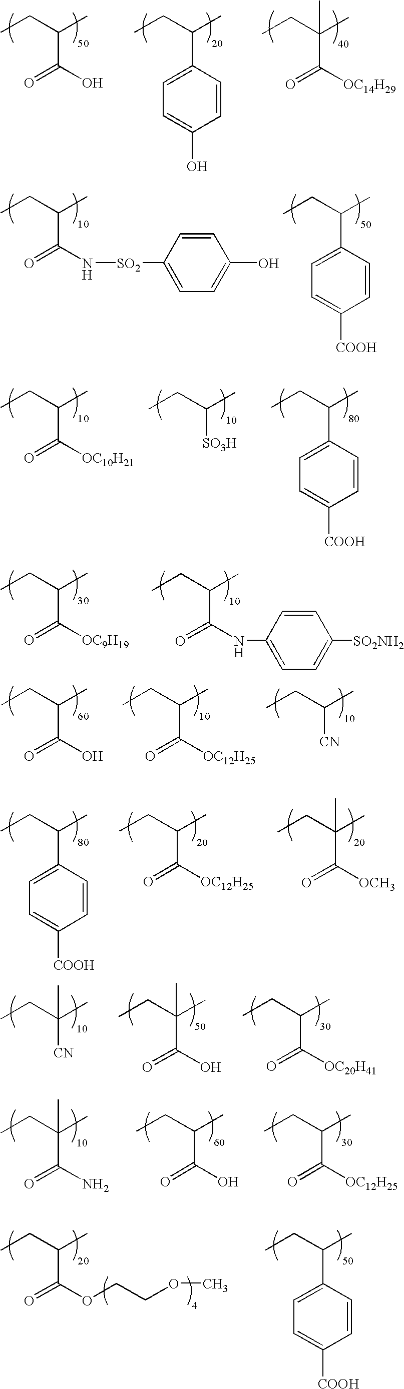

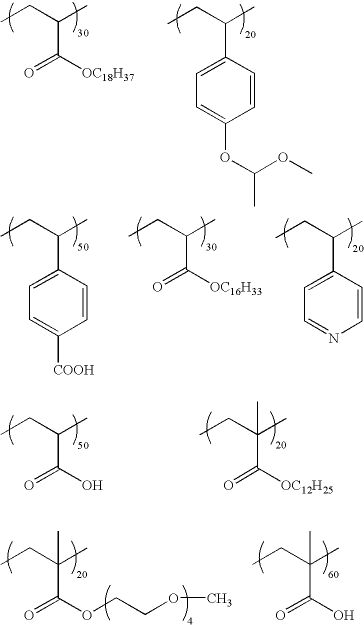

As the long-chain alkyl group-containing polymer used in the invention, a polymer having a weight average molecular weight of 5,000 or more and a number average molecular weight of 1,000 or more is preferably used. Further preferably, a weight average molecular weight in terms of polystyrene is 10,000 to 5,000,000, particularly preferably 10,000 to 2,000,000, further preferably 20,000 to 1,000,000. Such polymers may be used alone, or two or more kinds thereof may be used in combination.

An amount of a remaining monomer in a long-chain alkyl group-containing polymer is preferably 10% by mass or less, more preferably 5% by mass or less, from a viewpoint of a problem of transfer to a protective paper (interleaving sheet) or a substrate back surface when stacking the planographic printing plate precursor of the invention, or transfer to a roller when manufacturing the planographic printing plate precursor.

For forming a recording layer in the first aspect of the invention, a long-chain alkyl group-containing polymer, and respective components described later as components used in a recording layer are mixed, and the mixture as a recording layer coating liquid is coated on a support. Thereby, the long-chain alkyl group-containing polymer, and a polymer compound contained in recording layer components, for example, an alkali-soluble resin described later cause phase separation, and the long-chain alkyl group-containing polymer is self-aggregated to form fine projections on a surface.

Herein, a content of such a long-chain alkyl group-containing polymer contained in a recording layer total solid matter is preferably around 0.5 to 30% by mass, further preferably 1 to 20% by mass. When a content of the long-chain alkyl group-containing polymer is less than 0.5% by mass, formation of irregularities is insufficient, so that the effect of improving abrasion resistance is not sufficiently obtained, and when the content exceeds 30% by mass, strength of an upper recording layer is reduced, so that printing durability tends to decrease.

Other preferable properties of an image recording material for sufficiently exerting the effect in the first aspect of the invention is that an in-air water droplet contact angle on a recording layer surface after formation of the recording layer containing a long-chain alkyl group-containing polymer is in a range of 60 degree to 140 degree, and that a dynamic friction coefficient of a recording layer surface in the case of film-making of the recording layer containing a long-chain alkyl group-containing polymer is in a range of 0.38 to 0.70. In view of them, a kind and addition amount of the long-chain alkyl group-containing polymer may be determined. The dynamic friction coefficient referred to herein refers to a value measured according to standard ASTM D1894 by arranging the recording layer surface and a stainless steel so as to be in contact with each other.

(Water-Insoluble and Alkali-Soluble Resin)

A water-insoluble and alkali-soluble resin (hereinafter, referred to as alkali-soluble resin in some cases) used in the recording layer of the invention may be a homopolymer containing an acidic group on a main chain and/or a side chain in a polymer, a copolymer thereof and a mixture thereof. Therefore, the recording layer in the invention is dissolved in an alkaline developer when contacted with the alkaline developer.

An alkali-soluble resin used in the present invention may be a conventionally known resin, and is not particularly limited, but is preferably a polymer compound having at least one acidic group selected from (1) a phenolic hydroxy group, (2) a sulfonamido group, (3) an active imido group, and (4) a carboxylic acid group in a molecule. For example, the following are exemplified, but the resin is not limited to them.

(1) Examples of the polymer compound having a phenolic hydroxy group include novolak resins such as a phenol formaldehyde resin, a m-cresol formaldehyde resin, a p-cresol formaldehyde resin, a m-/p-mixed cresol formaldehyde resin, and a phenol/cresol (any of m-, p- and m-/p-mixed may be used) mixed formaldehyde resin, and a pyrogallol acetone resin.

In addition, as the alkali-soluble resin having a phenolic hydroxy group, a resin obtained by condensing substituted phenols represented by the following formula (i) and aldehydes is a preferable example.

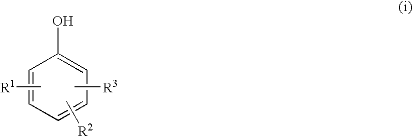

In the formula (i), R¹ and R² each represent a hydrogen atom, an alkyl group or a halogen atom. The alkyl group preferably has 1 to 3 carbon atoms, more preferably has 1 or 2 carbon atoms. The halogen atom is any of a fluorine atom, a chlorine atom, a bromine atom and an iodine atom, preferably a chlorine atom or a bromine atom. And, R³ represents an alkyl group having 3 to 6 carbon atoms, or a cycloalkyl group.

Examples of the substituted phenols include isopropylphenol, t-butylphenol, t-amylphenol, hexylphenol, cyclohexylphenol, 3-methyl-4-chloro-6-tertiarybutylphenol isopropylcresol, t-butylcresol, and t-amylcresol. Inter alia, t-butylphenol and t-butylcresol are preferable.

Examples of aldehydes used for condensing with the substituted phenols include aliphatic and aromatic aldehydes such as formaldehyde, acetoaldehyde, acrolein, and crotonaldehyde. Inter alia, formaldehyde and acetoaldehyde are preferable.

Other examples of the alkali-soluble resin having a phenolic hydroxy group include polymer compounds having a phenolic hydroxy group on a side chain. Examples of the polymer compound having a phenolic hydroxy group on a side chain include polymer compounds obtained by homo-polymerizing a polymerizable monomer consisting of a low-molecular compound having one or more phenolic hydroxy group and one or more polymerizable unsaturated bond, or copolymerizing the monomer with another polymerizable monomer.

Examples of the polymerizable monomer having a phenolic hydroxy group include acrylamide, methacrylamide, acrylic acid ester, methacrylic acid ester and hydroxystyrene which have a phenolic hydroxy group. Specifically, N-(2-hydroxyphenyl)acrylamide, N-(3-hydroxyphenyl)acrylamide, N-(4-hydroxyphenyl)acrylamide, N-(2-hydroxyphenyl)methacrylamide, N-(3-hydroxyphenyl)methacrylamide, N-(4-hydroxyphenyl)methacrylamide, o-hydroxyphenyl acrylate, m-hydroxyphenyl acrylate, p-hydroxyphenyl acrylate, o-hydroxyphenyl methacrylate, m-hydroxyphenyl methacrylate, p-hydroxyphenyl methacrylate, o-hydroxystyrene, m-hydroxystyrene, p-hydroxystyrene, 2-(2-hydroxyphenyl)ethyl acrylate, 2-(3-hydroxyphenyl)ethyl acrylate, 2-(4-hydroxyphenyl)ethyl acrylate, 2-(2-hydroxyphenyl)ethyl methacrylate, 2-(3-hydroxyphenyl)ethyl methacrylate, and 2-(4-hydroxyphenyl)ethyl methacrylate can be suitably used. The resin having a phenolic hydroxy group may be used in combination of two or more kinds.

Examples of the alkali-soluble resin having a phenolic hydroxy group used in the invention include an alkali-soluble resin in which at least a part of phenolic hydroxy groups of the alkali-soluble resin having a phenolic hydroxy group is esterified, which is described in JP-A No. 11-288089.

(2) Examples of the alkali-soluble resin having a sulfonamido group include polymer compounds obtained by homo-polymerizing a polymerizable monomer having a sulfonamido group, or copolymerizing the monomer with another copolymerizable monomer. Examples of the polymerizable monomer having a sulfonamido group include a polymerizable monomer consisting of a low-molecular compound having one or more sulfonamido group —NH—SO₂— in which at least one hydrogen atom is bound to a nitrogen atom, and one or more polymerizable unsaturated bond in one molecule. Among them, a low-molecular compound having an acryloyl group, an allyl group or a vinyloxy group, and a substituted or mono-substituted aminosulfonyl group or a substituted sulfonylimino group is preferable.

Examples of the alkali-soluble resin having a sulfonamido group include resins described in Japanese Patent Application Publication (JP-B) No. 7-69605.

(3) As the alkali-soluble resin having an active imido group, a resin having an active imido group (—CO—NH—SO₂—) in a molecule is preferable, and examples of this polymer compound include a polymer compound obtained by homo-polymerizing a polymerizable monomer consisting of a low-molecular compound having one or more active imido group and one or more polymerizable unsaturated bond in one molecule, or copolymerizing the monomer with another polymerizable monomer.

As an example of such a compound, N-(p-toluenesulfonyl)methacrylamide, and N-(p-toluenesulfonyl)acrylamide can be suitably used.

(4) Examples of the alkali-soluble resin having a carboxylic acid group include a polymer compound obtained by homo-polymerizing a polymerizable monomer consisting of a low-molecular compound having one or more carboxylic acid group and one or more polymerizable unsaturated group in a molecule, or copolymerizing the monomer with another copolymerizable monomer. Examples of the polymerizable monomer having a carboxylic acid group include α,β-unsaturated carboxylic acids such as acrylic acid, methacrylic acid, maleic acid, maleic anhydride, and itaconic acid. In addition, an unsaturated carboxylic acid which is a monoester of a hydroxyl group of acrylate or methacrylate having a hydroxyl group on a side chain (e.g. 2-hydroxyethylethyl acrylate or methacrylate etc.) and a dibasic acid (e.g. succinic acid, glutaric acid, phthalic acid etc.) is a preferable example.

Further, as the alkali-soluble resin in the invention, a polymer compound obtained by polymerizing two or more kinds among the polymerizable monomer having a phenolic hydroxy group, the polymerizable monomer having a sulfonamido group, the polymerizable monomer having an active imido group, and the polymerizable monomer having a carboxylic acid group, or a polymer compound obtained by copolymerizing these two or more kinds of polymerizable monomers with another polymerizable monomer can be used.

In the invention, when the alkali-soluble resin is a copolymer of the monomer having an acidic group (a phenolic hydroxy group, a sulfonamido group, an active imido group, a carboxylic acid group) with another polymerizable monomer, from a viewpoint of alkali solubility, a monomer imparting alkali solubility is used at preferably 10 mol % or more, more preferably 20 mol % or more.

Examples of a monomer component to be copolymerized with the monomer having an acidic group are not limited to, but include compounds listed in the following (m1) to (m11).

(m1) Acrylic acid esters and methacrylic acid esters having an aliphatic hydroxy group such as 2-hydroxyethyl acrylate and 2-hydroxyethyl methacrylate.

(m2) Alkyl acrylates such as methyl acrylate, ethyl acrylate, propyl acrylate, butyl acrylate, amyl acrylate, hexyl acrylate, octyl acrylate, benzyl acrylate, 2-chloroethyl acrylate, and glycidyl acrylate.

(m3) Alkyl methacrylate such as methyl methacrylate, ethyl methacrylate, propyl methacrylate, butyl methacrylate, amyl methacrylate, hexylmaethacrylate, cyclohexyl methacrylate, benzyl methacrylate, 2-chloroethyl methacrylate, and glycidyl methacrylate.

(m4) Acrylamides or methacrylamides such as acrylamide, methacrylamide, N-methylolacrylamide, N-ethylacrylamide, N-hexylmethacrylamide, N-cyclohexylacrylamide, N-hydroxyethylacrylamide, N-phenylacrylamide, N-nitrophenylacrylamide, and N-ethyl-N-phenylacrylamide.

(m5) Vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether.

(m6) Vinyl esters such as vinyl acetate, vinyl chloroacetate, vinyl butyrate, and vinyl benzoate.

(m7) Styrenes such as styrene, α-methylstyrene, methylstyrene, and chloromethylstyrene.

(m8) Vinyl ketones such as methyl vinyl ketone, ethyl vinyl ketone, propyl vinyl ketone, and phenyl vinyl ketone.

(m9) Olefins such as ethylene, propylene, isobutylene, butadiene, and isoprene.

(m10) N-vinylpyrrolidone, acrylonitrile, and methacrylonitrile.

(m11) Unsaturated imides such as maleimide, N-acryloylacrylamide, N-acetylmethacrylamide, N-propionylmethacrylamide, and N-(p-chlorobenzoyl)methacrylamide.

As a method of copolymerization of the alkaline water-soluble polymer compound, conventionally known methods such as graft copolymerization method, block copolymerization method, and random copolymerization method can be used.

When the alkali-soluble resin is a homopolymer or a copolymer of the polymerizable monomer having an acidic group in the invention, a weight average molecular weight thereof is preferably 2,000 or more, further preferably 5,000 to 300,000. In addition, when the alkali-soluble resin is a resin such as a phenol formaldehyde resin and a cresol aldehyde resin in the invention, a weight average molecular weight thereof is preferably 500 to 50,000, more preferably 700 to 20,000, particularly preferably 1,000 to 10,000.

When a recording layer has a multi-layered structure, as the alkali-soluble resin used in an uppermost layer of the recording layer, a resin having a phenolic hydroxy group is desirable because strong hydrogen bonding property is generated in an unexposed area, and a part of hydrogen bonds is easily eliminated in an exposed area. Further preferable is a novolak resin.

In the invention, two or more kinds of alkali-soluble resins having different dissolution rates in an alkaline aqueous solution may be mixed and used, and a mixing ratio in that case is arbitrary. As a preferable alkali-soluble resin to be mixed with a resin having a phenolic hydroxy group which is suitably used in an uppermost layer of a multi-layered-type recording layer, an acryl resin is preferable, and an acryl resin having a sulfoamido group or a carboxylic acid group is more preferable, since the resin has low compatibility with a resin having a phenolic hydroxy group.

When a recording layer is a multi-layered structure, the aforementioned alkali-soluble resin is used in a lower layer of the recording layer, and it is required that a lower layer itself shows high alkali solubility, particularly in a non-image area. In addition, it is also required that resistance to various printing chemicals is shown at the time of printing, and stable printing durability is shown under various printing conditions. For this reason, a resin which does not deteriorate these properties is preferably selected. From this viewpoint, it is preferable to select a resin excellent in solubility in an alkali developer, dissolution resistance to various printing chemicals, and physical strength. In addition, it is preferable to select a resin having low solvent solubility which is not dissolved by a coating solvent when coating an uppermost layer thereon, as an alkali-soluble resin used in a lower layer. By selecting such a resin, undesired compatibility at an interface between two layers is suppressed.

From these viewpoints, as an alkali-soluble resin contained in a lower layer, an acryl resin is preferable among the aforementioned alkali-soluble resins. Inter alia, an acryl resin having a sulfonamido group is preferable.

In addition, from the aforementioned viewpoint, as an alkali-soluble resin used in a lower layer, in addition to the aforementioned resins, examples include a polyamide resin, an epoxy resin, a polyvinyl acetal resin, a styrene type resin, and a urethane resin, which are water-insoluble and alkali-soluble. Among them, a urethane resin, and a polyvinyl acetal resin are preferable.

The polyurethane resin which is water-insoluble and alkali-soluble (hereinafter, referred to as “polyurethane resin” in some cases) is not particularly limited as far as the resin is water-soluble and alkali aqueous solution-soluble, and inter alia, a resin having a carboxyl group on a polymer main chain is preferable. Examples include a polyurethane resin wherein a fundamental skeleton thereof is a reaction product of a diisocyanate compound represented by the following formula (ii), and at least one kind of a diol compound having a carboxyl group represented by the following formula (iii) or the formula (Iv).

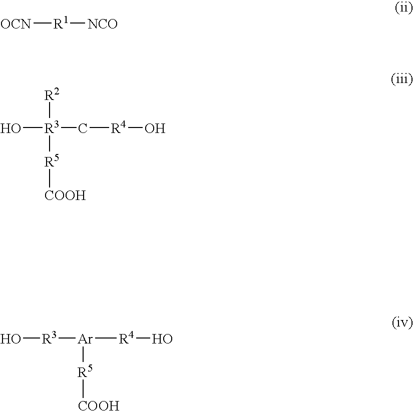

In the formula (ii), R¹ represents a divalent linking group. Examples of the divalent linking group include an aliphatic hydrocarbon, an alicyclic hydrocarbon and an aromatic hydrocarbon, and preferable examples include an alkylene group having 2 to 10 carbon atoms, and an arylene group having 6 to 30 carbon atoms. As the arylene group, a group in which two or more ring structures are bound via a single bond or a divalent organic linking group such as a methylene group, or a group in which a fused polycyclic structure is formed may be used. If necessary, R¹ may have other functional groups which do not react with an isocyanate group (e.g. ester group, urethane group, amido group, ureido group etc.).

R¹ in the formula (ii) may have a substituent, and examples of a substituent which can be introduced include a substituent which is inert to the isocyanate group, such as a halogen atom (—F, —Cl, —Br, —I), an alkyl group, an alkoxyl group, an alkyl ester group, and a cyano group.

In addition, as the diisocyanate compound, other than the compound represented by the formula (ii), for example, a high-molecular weight diisocyanate compound having an isocyanate group on both ends of a polymer compound such as an oligomer and a polymer prepared from diol compounds described later can be used.

In the formula (iii), R² represents a hydrogen atom, an alkyl group, an aralkyl group, an aryl group, an alkoxy group, or an aryloxy group. Herein, R² may have a substituent, and examples of a substituent which can be introduced include a cyano group, a nitro group, a halogen atom (—F, —Cl, —Br, —I), —CONH₂, —COOR⁶, —OR⁶, —NHCONHR⁶, —NHCOOR⁶, —NHCOR⁶, —OCONHR⁶, and —CONHR⁶ (wherein R⁶ represents an alkyl group having 1 to 10 carbon atoms, or an aralkyl group having 7 to 15 carbon atoms).

Examples of preferable R² include a hydrogen atom, an unsubstituted alkyl group having 1 to 8 carbon atoms, and an unsubstituted aryl group having 6 to 15 carbon atoms.

In the formula (iii) or (iv), R³, R⁴ and R⁵ may be the same or different, and represent a single bond or a divalent linking group. Examples of the divalent linking group include an aliphatic hydrocarbon and an aromatic hydrocarbon. Herein, R³, R⁴ and R⁵ may have a substituent, and examples of a substituent which can be introduced include an alkyl group, an aralkyl group, an aryl group, an alkoxy group, and a halogen atom (—F, —Cl, —Br, —I).

Examples of preferable R³, R⁴ and R⁵ include an unsubstituted alkylene group having 1 to 20 carbon atoms, and an unsubstituted arylene group having 6 to 15 carbon atoms, and further preferable examples include an unsubstituted alkylene group having 1 to 8 carbon atoms. If necessary, R³, R⁴ and R⁵ may have other functional groups which do not react with an isocyanate group in the formula (ii) (e.g. ester group, urethane group, amido group, ureido group, ether group).

Further, two or three of R², R³, R⁴ and R⁵ may be bonded to each other to form a ring structure.

In the formula (Iv), Ar represents a trivalent aromatic hydrocarbon optionally having a substituent, preferably an aromatic group having 6 to 15 carbon atoms.

Examples of the diisocyanate compound represented by the formula (ii) include following compounds, but the invention is not limited to them.

Examples include aromatic diisocyanate compounds such as 2,4-tolylene diisocyanate, a dimer of 2,4-tolylene diisocyanate, 2,6-tolylene diisocyanate, p-xylylene diisocyanate, metaxylylene diisocyanate, 4,4′-diphenylmethane diisocyanate, 1,5-naphthylene diisocyanate, and 3,3′-dimethylbiphenyl-4,4′-diisocyanate; aliphatic diisocyanate compounds such as hexamethylene diisocyanate, trimethylhexamethylene diisocyanate, lysine diisocyanate, and dimer acid diisocyanate; alicyclic diisocyanate compounds such as isophorone diisocyanate, 4,4′-methylenebis(cyclohexyl isocyanate), methylcyclohexane-2,4(or 2,6)diisocyanate, and 1,3-(isocyanatemethyl)cyclohexane; a diisocyanate compound which is a reaction product of a diol and a diisocyanate such as an adduct of 1 mole of 1,3-butylene glycol and 2 mole of tolylene diisocyanate.

Inter alia, a compound having an aromatic ring such as 4,4′-diphenylmethane diisocyanate, xylylene diisocyanate, and tolylene diisocyanate is preferable from a viewpoint of abrasion resistance.

In addition, examples of the diol compound having a carboxyl group represented by the formula (iii) or (iv) include the following compounds, but the present invention is not limited to them.

Examples include 3,5-dihydroxybenzoic acid, 2,2-bis(hydroxymethyl)propionic acid, 2,2-bis(hydroxyethyl)propionic acid, 2,2-bis(3-hydroxypropyl)propionic acid, 2,2-bis(hydroxymethyl)acetic acid, bis-(4-hydroxyphenyl)acetic acid, 4,4-bis-(4-hydroxyphenyl)pentanoic acid, and tartaric acid.

Inter alia, 2,2-bis(hydroxymethyl)propionic acid, and 2,2-bis(hydroxyethyl)propionic acid are preferable from a viewpoint of reactivity with isocyanates.

The polyurethane resin may be a polyurethane resin formed by using two or more kinds of the diisocyanate compound represented by the formula (ii), and two or more kinds of the diol compound having a carboxyl group represented by the formula (iii) or (iv).

Further, in addition to the diol compound having a carboxyl group represented by the formula (iii) or (iv), a diol compound having no carboxyl group and optionally having a substituent which does not react with an isocyanate group in the formula (ii) may be used in combination to such an extent that alkali developability is not reduced.

The polyurethane resin can be synthesized by heating the diisocyanate compound and the diol compound in an aprotic solvent to which known catalysts having activity according to reactivity of each compound have been added.

A mole ratio of the diisocyanate and the diol compounds used is preferably 0.8:1 to 1.2:1 and, when an isocyanate group remains on a polymer end, the polyurethane resin is synthesized in a form in which an isocyanate group does not finally remain, by treating with alcohols or amines.

A weight average molecular weight of the polyurethane resin is preferably 1,000 or more, further preferably in a range of 5,000 to 100 thousand. These polyurethane resins may be used alone, or may be used in combination of two or more kinds.

Then, a polyvinyl acetal resin which is water-insoluble and alkali-soluble will be explained. The polyvinyl acetal resin used herein is not particularly limited, as far as it is water-insoluble and alkali aqueous solution-soluble, and inter alia, a polyvinyl acetal resin represented by the following formula (v) is preferable.

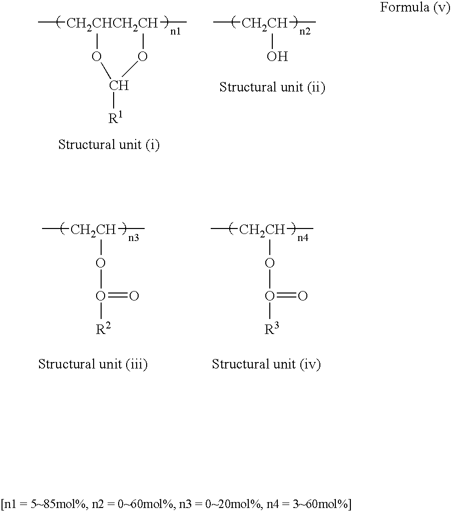

The polyvinyl acetal resin represented by the formula (v) is formed of structural units (i) to (iv), in which a structural unit (i) which is a vinyl acetal component and a structural unit (iv) which is an ester component containing a carboxyl group are essential components, and a structural unit (ii) which is a vinyl alcohol component and a structural unit (iii) which is an unsubstituted ester component are optional components, and the resin can have at least one kind of each structural unit. And, n1 to n4 represent a constitutional ratio (mol %) of each structural unit.

In the structural unit (i), R¹ represents an alkyl group optionally having a substituent, a hydrogen atom, a carboxyl group or a dimethylamino group. Examples of the substituent include a carboxyl group, a hydroxyl group, a chloro group, a bromo group, a urethane group, a ureido group, a tertiary amino group, an alkoxy group, a cyano group, a nitro group, an amido group, and an ester group.

Examples of R¹ in the structural unit (i) include a hydrogen atom, a methyl group, an ethyl group, a propyl group, a butyl group, a pentyl group, a carboxy group, a methyl group substituted with a halogen atom (—Br, —Cl etc.) or a cyano group, a 3-hydroxybutyl group, a 3-methoxybutyl group, and a phenyl group, and inter alia, a hydrogen atom, a propyl group and a phenyl group rare particularly preferable.

And, n1 is preferably in a range of 5 to 85 mol %, more preferably in a range of 25 to 70 mol %.

And, n2 is preferably in a range of 0 to 60 mol %, more preferably in a range of 10 to 45 mol %.

In the structural unit (iii), R² represents an alkyl group having no substituent. Inter alia, an alkyl group having 1 to 10 carbon atoms is preferable, and in particular, a methyl group and an ethyl group are preferable from a viewpoint of developability.

And, n3 is preferably in a range of 0 to 20 mol %, more preferably in a range of 1 to 10 mol %.

In the structural unit (iv), R³ represents an aliphatic hydrocarbon group, an alicyclic hydrocarbon group or an aromatic hydrocarbon group having a carboxyl group, and these hydrocarbon groups preferably have 1 to 20 carbon atoms. In addition, these hydrocarbon groups in this structural unit (iv) are preferably a hydrocarbon group obtained by reacting mainly an acid anhydride such as succinic anhydride, maleic anhydride, phthalic anhydride, trimellitic anhydride, and cis-4-cyclohexene-1,2-dicarboxylic anhydride, and —OH remaining in polyvinyl acetal, inter alia, more preferably a hydrocarbon group obtained by reacting phthalic anhydride or succinic anhydride. Alternatively, a hydrocarbon group obtained by using another cyclic acid anhydride may be used.

R³ in the structural unit (iv) may have a substituent other than a carboxyl group. Examples of such a substituent include the following substituents represented by the following structures.

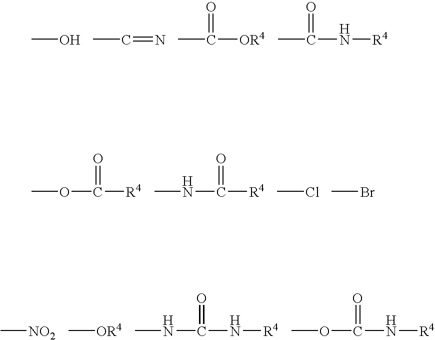

In the above formulas, examples of R⁴ include an alkyl group, an aralkyl group and an aryl group which optionally have a substituent and have 1 to 20 carbon atoms, and examples of a substituent which can be introduced include —OH, —C≡N, —Cl, —Br, and —NO₂.

Examples of R³ in the structural unit (iv) include the following, but the present invention is not limited to them.

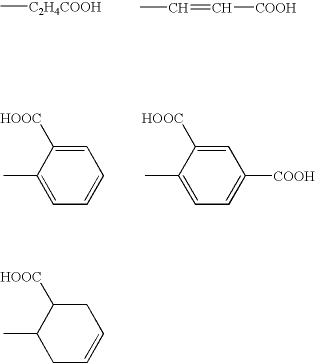

And, n4 is preferably in a range of 3 to 60 mol %, more preferably in a range of 10 to 55 mol %, from a viewpoint of developability.

The polyvinyl acetal resin represented by the formula (v) can be synthesized by a method of acetalating polyvinyl alcohol with aldehyde, and reacting its remaining hydroxy group and an acid anhydride.

Examples of the aldehyde used herein are not limited to, but include formaldehyde, acetoaldehyde, propionaldehyde, butylaldehyde, pentylaldehyde, hexylaldehyde, glyoxylic acid, N,N-dimethylformamide di-n-butylacetal, bromoacetoaldehyde, chloroacetoaldehyde, 3-hydroxy-n-butylaldehyde, 3-methoxy-n-butylaldehyde, 3-(dimethylamino)-2,2-dimethylpropionaldehyde, and cyanoacetoaldehyde.

An acid content in the polyvinyl acetal resin is preferably in a range of 0.5 to 5.0 meq/g (that is, 84 to 280 in terms of mg of KOH), more preferably 1.0 to 3.0 meq/g.

A molecular weight of the polyvinyl acetal resin is preferably about 5000 to 400 thousand, more preferably about 20 thousand to 300 thousand as expressed by a weight average molecular weight measured by gel permeation chromatography. These polyvinyl acetal resins may be used alone, or may be used in combination of two or more kinds.

The alkali-soluble resins used in a lower layer may be used alone, or in combination of two or more kinds.

In the case of a monolayer-type recording layer, a content of the alkali-soluble resin based on a recording layer total solid matter is preferably 30 to 99% by mass, more preferably 40 to 95% by mass from a viewpoint of sensitivity and durability of a recording layer.

In the case of a multi-layered-type recording layer, a content of the alkali-soluble resin based on an uppermost layer total solid matter is preferably 40 to 98% by mass, more preferably 60 to 97% by mass from a viewpoint of sensitivity and durability of a recording layer.

A content of the alkali-soluble resin in lower layer components is preferably 40 to 95% by mass, more preferably 50 to 90% by mass in a total solid matter of a lower layer.

(Development Inhibitor)

A development inhibitor may be contained in a recording layer for the purpose of enhancing its inhibition (dissolution inhibiting ability). When a recording layer has a multi-layered structure, in particular, it is preferable that a development inhibitor is contained in an uppermost layer.

The development inhibitor is not particularly limited as far as it forms interaction with the alkali-soluble resin, substantially reduces solubility of the alkali-soluble resin in a developer in an unexposed area, and has weakened interaction in an exposed area to be soluble in a developer, but in particular, a quaternary ammonium salt, and a polyethylene glycol type compound are preferably used. Some of light-heat converting agents and image coloring agents described later function as a development inhibitor, and they are also preferable examples.

Examples of the quaternary ammonium salt are not particularly limited, but include a tetraalkyl ammonium salt, a trialkylarylammonium salt, a dialkyldiarylammonium salt, an alkyltriarylammonium salt, a tetraarylammonium salt, a cyclic ammonium salt, and a dicyclic ammonium salt.

Specific examples include tetrabutylammonium bromide, tetrapentylammonium bromide, tetrahexylammonium bromide, tetraoctylammonium bromide, tetralaurylammonium bromide, tetraphenylammonium bromide, tetranaphthylammonium bromide, tetrabutylammonium chloride, tetrabutylammonium iodide, tetrastearylammonium bromide, lauryltrimethylammonium bromide, stearyltrimethylammonium bromide, behenyltrimethylammonium bromide, lauryltriethylammonium bromide, phenyltrimethylammonium bromide, 3-trifluoromethylphenyltrimethylammonium bromide, benzyltrimethylammonium bromide, dibenzyldimethylammonium bromide, distearyldimethylammonium bromide, tristearylmethylammonium bromide, benzyltriethylammonium bromide, hydroxyphenyltrimethylammonium bromide, and N-methylpyridinium bromide. In particular, quaternary ammonium salts described in Japanese Patent Application Nos. 2001-226297, 2001-370059 and 2001-398047 are preferable.

From a viewpoint of development inhibiting effect and film making property of the alkali-soluble resin, an addition amount of the quaternary ammonium salt, in the case of a monolayer-type recording layer, is preferably 0.1 to 50% by mass, more preferably 1 to 30% by mass based on a recording layer total solid matter. In the case of a multi-layered-type recording layer, the addition amount is preferably 0.1 to 50% by mass, more preferably 1 to 30% by mass based on an uppermost layer total solid matter.

The polyethylene glycol compound is not particularly limited, but examples include compounds of a structure represented by the following formula (vi).
R⁶¹—{—O—(R⁶³—O—)ₘ—R⁶²}ₙ Formula (vi)

In the formula (vi), R⁶¹ represents a polyhydric alcohol residue or a polyhydric phenol residue, and R⁶² represents a hydrogen atom, or an alkyl group, an alkenyl group, an alkynyl group, an alkyloyl group, an aryl group or an aryloyl group each having 1 to 25 carbon atoms and optionally having a substituent. R⁶³ represents an alkylene residue optionally having a substituent, m represents an integer of 10 or more on average, and n represents an integer of 1 to 4.

Examples of the polyethylene glycol compound represented by the formula (vi) include polyethylene glycols, polypropylene glycols, polyethylene glycol alkyl ethers, polypropylene glycol alkyl ethers, polyethylene glycol aryl ethers, polypropylene glycol aryl ethers, polyethylene glycol alkylaryl ethers, polypropylene glycol alkylaryl ethers, polyethylene glycol glycerin esters, polypropylene glycol glycerin esters, polyethylene sorbitol esters, polypropylene glycol sorbitol esters, polyethylene glycol fatty acid esters, polypropylene glycol fatty acid esters, polyethylene glycolated ethylenediamines, polypropylene glycolated ethylenediamines, polyethylene glycolated diethylenetriamines, and polypropylene glycolated diethylene triamines.

Specific examples include polyethylene glycol 1000, polyethylene glycol 2000, polyethylene glycol 4000, polyethylene glycol 10000, polyethylene glycol 20000, polyethylene glycol 5000, polyethylene glycol 100000, polyethylene glycol 200000, polyethylene glycol 500000, polypropylene glycol 1500, polypropylene glycol 3000, polypropylene glycol 4000, polyethylene glycol methyl ether, polyethylene glycol ethyl ether, polyethylene glycol phenyl ether, polyethylene glycol dimethyl ether, polyethylene glycol diethyl ether, polyethylene glycol diphenyl ether, polyethylene glycol lauryl ether, polyethylene glycol dilauryl ether, polyethylene glycol nonyl ether, polyethylene glycol cetyl ether, polyethylene glycol stearyl ether, polyethylene glycol distearyl ether, polyethylene glycol behenyl ether, polyethylene glycol dibehenyl ether, polypropylene glycol methyl ether, polypropylene glycol ethyl ether, polypropylene glycol phenyl ether, polypropylene glycol dimethyl ether, polypropylene glycol diethyl ether, polypropylene glycol diphenyl ether, polypropylene glycol lauryl ether, polypropylene glycol dilauryl ether, polypropylene glycol nonyl ether, polyethylene glycol acetyl ester, polyethylene glycol diacetyl ester, polyethylene glycol benzoic acid ester, polyethylene glycol lauryl ester, polyethylene glycol dilauryl ester, polyethylene glycol nonylic acid ester, polyethylene glycol cetylic acid ester, polyethylene glycol stearoyl ester, polyethylene glycol distearoyl ester, polyethylene glycol behenic acid ester, polyethylene glycol dibehenic acid ester, polypropylene glycol acetyl ester, polypropylene glycol diacetyl ester, polypropylene glycol benzoic acid ester, polypropylene glycol dibenzoic acid ester, polypropylene glycol lauric acid ester, polypropylene glycol lauric acid ester, polypropylene glycol nonylic acid ester, polyethylene glycol glycerin ether, polypropylene glycol glycerin ether, polyethylene glycol sorbitol ether, polypropylene glycol sorbitol ether, polyethylene glycolated ethylenediamine, polypropylene glycolated ethylenediamine, polyethylene glycolated diethylenetriamine, polypropylene glycolated diethylenetriamine, and polyethylene glycolated pentamethylene hexamine.

From a viewpoint of development inhibiting effect and image forming property, an addition amount of the polyethylene glycol type compound, in the case of a monolayer-type recording layer, is preferably 0.1 to 50% by mass, more preferably 1 to 30% by mass based on a recording layer total solid matter. In the case of a multi-layered-type recording layer, the addition amount is preferably 0.1 to 50% by mass, more preferably 1 to 30% by mass based on an uppermost layer total solid matter.

When such a method for enhancing inhibition (dissolution inhibiting ability) is performed, sensitivity is reduced. In this case, addition of a lactone compound described in JP-A No. 2002-361066 to an uppermost layer is effective for inhibiting reduction in sensitivity.

It is preferable that the dissolution inhibiting agent is used together with a thermally degradable substance which substantially reduces solubility of the alkali-soluble resin when not degraded, such as an onium salt, an o-quinonediazide compound, an aromatic sulfone compound and an aromatic sulfonic acid ester compound, because inhibition of an image area in a developer is improved.

Examples of the onium salt used in the invention include a diazonium salt, an ammonium salt, a phosphonium salt, an iodonium salt, a sulfonium salt, a selenonium salt, and arsonium salt, and particularly preferable examples include diazonium salts described in S. I. Schlesinger, Photogr. Sci. Eng., 18, 387 (1974), T. S. Bale et al., Polymer, 21, 423 (1980), and JP-A No. 5-158230, ammonium salts described in U.S. Pat. Nos. 4,069,055, and 4,069,056, and JP-A No. 3-140140, phosphonium salts described in D. C. Necker et al., Macromolecules, 17, 2468 (1984), C. S. Wen et al., The, Proc. Conf. Rad. Curing ASIA, p 478 Tokyo, October (1988), U.S. Pat. Nos. 4,069,055, and 4,069,056, iodonium salts described in J. V. Crivello et al., Macromolecules, 10 (6), 1307 (1977), Chem. & Eng. News, Nov. 28, p 31 (1988), EP 104,143, U.S. Pat. Nos. 5,041,358, and 4,491,628, JP-A No. 2-150848, and JP-A No. 2-296514, sulfonium salts described in J. V. Crivello et al., Polymer J. 17, 73 (1985), J. V. Crivello et al., J. Org. Chem., 43, 3055 (1978), W. R. Watt et al., J. Polymer Sci., Polymer Chem. Ed., 22, 1789 (1984), J. V. Crivello et al., Polymer Bull., 14, 279 (1985), J. V. Crivello et al., Macromolecules, 14 (5), 1141 (1981), J. V. Crivello et al., J. Polymer Sci., Polymer Chem. Ed., 17, 2877 (1979), EP Nos. 370,693, 233, 567, 297,443, and 297,442, U.S. Pat. Nos. 4,933,377, 3,902,114, 4,491,628, 4,760,013, 4,734,444, and 2,833,827, German Patent Nos. 2,904,626, 3,604,580 and 3,604,581, selenonium salts described in J. V. Crivello et al., Macromolecules, 10 (6), 1307 (1977), J. V. Crivello et al., J. Polymer Sci., Polymer Chem. Ed., 17, 1047 (1979), and arsonium salts described in C. S. Wen et al., The, Proc. Conf. Rad. Curing ASIA, B478 Tokyo, October (1988).

Among such onium salts, a diazonium salt is particularly preferable. Particularly preferable examples of a diazonium salt include those described in JP-A No. 5-158230.

Examples of a counterion of an onium salt include anions from tetrafluoroboric acid, hexafluorophosphoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorocaprylnaphthalenesulfonic acid, dodecylbenzenesulfonic acid, 1-naphthol-5-sulfonic acid, 2-methoxy-4-hydroxy-5-benzoyl-benzenesulfonic acid and paratoluenesulfonic acid. Among them, in particular, anions from hexafluorophosphoric acid and alkyl aromatic sulfonic acid such as triisopropylnaphthalenesulfonic acid and 2,5-dimethylbenzenesulfonic acid are preferable.

Preferable examples of quinonediazides include an o-quinonediazide compound. The o-quinonediazide compound used in the invention is a compound which has at least one o-quinonediazido group and is thermally degraded to increase alkali solubility, and compounds of various structures can be used. That is, the o-quinonediazide assists solubility of an uppermost layer due to both the effects of loss of inhibition as a development inhibitor and change of the o-quinonediazide itself into an alkali-soluble substance when thermally degraded.

As such an o-quinonediazide compound, compounds described, for example, in J. Coser “Light-Sensitive Systems” (John Wiley & Sons. Inc.), p 339-352 can be used, and in particular, sulfonic acid ester or sulfonic acid amide of o-quinonediazide obtained by reacting with various aromatic polyhydroxy compounds or aromatic amino compounds are suitable. In addition, an ester of benzoquinone(1,2)-diazidosulfonic acid chloride or naphthoquinone-(1,2)-diazido-5-sulfonic acid chloride and pyrogallol-acetone resin described in JP-B No. 43-28403, and an ester of benzoquinone-(1,2)-diazidosulfonic acid chloride or naphthoquinone-(1,2)-diazido-5-sulfonic acid chloride and a phenol-formaldehyde resin described in U.S. Pat. Nos. 3,046,120 and 3,188,210 are suitably used.

Further, an ester of naphthoquinone-(1,2)-diazido-4-sulfonic acid chloride and a phenol formaldehyde resin or a cresol-formaldehyde resin, and an ester of naphthoquinone-(1,2)-diazido-4-sulfonic acid chloride and a pyrogallol-acetone resin are similarly preferably used. Other useful o-quinonediazide compounds are reported in many patents and are known. Examples include those described in JP-A No. 47-5303, JP-A No. 48-63802, JP-A No. 48-63803, JP-A No. 48-96575, JP-A No. 49-38701, JP-A No. 48-13354, JP-B No. 41-11222, JP-B No. 45-9610, JP-B No. 49-17481, U.S. Pat. Nos. 2,797,213, 3,454,400, 3,544,323, 3,573,917, 3,674,495, and 3,785,825, British Patent Nos. 1,227,602, 1,251,345, 1,267,005, 1,329,888, and 1,330,932, and German Patent No. 854,890.

An addition amount of the o-quinonediazide compound, in the case of a monolayer-type recording layer, is preferably 1 to 50% by mass, more preferably in a range of 5 to 30% by mass based on a recording layer total solid matter. In the case of a multi-layered-type recording layer, the amount is preferably in a range of 1 to 50% by mass, further preferably 5 to 30% by mass, particularly preferably 10 to 30% by mass based on an uppermost layer total solid matter. These compounds can be used alone, or may be used as a mixture of a few kinds of them.

In addition, for the purpose of enhancing inhibition of a recording layer surface as well as enhancing resistance to abrasion on a surface, it is preferable to additionally use a polymer prepared from a (meth)acrylate monomer having two or more perfluoroalkyl groups having 3 to 20 carbon atoms in a molecule as a polymerization component, as described in JP-A No. 2000-187318.

An addition amount thereof, in the case of a monolayer-type recording layer, is preferably 0.1 to 10% by mass, more preferably 0.5 to 5% by mass based on a recording layer total solid matter. In the case of a multi-layered-type recording layer, the amount is preferably 0.1 to 10% by mass, more preferably 0.5 to 5% by mass based on an uppermost layer total solid matter.

(Infrared Absorber)

An infrared absorber in the invention will be explained.

The planographic printing plate precursor of the invention contains an infrared absorber which has maximum absorption in an infrared region and has light-heat converting ability, thus allowing recording by an infrared laser.

The infrared absorber used in the invention is not particularly limited, as far as it is a dye which absorbs infrared light or near infrared light and generates heat, and various dyes known as an infrared absorber can be used.

When a recording layer in the invention is a monolayer-type recording layer, it is required that the recording layer contains an infrared absorber. When a recording layer in the invention has a multi-layered structure, at least one of a lower layer and/or an uppermost layer is a layer containing an infrared absorber, and it is preferable to add an infrared absorber to both of a lower layer and an uppermost layer.

As the infrared absorber, commercially available dyes, and the known dyes described in the literature (e.g. “Dye Handbook”, edited by Organic Synthesis Chemistry Association, published in 1970) can be utilized. Specific examples include dyes such as an azo dye, a metal complex salt azo dye, a pyrazoloneazo dye, an anthraquinone dye, a phthalocyanine dye, a carbonium dye, a quinoneimine dye, a methine dye, and a cyanine dye. In the invention, among these dyes, those absorbing infrared light or near infrared light are particularly preferable since they are suitable for use with lasers emitting infrared light or near infrared light.

Examples of preferable dyes include cyanine dyes described in JP-A No. 58-125246, JP-A No. 59-84356, JP-A No. 60-78787, and U.S. Pat. No. 4,973,572, methine dyes described in JP-A No. 58-173696, JP-A No. 58-181690, and JP-A No. 58-194595, naphthoquinone dyes described in JP-A No. 58-112793, JP-A No. 58-224793, JP-A No. 59-48187, JP-A No. 59-73996, JP-A No. 60-52940, and JP-A No. 60-63744, squarylium dyes described in JP-A No. 58-112792, and cyanine dyes described in British Patent No. 434,875.

As the dye, a near infrared absorbing sensitizers described in U.S. Pat. No. 5,156,938 are also suitably used, and substituted arylbenzo(thio)pyrylium salts described in U.S. Pat. No. 3,881,924, trimethinethiapyrylium salts described in JP-A No. 57-142645 (U.S. Pat. No. 4,327,169), Pyrylium compounds described in JP-A Nos. 58-181051, 58-220143, 59-41363, 59-84248, 59-84249, 59-146063, and 59-146061, cyanine dyes described in JP-A No. 59-216146, pentamethinethiopyrylium salts described in U.S. Pat. No. 4,283,475, and pyrylium compounds disclosed in JP-B Nos. 5-13514, and 5-19702 and, as a commercially available dye, Epolight 111-178, Epolight 111-130, and Epolight 111-125 manufactured by Epolin are particularly preferably used.

Another example which is particularly preferable as a dye includes near infrared absorbing dyes described in U.S. Pat. No. 4,756,993 as the formulas (I) and (II).

Among these dyes, particularly preferable examples include cyanine dyes, squarylium dyes, pyrylium salts, nickel thiolate complexes, and indolenine cyanine dyes. Cyanine dyes and indolenine cyanine dyes are further preferable, and one particularly preferable example is a cyanine dye represented by the following formula (a).

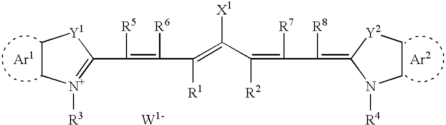

In the formula (a), X¹ represents a hydrogen atom, a halogen atom, —NPh₂, X²-L¹ or a group shown later, wherein X² represents an oxygen atom, a nitrogen atom or a sulfur atom, and L¹ represents a hydrocarbon group having 1 to 12 carbon atoms, an aromatic ring having a heteroatom, or a hydrocarbon group having 1 to 12 carbon atoms containing a heteroatom. Herein, a heteroatom represents N, S, O, a halogen atom or Se. W¹⁻ is as defined for Xa⁻ described later, and R^{a} represents a substituent selected from a hydrogen atom, an alkyl group, an aryl group, a substituted or unsubstituted amino group, and a halogen atom.

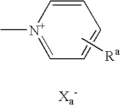

In the formula (a), R¹ and R² each represent independently a hydrocarbon group having 1 to 12 carbon atoms. From a viewpoint of storage stability of a recording layer coating solution, R¹ and R² are preferably a hydrocarbon group having 2 or more carbon atoms, and R¹ and R² are further preferably bonded together to form a 5-membered ring or a 6-membered ring.

Ar¹ and Ar² may be the same or different, and represent an aromatic hydrocarbon group optionally having a substituent. Examples of a preferable aromatic hydrocarbon group include a benzene ring and a naphthalene ring. Examples of a preferable substituent include a hydrocarbon group having 12 or less carbon atoms, a halogen atom, and an alkoxy group having 12 or less carbon atoms. Y¹ and Y² may be the same or different, and represent a dialkylmethylene group having 12 or less sulfur atoms or carbon atoms. R³ and R⁴ may be the same or different, and represent a hydrocarbon group having 20 or less carbon atoms and optionally having a substituent. Examples of a preferable substituent include an alkoxy group having 12 or less carbon atoms, a carboxyl group, and a sulfo group. R⁵, R⁶, R⁷ and R⁸ may be the same or different, and represent a hydrogen atom or a hydrocarbon group having 12 or less carbon atoms. From availability of a raw material, they are preferably a hydrogen atom. Xa⁻ represents a counteranion, but when a cyanine dye represented by the formula (a) has an anionic substituent in its structure, and neutralization of a charge is not necessary, W¹⁻ is not necessary. From a viewpoint of storage stability of a recording layer coating solution, preferable Xa⁻ is a halogen ion, a perchlorate ion, a tetrafluoroborate ion, a hexafluorophosphate ion, and a sulfonate ion, particularly preferably a perchlorate ion, a hexafluorophosphate ion, and an arylsulphonate ion.

In the case of a multi-layered-type recording layer, from a viewpoint of sensitivity, it is preferable that an infrared absorber is added to an uppermost layer of a recording layer or a vicinity thereof. In particular, when a component having dissolution inhibiting ability such as a cyanine dye together with an alkali-soluble resin having a phenol group is added, high sensitivity of the recording layer can be obtained, and at the same time, an unexposed area can be endowed with alkali dissolution resistance. Alternatively, the infrared absorber may be added to a lower layer, or may be added to both of an uppermost layer and a lower layer. By adding to a lower layer, further higher sensitivity is obtained. When an infrared absorber is added to both of an uppermost layer and a lower layer, same infrared absorber may be added to each layer or different infrared absorber may be added to each layer.

Alternatively, a layer other than a recording layer is provided, and the infrared absorbing layer may be added to the layer. When another layer is provided, it is desirable to add the infrared absorber to a layer adjacent to a recording layer.

In the case of a monolayer-type recording layer, an addition amount of the infrared absorber is preferably 3 to 50% by mass, further preferably 5 to 40% by mass based on a recording layer total solid matter. In the case of a multi-layered-type recording layer, when the absorber is added to an uppermost layer of a recording layer, the amount is 0.01 to 50% by mass, preferably 0.1 to 30% by mass, particularly preferably 1.0 to 30% by mass based on an uppermost layer total solid matter. When the addition amount is in the above range, sensitivity and durability of a recording layer become excellent. On the other hand, when the absorber is added to a lower layer, the absorber can be added in an amount of 0 to 20% by mass, preferably 0 to 10% by mass, particularly preferably 0 to 5% by mass, based on a lower layer total solid matter.

In the case where the infrared absorber is added to a lower layer, when the infrared absorber having dissolution inhibiting ability is used, solubility of a lower layer is reduced, but on the other hand, the infrared absorber generates heat at the time of infrared laser exposure, and improvement in solubility of a lower layer due to heat is expected. Accordingly, compounds to be added and an addition amount thereof should be selected in view of balance therebetween. At a region around 0.2 to 0.3 μm from a support surface, heat generated at the time of exposure is diffused into the support, the effect of improving solubility due to heat is hardly obtained, and reduction in solubility of a lower layer due to addition of the infrared absorber becomes a cause for reduction in sensitivity in some cases. Therefore, within the range of an addition amount shown above, such an addition amount that a dissolution rate of a lower layer in a developer (25 to 30° C.) is below 30 nm/sec is not preferable.

(Other Additives)

At the time of formation of a recording layer, in addition to the aforementioned components, various additives may be further added as necessary, as far as the effect of the invention is not deteriorated.

In the case of a multi-layered-type recording layer, the following additives may be added to only a lower layer of a recording layer, may be added to only an uppermost layer, or may be added to both layers.

<Development Accelerator>

For the purpose of improving sensitivity, acid anhydrides, phenols and organic acids may be added to a recording layer.

As acid anhydrides, a cyclic acid anhydride is preferable, and specifically as the cyclic acid anhydride, phthalic anhydride, tetrahydrophthalic anhydride, hexahydrophthalic anhydride, 3,6-endoxy-tetrahydrophthalic anhydride, tetrachlorophthalic anhydride, maleic anhydride, chloromaleic anhydride, α-phenylmaleic anhydride, succinic anhydride, and pyromellitic anhydride each described in U.S. Pat. No. 4,115,128 can be used. Examples of a non-cyclic acid anhydride include acetic anhydride.

Examples of phenols include bisphenol A, 2,2′-bishydroxysulfone, 4,4′-bishydroxysulfone, p-nitrophenol, p-ethoxyphenol, 2,4,4′-trihydroxybenzophenone, 2,3,4-trihydroxybenzophenone, 4-hydroxybenzophenone, 4,4′-4″-trihydroxytriphenylmethane, and 4,4′,3″,4″-tetrahydroxy-3,5,3′,5′-tetramethyltriphenylmethane.

Examples of organic acids include sulfonic acids, sulfinic acids, alkylsulfuric acids, phosphonic acids, phosphoric acid esters and carboxylic acids each described in JP-A No. 60-88942, and JP-A No. 2-96755, and specific examples include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phtalic acid, terephthalic acid, 4-cyclohexene-1,2-dicarboxylic acid, erucic acid, lauric acid, n-undecanoic acid, and ascorbic acid.

In the case of a monolayer-type recording layer, a ratio of acid anhydrides, phenols or organic acids contained in a recording layer total solid matter is preferably 0.05 to 20% by mass, more preferably 0.1 to 15% by mass, particularly preferably 0.1 to 10% by mass. In the case of a multi-layered-type recording layer, a ratio of acid anhydrides, phenols or organic acids contained in a total solid matter of a lower layer of a recording layer or an uppermost layer is preferably 0.05 to 20% by mass, more preferable 0.1 to 15% by mass, particularly preferably 0.1 to 10% by mass, respectively.

<Surfactant>

In order to improve coatability and stability of treatment in developing condition, nonionic surfactants described in JP-A No. 62-251740 and JP-A No. 3-208514, amphoteric surfactants described in JP-A No. 59-121044 and JP-A No. 4-13149, siloxane compounds described in European Patent No. 950517, and copolymers of a fluorine-containing monomer described in JP-A No. 62-170950, JP-A No. 11-288093, and JP-A No. 2003-057820 can be added to a recording layer.

In the case of a monolayer-type recording layer, a ratio of a surfactant contained in a recording layer total solid matter is preferably 0.01 to 15% by mass, more preferably 0.1 to 5% by mass, particularly preferably 0.05 to 0.5% by mass.

In the case of a multi-layered-type recording layer, a ratio of a surfactant contained in a total solid matter of a lower layer of a recording layer or an uppermost layer is preferably 0.01 to 15% by mass, more preferably 0.1 to 5.0% by mass, further preferably 0.05 to 2.0% by mass.

<Printing-Out Agent/Coloring Agent>

A printing-out agent for obtaining a visualized image immediately after heating by exposure, and a dye and a pigment as an image coloring agent can be added to a recording layer.

Typical examples of the printing-out agent include a combination of an organic dye which can form a salt with a compound releasing an acid when heated by exposure to light (photo acid releasing agent). Specific examples include a combination of o-naphthoquinonediazido-4-sulfonic acid halogenide and a salt forming organic dye described in JP-A Nos. 50-36209 and 53-8128, and a combination of a trihalomethyl compound and a salt forming organic dye described in JP-A Nos. 53-36223, 54-74728, 60-3626, 61-143748, 61-151644 and 63-58440. As such a trihalomethyl compound, there are an oxazole compound and a triazine compound, and both compounds are excellent in stability with time, and give a clear printed out image.

As the image coloring agent, in addition to the aforementioned salt forming organic dye, other dyes can be used. Examples of preferable dyes including the salt forming organic dye include oil-soluble dyes and basic dyes. Specific examples include Oil Yellow #101, Oil Yellow #103, Oil Pink #312, Oil Green BG, Oil Blue BOS, Oil Blue #603, Oil Black BY, Oil Black BS, Oil Black T-505 (all manufactured by Orient Chemical Industries, Ltd.), Victoria Pure Blue, Crystal Violet Lactone, Crystal Violet (CI42555), Methyl Violet (CI42535), Ethyl Violet, rhodamine B (CI145170 B), Malachite Green (CI42000), and Methylene Blue (CI52015). In addition, dyes described in JP-A No. 62-293247 are particularly preferable.

In the case of a monolayer-type recording layer, these dyes can be added at a ratio of 0.01 to 10% by mass, preferably 0.1 to 3% by mass based on a total solid matter of a recording layer.

In the case of a multi-layered-type recording layer, those dyes can be added at a ratio of 0.01 to 10% by mass, preferably 0.1 to 3% by mass based on a total solid matter of a lower layer of a recording layer or an uppermost layer.

<Plasticizer>

A plasticizer may be added to a recording layer in order to impart softness to a coated film. For example, butyl phthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl oleate, and an oligomer and a polymer of acrylic acid or methacrylic acid are used.

In the case of a monolayer-type recording layer, these plasticizers can be added at a ratio of 0.5 to 10% by mass, preferably 1.0 to 5.0% by mass based on a total solid matter of a recording layer.

In the case of a recording layer of a multi-layered structure, they can be added at a ratio of 0.5 to 10% by mass, preferably 1.0 to 5.0% by mass based on a total solid matter of a lower layer of a recording layer or an uppermost layer.

<WAX Agent>

For the purpose of imparting resistance to abrasion, a compound which reduces a static friction coefficient of a surface may be added to a monolayer-type recording layer or an uppermost layer of a multi-layered-type recording layer according to the invention. Specific examples include compounds having an ester of long-chain alkylcarboxylic acid described in U.S. Pat. No. 6,117,913, and those compounds described in Japanese Patent Application Nos. 2001-261627 and 2002-032904 and Japanese Patent Application No. 2002-165584 which were previously proposed by the present applicant.

As an addition amount, in the case of a monolayer-type recording layer, the agent can be added at a ratio of 0.1 to 10% by mass, preferably 0.5 to 5.0% by mass based on a total solid matter of a recording layer.

In the case of a recording layer of a multi-layered structure, a ratio of the agent in an uppermost layer of a recording layer is preferably 0.1 to 10% by mass, more preferably 0.5 to 5% by mass.

(Formation of a Recording Layer)

A recording layer in the planographic printing plate precursor of the invention can be formed by dissolving respective components constituting a recording layer in a solvent, and coating the solution.

Examples of the solvent used herein are not limited to, but include ethylene dichloride, cyclohexanone, methyl ethyl ketone, methanol, ethanol, propanol, ethylene glycol monomethyl ether, 1-methoxy-2-propnaol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethyl sulfoxide, sulfolane, γ-butyrolactone, and toluene. These solvents are used alone, or in combination.

In the case of a multi-layered-type recording layer, it is preferable that a lower layer and an uppermost layer of a recording layer are formed, in principle, so as to separate the two layers.

Examples of a method of forming two layers so as to separate them include a method utilizing a difference in solvent solubility between components contained in a lower layer and components contained in an uppermost layer, and a method of coating an uppermost layer, and rapidly drying and removing a solvent.

Details of these methods are described in JP-A No. 2002-251003.

In order to impart new function, partial compatibilization between an uppermost layer and a lower layer is positively performed in some cases in such a range that the effect of the invention is sufficiently exerted. In this case, partial compatibilization becomes possible by controlling a difference in solvent solubility, and a rate of drying a solvent after coating an uppermost layer.

A concentration of the aforementioned components except for a solvent (a total solid matter containing additives) in a coating solution for a recording layer which is to be coated on a support is preferably 1 to 50% by mass.

As a coating method, various methods can be used, and examples include a bar coater coating, rotation coating, spray coating, curtain coating, dip coating, air knife coating, blade coating, and roll coating.

In particular, in the case of a multi-layered type recording layer, in order to prevent damage on a lower layer at the time of coating an uppermost layer, it is desirable that an uppermost layer coating method is non-contact manner. As a method which is generally used for coating in a solvent system but is a contact type method, it is also possible to use bar coater coating, but in order to prevent damage on a lower layer, it is desirable to perform coating by forward rotation driving.

In the case of a monolayer-type recording layer, a coating amount after drying of a recording layer is preferably in a range of 0.3 to 3.0 μg/m², further preferably in a range of 0.5 to 2.5 g/m².

In the case of a multi-layered type recording layer, a coating amount after drying of a lower layer component is preferably in a range of 0.5 to 4.0 g/m², further preferably in a range of 0.6 to 2.5 g/m2. When the amount is 0.5 g/m2 or more, printing durability is excellent, and when the amount is 4.0 g/m² or less, excellent image reproducibility and sensitivity are obtained.

A coating amount after drying of an uppermost layer component is preferably in a range of 0.05 to 1.0 g/m², further preferably in a range of 0.08 to 0.7 g/m². When the amount is 0.05 g/m² or more, excellent development latitude and abrasion resistance are obtained, and when the amount is 1.0 g/m² or less, excellent sensitivity is obtained.

A total coating amount after drying of a lower layer and an uppermost layer is preferably in a range of 0.6 to 4.0 g/m², further preferably in a range of 0.7 to 2.5 g/m². When the amount is 0.6 g/m² or more, excellent printing durability is obtained, and when the amount is 4.0 g/m² or less, excellent image reproducibility and sensitivity are obtained.

[Back Coating Layer (Organic Polymer Layer)]

The planographic printing plate precursor of the first aspect the invention has a back coating layer which has a thickness of 0.3 μm or more and contains an organic polymer on a support at a side (a back surface of a support) opposite to a side having a recording layer.

It is required that a thickness of a back coating layer in the first aspect of the invention is 0.3 μm or more, and from a viewpoint of printing durability improving effect and printing size stability, the thickness is preferably 0.3 μm to 50 μm, more preferably 0.5 μm to 25 μm, particularly preferably 1.0 μm to 20 μm.

In the second aspect of the invention, the precursor has an organic polymer layer comprising a long-chain alkyl group-containing polymer and an organic polymer that is different from the long-chain alkyl group-containing polymer on a support at a side opposite to a side having a recording layer. Examples of the long-chain alkyl group-containing polymer contained in the organic polymer layer include the examples of the long-chain alkyl group-containing polymer used in a recording layer in the first aspect of the invention.

In the second aspect of the invention, an addition amount of the long-chain alkyl group-containing polymer contained in a total solid matter of an organic polymer layer is preferably around 0.01 to 30% by mass, further preferably 0.1 to 20% by mass, particularly preferably 0.5 to 10% by mass. When the content is less than 0.01 by mass, or when the content exceeds 30% by mass, formation of irregularities (fine projections) is insufficient, so that abrasion resistance improving effect is not sufficiently obtained in some cases.

The organic polymer layer in the second aspect of the invention contains, together with the long-chain alkyl group-containing polymer, an organic polymer that is different from the long-chain alkyl group-containing polymer as a base polymer contained in the organic polymer layer. As the organic polymer, a polymer which is not compatible with the long-chain alkyl group-containing polymer is suitably used.

According to the third aspect of the invention, the precursor has an organic polymer layer on a support at a side opposite to a side having a recording layer. The organic polymer layer contains an organic polymer as a base polymer for forming a layer.

(Organic Polymer)

Organic polymers which are suitably used in a back coating layer (organic polymer layer) will be exemplified below, without any limitation.

Examples include novolak resins such as a phenol formaldehyde resin, a m-cresol formaldehyde resin, a p-cresol formaldehyde resin, a m-/p-mixed cresol formaldehyde resin, and a phenol/cresol (any of m-, p- and m-/p-mixed may be used) mixed formaldehyde resin, and pyrogallol acetone resins.

Examples include at least one kind resin selected from the group consisting of a saturated copolymerized polyester resin, a phenoxy resin, a polyvinyl acetal resin and a vinylidene chloride copolymer resin.

The saturated copolymerized polyester resin consists of a dicarboxylic acid unit and a diol unit. Examples of the dicarboxylic acid unit of polyester used in the invention include aromatic dicarboxylic acids such as phthalic acid, terephthalic acid, isophthalic acid, tetrabromophthalic acid, and tetrachlorophthalic acid; saturated aliphatic dicarboxylic acids such as adipic acid, azelaic acid, succinic acid, oxalic acid, suberic acid, sebacic acid, malonic acid, and 1,4-cyclohexanedicarboxylic acid.

Examples of the diol unit include aliphatic chain diols such as ethylene glycol, diethylene glycol, triethylene glycol, polyethylene glycol, propylene glycol, dipropylene glycol, polypropylene glycol, 1,3-butylene glycol, 2,3-butylene glycol, 1,4-butylene glycol, neopentyl glycol, hexanediol, and 2,2,4-trimethyl-1,3-pentanediol; cyclic diols such as 1,4-bis-β-hydroxyethoxycyclohexane, cyclohexanedimethanol, tricyclodecanedimethanol, bisphenoldioxyethyl ether, and bisphenoldioxypropyl ether.

These dicarboxylic acid and diol units are at least one kind or more, respectively, and either of them is used as two or more kinds of copolymerization units, and a nature of copolymer is determined by a copolymerization composition and a molecular weight.

The back coating layer (organic polymer layer) in the invention can be provided by thermal press bonding of a film or a melt lamination method, but coating using a solution is more preferable from a viewpoint of effective provision of a thin layer. Therefore, when a copolymerized polyester resin is used as the organic polymer, a resin which is non-crystalline and is easily dissolved in industrial various organic solvents is preferable.

When a copolymerized polyester resin is used as the organic polymer, its molecular weight is preferably 10,000 or more from a viewpoint of film strength of a back coating layer (organic polymer layer).

The phenoxy resin is prepared from bisphenol A and epichlorohydrin, like an epoxy resin, is excellent in chemical resistance and adherability without assisting action of a curing agent or a catalyst as compared with an epoxy resin, and is suitable as a main component of a back coating layer (organic polymer layer).

The polyvinyl acetal resin is a resin in which polyvinyl alcohol is acetalated with aldehyde such as butylaldehyde and formaldehyde, and a polyvinyl butyral resin and a polyvinyl formal resin are preferably used. These polyvinyl acetal resins are different in a physical nature and a chemical nature depending on an acetalation degree, a compositional ratio of a hydroxyl group and an acetyl group, and a polymerization degree, and in a back coating layer (organic polymer layer) in the invention, resins having a glass transition temperature of 60° C. or higher are preferable.

As the vinylidene chloride copolymer resin, copolymer resins of a vinylidene chloride monomer, and a vinyl monomer such as vinyl chloride, vinyl acetate, ethylene and vinyl methyl ether, or an acryl monomer such as (meth)acrylic acid ester, and (meth)acrylonitrile are used. Inter alia, a vinylidene chloride copolymer containing acrylonitrile in a range of 20 mol % or less is rich in solubility in a general-use organic solvent, and thus preferable.

As the organic polymer contained in a back coating layer (organic polymer layer), the following other hydrophobic polymer compounds may also be used. Suitable examples of the hydrophobic polymer compound include polybutene, polybutadiene, polyamide, unsaturated copolymerized polyester resin, polyurethane, polyurea, polyimide, polysiloxane, polycarbonate, epoxy resin, chlorinated polyethylene, alkyl phenol aldehyde-condensed resin, polyvinyl chloride, polyvinylidene chloride, polystyrene, acryl resin and a copolymerized resin thereof, hydroxyl cellulose, polyvinyl alcohol, cellulose acetate, and carboxymethylcellulose.

Examples of other suitable hydrophobic polymer compounds include copolymers usually having a molecular weight of 10 thousand to 200 thousand which are formed from monomers shown in the following (1m) to (12m) as constitutional units thereof.

(1m) Acrylamides, methacrylamides, acrylic acid esters, methacrylic acid esters and hydroxylstyrenes each having an aromatic hydroxyl group, for example, N-(4-hydroxylphenyl)acrylamide or N-(4-hydroxylphenyl)methacrylamide, o-, m- or p-hydroxylstyrene, and o-,m- or p-hydroxylphenyl acrylate or methacrylate.

(2m) Acrylic acid esters and methaclyric acid esters each having an aliphatic hydroxyl group, for example, 2-hydroxylethyl acrylate and 2-hydroxyethyl methacrylate.

(3m) (Substituted) acrylic acid esters such as methyl acrylate, ethyl acrylate, propyl acrylate, butyl acrylate, amyl acrylate, hexyl acrylate, cyclohexyl acrylate, octyl acrylate, phenyl acrylate, benzyl acrylate, 2-chloroethyl acrylate, 4-hydroxylbutyl acrylate, glycidyl acrylate, and N-dimethylaminoethyl acrylate.

(4m) (Substituted) methacrylic acid esters such as methyl methacrylate, ethyl methacrylate, propyl methacrylate, butyl methacrylate, amyl methacrylate, hexyl methacrylate, cyclohexyl methacrylate, octyl methacrylate, phenyl methacrylate, benzyl methacrylate, 2-chloroethyl methcacrylate, 4-hydroxylbutyl methacrylate, glycidyl methacrylate and N-dimethylaminoethyl methacrylate.

(5m) Acrylamides or methacrylamides such as acrylamide, methacrylamide, N-methylolacrylamide, N-methylolmethacrylamide, N-ethylacrylamide, N-ethylmethacrylamide, N-hexylacrylamide, N-hexylmethacrylamide, N-cyclohexylacrylamide, N-cyclohexylmethacrylamide, N-hydroxylethylacrylamide, N-hydroxylethylmethacrylamide, N-phenylacrylamide, N-pheynlmethacrylamide, N-benzylacrylamide, N-benzylmethacrylamide, N-nitrophenylacrylamide, N-nitrophenylmethacrylamide, N-ethyl-N-phenylacrylamide and N-ethyl-N-phenylmethacrylamide.

(6m) Vinyl ethers such as ethyl vinyl ether, 2-chloroethyl vinyl ether, hydroxylethyl vinyl ether, propyl vinyl ether, butyl vinyl ether, octyl vinyl ether, and phenyl vinyl ether.

(7m) Vinyl esters such as vinyl acetate, vinyl chloroacetate, vinyl butyrate, and vinyl benzoate.

(8m) Styrenes such as styrene, methylstyrene, and chloromethylstyrene.

(9m) Vinyl ketones such as methyl vinyl ketone, ethyl vinyl ketone, propyl vinyl ketone, and phenyl vinyl ketone.

(10m) Olefins such as ethylene, propylene, isobutylene, butadiene, and isoprene.

(11m) N-vinylpyrrolidone, N-vinylcarbazole, 4-vinylpyridine, acrylonitrile, and methacrylonitrile.

(12m) Acrylamides such as N-(o-aminosulfonylphenyl)acrylamide, N-(m-aminosulfonylphenyl)acrylamide, N-(p-aminosulfonylphenyl)acrylamide, N-[1-(3-aminosulfonyl)naphthyl]acrylamide, and N-(2-aminosulfonylethyl)acrylamide, methacrylamides such as N-(o-aminosulfonylphenyl)methacrylamide, N-(m-aminosulfonylphenyl)methacrylamide, N-(p-aminosulfonylphenyl)methacrylamide, N-[1-(3-aminosulfonyl)naphthyl]methacrylamide, and N-(2-aminosulfonylethyl)methacrylamide, unsaturated sulfonamides such as acrylic acid esters such as o-aminosulfonylphenyl acrylate, m-aminosulfonylphenyl acrylate, p-aminosulfonylphenyl acrylate, and 1-(3-aminosulfonylphenylnaphtyl)acrylate, and unsaturated sulfonamides such as methacrylic acid esters such as o-aminosulfonylphenyl methacrylate, m-aminosulfonylphenyl methacrylate, p-aminosulfonylphenyl methacrylate, and 1-(3-aminosulfonylphenylnaphthyl)methacrylate.

Further, a monomer which is copolymerizable with the aforementioned monomers may be copolymerized. In addition, those obtained by modifying a copolymer obtained by copolymerization of the aforementioned monomers, for example, with glycidyl acrylate or glycidyl methacrylate are also exemplified.

These other hydrophobic polymer compounds may be used alone, or two or more kinds thereof may be used together. In addition, when those compounds are used together with a saturated copolymerized polyester resin, a phenoxy resin, a polyvinyl acetal resin and/or a vinylidene chloride copolymerized resin, they may be added in an amount of 50% by mass or less based on a total solid matter of a back coating layer (organic polymer layer), and an amount of those compounds is preferably 30% by mass or less in order to utilize property of the resins.

A content of the organic polymer contained in a total solid matter of a back coating layer (organic polymer layer) is preferably 99.99 to 70% by mass, more preferably 99.9 to 80% by mass, particularly preferably 99.5 to 90% by mass.

(Other Components)

For the purpose of imparting flexibility, adjusting slidability and improving a coating surface state, plasticizers, surfactants and other additives may be added to a back coating layer (organic polymer layer) in such an amount that the effect of the invention is not deteriorated.

As the plasticizer, for example, phthalic acid esters such as dimethyl phthalate, diethyl phthalate, dibutyl phthalate, diisobutyl phthalate, dioctyl phthalate, octylcapryl phthalate, dicyclohexyl phthalate, ditridecyl phthalate, butylbenzyl phthalate, diisodecyl phthalate, and diallyl phthalate, glycol esters such as dimethylglycol phthalate, ethylphthalylethyl glycolate, methylphthalylethyl glycolate, butylphthalylbutyl glycolate, and triethylene glycol dicaprylic acid ester, phosphate esters such as tricresyl phosphate, and triphenyl phosphate, aliphatic dibasic acid esters such as diisobutyl adipate, dioctyl adipate, dimethyl sebacate, dibutyl sebacate, dioctyl azelate, and dibutyl maleate, polyglycidyl methacrylate, triethyl citrate, glycerin triacetyl ester, and butyl laurate are effective.

An addition amount of the plasticizer varies depending on the kind of an organic polymer used in a back coating layer (organic polymer layer), and it is preferable that the plasticizer is added in such an amount that a glass transition temperature of the layer is not 60° C. or lower.

Examples of the surfactant include anionic, cationic, nonionic and amphoteric surfactants. Specific examples include nonionic surfactants such as polyoxyethylene alkyl ethers, polyoxyethylene alkyl phenyl ethers, polyoxyethylene polystyryl phenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sucrose fatty acid partial esters, polyoxyethylene sorbitan fatty acid partial esters, polyoxyethylene sorbitol fatty acid partial esters, polyethylene glycol fatty acid esters, polyglycerin fatty acid partial esters, polyoxyethylenated castor oils, polyoxyethyleneglycerin fatty acid partial esters, fatty acid diethanolamides, N,N-bis-2-hydroxyalkylamines, polyoxyethylenealkylamine, triethanolamine fatty acid ester, and trialkylamine oxide, anionic surfactants such as fatty acid salts, abietic acid salts, hydroxyalkanesulfonic acid salts, alkanesulfonic acid salts, dialkylsulfosuccinic acid ester salts, straight chain alkylbenzenesulfonic acid salts, branched alkylbenzenesulfonic acid salts, alkylnaphthalenesulfonic acid salts, alkylphenoxypolyoxyethylenepropylsulfonic acid salts, polyoxyethylene alkyl sulfophenyl ether salts, N-methyl N-oleyltaurine sodium salt, N-alkylsulfosuccinic acid monoamide disodium salt, petroleum sulfonic acid salts, sulfated beef tallow oil, sulfate ester salts of fatty acid alkyl ester, alkyl sulfate ester salts, polyoxyethylene alkyl ether sulfate ester salts, fatty acid monoglyceride sulfate ester salts, polyoxyethylene alkyl phenyl ether sulfate ester salts, polyoxyethylene styryl phenyl ether sulfate ester salts, alkylphosphate ester salts, polyoxyethylene alkyl ether phosphate ester salts, polyoxyethylene alkyl phenyl ether phosphate ester salts, partial saponified products of styrene/maleic anhydride copolymer, partial saponified products of olefin/maleic anhydride copolymer, and naphthalenesulfonic acid salt formalin condensates, cationic surfactants such as alkylamine salts, quaternary ammonium salts, polyoxyethylenealkylamine salts, and polyethylenepolyamine derivative, and amphoteric surfactants such as carboxylbetaines, aminocarboxylic acids, sulfobetaines, aminosulfate esters, and imidazolines. Among the above-listed surfactants, polyoxyethylene can be also read as polyoxyalkylene such as polyoxymethylene, polyoxypropylene and polyoxybutylene, and those surfactants are also included.

A further preferable surfactant is a fluorine type surfactant containing a perfluoroalkyl group in a molecule. Examples of the fluorine type surfactant include anion type such as perfluoroalkylcarboxylic acid salt, perfluoroalkylsulfonic acid salt, and perfluoroalkylphosphoric acid ester, amphoteric types such as perfluoroalkylbetaine, cationic types such as perfluoroalkyltrimethylammonium salt, and nonionic types such as perfluoroalkylamine oxide, perfluoroalkylethylene oxide adduct, perfluoroalkyl group and hydrophilic group-containing oligomer, perfluoroalkyl group and oleophilic group-containing oligomer, perfluoroalkyl group, hydrophilic group and oleophilic group-containing oligomer, and perfluoroalkyl group and oleophilic group-containing urethane.

Surfactants may be used alone, or may be used in combination of two or more kinds, and can be added to a back coating layer (organic polymer layer) in an amount of preferably 0.001 to 10% by mass, more preferably 0.01 to 5% by mass.

Further, a dye for coloring, a silane coupling agent for improving adherability with an aluminum support, a diazo resin containing a diazonium salt, organic phosphonic acid, organic phosphoric acid and a cationic polymer, and further, a wax which is usually used as a sliding agent, higher fatty acid, higher fatty acid amide, a silicone compound consisting of dimethylsiloxane, modified dimethylsiloxane, and a polyethylene powder may be appropriately added to a back coating layer (organic polymer layer).

A thickness of an organic polymer layer in the second and third aspects of the invention may be such a thickness that a recording layer is hardly damaged without a interleaving sheet, and is usually preferably in a range of 0.05 to 50 μm, more preferably in a range of 0.5 to 25 μm, further preferably in a range of 1.0 to 20 μm. Within the above range, when planographic printing plate precursors are stacked and used, occurrence of rubbing abrasion of a recording layer can be effectively prevented.

(Formation of a Back Coating Layer (Organic Polymer Layer))

The back coating layer (organic polymer layer) in the invention can be formed by dissolving respective components constituting the back coating layer (organic polymer layer) in a solvent to prepare a coating solution, and coating this coating solution on a support at a side (a back surface of a support) opposite to a side at which a recording layer is to be formed, for example, on a support surface on which an anodic oxide film described later has been formed.

As a solvent used, organic solvents described in JP-A No. 62-251739 can be used alone, or in combination. Examples of the solvent are not limited to, but include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethyl sulfoxide, sulfolane, γ-butyrolactone, and toluene. These solvents are used alone, or in combination.

The planographic printing plate precursor of the first aspect of the invention can exert an excellent effect in that, even when the precursors are stacked without using interleaving sheets, at the time of manufacturing, plate-making, conveyance during packaging or transportation after shipping, rubbing abrasion and adhesion problems are not caused on a recording layer, because the precursors have a back coating layer provided on a back surface of a support together with the aforementioned recording layer. That is, for example, even when the planographic printing plate precursors are stacked, packaged and transported, rubbing abrasion on a recording layer, which is caused by rubbing between a surface at a recording layer side and a back surface (a surface having a back coating layer) due to vibration during transportation, is not caused. In addition, even when stacked printing plate precursors are stored for a long period of time under high humidity conditions, adhesion problems are not caused on a recording layer. Further, even in a case where a surface at a recording layer side and a back surface of a printing plate precursor are partially strongly pressed while the precursor is moved, as in the case where a light exposure apparatus equipped with an autoloader is used, rubbing abrasion is not caused on a recording layer.

(Properties of the Organic Polymer Layer in the Second Aspect of the Invention)

A dynamic friction coefficient of an organic polymer layer surface is preferably in a range of 0.38 to 0.70 from a viewpoint that the effect in the second aspect of the invention is sufficiently exerted. When forming the organic polymer layer, the kind and the addition amount of a long-chain alkyl group-containing polymer and an organic polymer may be determined in view of such a point.

The dynamic friction coefficient referred to herein refers to a value measured according to standard ASTM D1894 by arranging an organic polymer layer surface and a recording layer surface opposite to the organic polymer layer so as to be in contact with each other.

Fine projections present on an organic polymer layer surface in the second aspect of the invention can be easily confirmed by observing an organic polymer layer surface with a microscope.

An average particle diameter of fine particles which form fine projections (surface projections) is preferably 0.05 μm to 50 μm, more preferably 0.1 μm to 20 μm, further preferably 0.3 μm to 10 μm.

When the average particle diameter is below 0.05 μm, formation of irregularities on an organic polymer layer surface is insufficient, so that there is fear that abrasion resistance improving effect is not sufficiently obtained. In addition, when projections exceeding 50 μm are present, the projections are deformed during printing, a uniform printing pressure is not obtained, and reproducibility of dots of a printed matter becomes unstable in some cases.

Examples of a method of measuring an average particle diameter of fine particles which form fine projections generally include a method of measuring diameters of particles present on a surface by observation with an optical microscope or an electron microscope, and calculating its average. That is, an average particle diameter of fine particles referred to herein is obtained by measuring a plurality of particle diameters of fine particles made of a long-chain alkyl group-containing polymer which is projected on an organic polymer layer surface, and taking an average value thereof.

A height of a fine projection present on an organic polymer layer surface is preferably 0.05 μm to 20 μm, more preferably 0.1 μm to 10 μm, most preferably 0.3 μm to 7 μm.

Examples of a method of measuring a height of a fine projection include a method of measuring a height of a projection by observing a cross-section with an electron microscope, and a method of measurement using an atomic force microscope (AFM). In addition, it is preferable that a fine projection is softer as compared with a smooth part, and a hardness thereof can be measured using a hardness meter.

In the second aspect of the invention, examples of a factor for controlling a particle diameter and a height of a fine projection made of a long-chain alkyl group-containing polymer present on an organic polymer layer surface include polarity of a long-chain alkyl group-containing polymer, polarity of an organic polymer to be used in combination, an addition amount of each component, the kind of a coating solvent, other additives contained in an organic polymer layer, and drying condition (temperature, time, humidity, pressure etc.).

For example, as a difference in polarity between a long-chain alkyl group-containing polymer and an organic polymer having no compatibility to be used in combination grows greater, a particle diameter of a fine projection grows greater, and by elevating a drying temperature and shortening a time necessary for drying, a particle diameter of a fine projection becomes smaller.

The infrared-sensitive planographic printing plate precursor of the second aspect of the invention can exert an excellent effect in that rubbing abrasion and adhesion problems are not caused on a recording layer at the time of manufacturing, plate-making, conveyance during packaging or transportation after shipping, even when the precursors are stacked without using interleaving sheets, because the precursors have the above-explained organic polymer layer.

That is, for example, even when the planographic printing plate precursors are stacked, packaged and transported, rubbing abrasion on a recording layer, which is caused by rubbing between a surface at a recording layer side and a back surface (a surface having an organic polymer layer) due to vibration during transportation, is not caused. In addition, even when stacked printing plate precursors are stored for a long period of time under high humidity conditions, adhesion problems are not caused on a recording layer. Further, even in a case where a surface at a recording layer side and a back surface of a printing plate precursor are partially strongly pressed while the precursor is moved, as in the case where a light exposure apparatus equipped with an autoloader is used, rubbing abrasion is not caused on a recording layer.

(Properties of the Organic Polymer Layer in the Third Aspect of the Invention)

A dynamic friction coefficient of an organic polymer layer surface is preferably in a range of 0.38 to 0.70 from a viewpoint that the effect in the third aspect of the invention is sufficiently exerted.

The dynamic friction coefficient referred to herein refers to a value measured according to standard ASTM D1894 by arranging an organic polymer layer surface and a recording layer surface opposite to the organic polymer layer so as to be in contact with each other.

In the third aspect of the invention, when a matte surface is formed on an organic polymer layer surface using an aqueous solution or an aqueous dispersion of a resin, fine projections can be uniformly formed unlike the case where a matte surface is directly formed on a back surface of a support.

On the other hand, in an embodiment as described in the aforementioned JP-A No. 2003-63162 in which a matte surface is directly formed on a back surface (a surface opposite to a recording layer side) of a support, since a support surface is usually hydrophilization-treated, there is a problem that when an aqueous solution or an aqueous dispersion of a resin is applied, the applied resin liquid tends to be completely evenly spread on the support surface, so that it is difficult to form uniform fine projections (matte) as in the present invention.

The infrared-sensitive planographic printing plate precursor of the third aspect of the invention can exert an excellent effect in that, even when the precursors are stacked without using interleaving sheets, rubbing abrasion is not caused on a recording layer, at the time of manufacturing, plate-making, conveyance during packaging or transportation after shipping, because the precursors have the above-explained recording layer and/or organic polymer layer having a matte surface.

That is, for example, even when planographic printing plate precursors are stacked, packaged and transported, rubbing abrasion on a recording layer, which is caused by rubbing between a recording layer and an organic polymer layer due to vibration during transportation, is not caused. Further, even in a case where a recording layer and an organic polymer layer of a printing plate precursor are partially strongly pressed, as in the case where stacked infrared-sensitive planographic printing plate precursors of the third aspect of the invention are supplied to a light exposure apparatus equipped with an autoloader, rubbing abrasion is not caused on a recording layer.

[Support]

A support used in the planographic printing plate precursor of the invention is not particularly limited as far as it is a dimensionally stable plate having necessary strength and durability, and examples include a paper, a paper laminated with a plastic (e.g. polyethylene, polypropylene, polystyrene etc.), a metal plate (e.g. aluminum, zinc, copper etc.), a plastic film (e.g. cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, polyvinyl acetal etc.), and a paper or plastic film onto which the metal is laminated or deposited.

Inter alia, in the invention, a polyester film and an aluminum plate are preferable, and among them, an aluminum plate, which is dimensionally stable and is relatively inexpensive, is particularly preferable. A preferable aluminum plate is a pure aluminum plate and an alloy plate containing aluminum as a main component and containing a trace amount of different elements, and further, a plastic film onto which aluminum is laminated or deposited may be used. Examples of the different elements contained in an aluminum alloy include silicon, iron, manganese, copper, magnesium, chromium, zinc, bismuth, nickel and titanium. A content of the different elements in an alloy may be 10% by mass or smaller.

Aluminum which is particularly suitable in the invention is pure aluminum, but since completely pure aluminum is difficult to manufacture from a viewpoint of a refining technique, aluminum may contain a small amount of different elements.

An aluminum plate which is applied to the invention is not limited to an aluminum plate having a specified composition, but an aluminum plate of a material which has conventionally been known and used can be conveniently utilized. A thickness of an aluminum plate used in the invention is around 0.1 mm to 0.6 mm, preferably 0.15 mm to 0.4 mm, particularly preferably 0.2 mm to 0.3 mm.

Such an aluminum plate may be subjected to surface treatment such as surface roughening treatment and anode oxidation treatment, if necessary. Such surface treatment will be simply explained below.

Prior to surface-roughening of an aluminum plate, optionally, degreasing treatment with a surfactant, an organic solvent, an alkaline aqueous solution or the like for removing rolling oil on a surface is performed. Treatment of roughening a surface of an aluminum plate is performed by various methods, for example, a mechanical surface-roughening method, a method of electrochemically dissolving and roughening a surface or a method of chemically and selectively dissolving a surface. As the mechanical surface-roughening method, known methods such as a ball abrading method, a brush abrading method, a blast abrading method and a buff abrading method can be used. As the electrochemical surface-roughening method, there is a method which is performed by an alternating current or a direct current in a hydrochloric acid or nitric acid electrolytic solution. In addition, as disclosed in JP-A No. 54-63902, a method of a combination of both methods may be utilized.

The aluminum plate thus surface-roughened is subjected to alkali etching-treatment and neutralization-treatment if necessary, and thereafter, is subjected to anode oxidation treatment in order to enhance water retention and abrasion resistance of a surface as necessary. As an electrolyte used in anode oxidation treatment of an aluminum plate, various electrolytes which form a porous oxide film can be used, and generally, sulfuric acid, phosphoric acid, oxalic acid, chromic acid or a mixed acid thereof is used. A concentration of those electrolytes is appropriately determined depending on the kind of the electrolytes.

Since treating condition of anode oxidation is variously changed depending on an electrolyte used, it cannot be absolutely specified, but generally, a concentration of an electrolyte of 1 to 80% by mass, a solution temperature of 5 to 70° C., a current density of 5 to 60 A/dm², a voltage of 1 to 100 V, and an electrolysis time or 10 seconds to 5 minutes are suitable. When an amount of an anodic oxide film is less than 1.0 g/m², there is a tendency that printing durability is insufficient, abrasion is easily caused in a non-image area of a planographic printing plate, and so-called “abrasion pollution” that ink is adhered to an abrasion part when printing is easily generated.

After anode oxidation treatment, an aluminum surface is subjected to hydrophilization treatment, if necessary. As hydrophilization treatment used in the invention, there is an alkali metal silicate (e.g. sodium silicate aqueous solution) method disclosed in U.S. Pat. Nos. 2,714,066, 3,181,461, 3,280,734 and 3,902,734.

In this method, a support is subjected to immersion-treatment or electrolysis-treatment with a sodium silicate aqueous solution. Alternatively, a method of treatment with potassium fluoride zirconate disclosed in JP-B No. 36-22063 or a method of treatment with polyvinylphosphonic acid disclosed in U.S. Pat. Nos. 3,276,868, 4,153,461, and 4,689,272 is used.

(Organic Undercoating Layer)

In the planographic printing plate precursor of the invention, an organic undercoating layer may be provided between a support and a recording layer, if necessary.

As an organic undercoating layer component, various organic compounds are used and, for example, the component is selected from carboxymethylcellulose, dextrin, gum arabic, phosphonic acids having an amino group such as 2-aminoethylphosphonic acid, organic phosphonic acids such as phenylphosphonic acid, naphthylphosphonic acid, alkylphosphonic acid, glycerophosphonic acid, methylenediphosphonic acid and ethylenediphosphonic acid each optionally having a substituent, organic phosphoric acids such as phenylphosphoric acid, naphthylphosphoric acid, alkylphosphoric acid and glycerophosphoric acid each optionally having a substituent, organic phosphinic acids such as phenylphosphinic acid, naphthylphosphinic acid, alkylphosphinic acid and glycerophosphinic acid each optionally having a substituent, amino acids such as glycine and β-alanine, and hydrochloride of amine having a hydroxy group such as triethanolamine hydrochloride, and a mixture of two or more kinds thereof may be used.

It is also preferable that the organic undercoating layer contains a compound having an onium group. The compound having an onium group is described in detail in JP-A No. 2000-10292, JP-A No. 2000-108538, and JP-A No. 2000-241962.

Inter alia, preferable examples include at least one kind of compound selected from a group of polymer compounds having a representative structural unit such as poly(p-vinylbenzoic acid) in a molecule. Specific examples include a copolymer of p-vinylbenzoic acid and vinylbenzyltriethylammoium chloride, and a copolymer of p-vinylbenzoic acid and a vinylbenzyltrimethylammonium salt.

The organic undercoating layer can be provided by the following method. That is, there are a method of providing a layer by coating on an aluminum plate a solution in which the aforementioned organic compound is dissolved in water, or an organic solvent such as methanol, ethanol and methyl ethyl ketone or a mixed solvent thereof, followed by drying, and a method of providing an organic undercoating layer by immersing an aluminum plate in a solution in which the aforementioned organic compound is dissolved in water, or an organic solvent such as methanol, ethanol and methyl ethyl ketone or a mixed solvent thereof, to adsorb the compound thereon, thereafter, washing with water, followed by drying. By the former method, a solution having a concentration of the organic compound of 0.005 to 10% by mass can be coated by various methods. In the latter method, a concentration of a solution is 0.01 to 20% by mass, preferably 0.05 to 5% by mass, an immersion temperature is 20 to 90° C., preferably 25 to 50° C., and an immersion time is 0.1 second to 20 minutes, preferably 2 seconds to 1 minute. A solution used therefor may be adjusted to a range of a pH 1 to 12 by using a basic substance such as ammonia, triethylamine and potassium hydroxide, or an acidic substance such as hydrochloric acid and phosphoric acid. For improving reproducibility of a tone of a recording layer, a yellow dye may be added.

A coating amount of the organic undercoating layer is suitably 2 to 200 mg/m², preferably 5 to 100 mg/m². When the coating amount is in the above range, sufficient printing durability is obtained.

The infrared-sensitive planographic printing plate precursor thus manufactured is imagewise exposed to light, and thereafter, is subjected to developing treatment.

[Plate-Making]

An image is formed on the planographic printing plate precursor of the invention by heat. Specifically, direct image recording with a thermal recording head, scanning light exposure with an infrared laser, a high illuminance flash light exposure such as a xenon discharge lamp light exposure, and an infrared lamp light exposure are used, and light exposure with a semiconductor laser which emits infrared-ray at a wavelength of 700 to 1200 nm, or a solid high output infrared laser such as a YAG laser is suitable.

The exposed planographic printing plate precursor of the invention is subjected to developing treatment and post-treatment with a finisher or a protective gum to obtain a printing plate. For these treatments, treating apparatuses such as known automatic developing apparatuses can be used.

Treating agents to be used in developing treatment and post-treatment of the planographic printing plate precursor of the invention can be appropriately selected from known treating agents.

A preferable developer is a developer having a pH in a range of 9.0 to 14.0, preferably in a range of 12.0 to 13.5. As the developer, a conventionally known alkali aqueous solution can be used. Among the alkali aqueous solutions, examples of a particularly preferable developer include a conventionally well-known aqueous solution of a pH of 12 or higher called “silicate developer” containing an alkaline silicate as a base, or containing an alkaline silicate obtained by mixing a base with a silicon compound, and a so-called “non-silicate developer” not containing an alkaline silicate but containing a non-reducing sugar (an organic compound having buffering action) and a base described in JP-A No. 8-305039 and JP-A No. 11-109637.

It is preferable from a viewpoint of development acceleration and prevention of occurrence of dregs that the developer contains an anionic surfactant and/or an amphoteric surfactant.

When the planographic printing plate of the invention is subjected to burning treatment, it is preferable to perform the treatment using a burning affinitizing solution by a conventionally known method which is performed using a burning processor.

The planographic printing plate obtained by such treatment is subjected to an offset printing apparatus, and is used for printing multiple sheets.

The planographic printing plate precursor of the invention has the aforementioned construction, and therefore, since damage of a recording layer is effectively suppressed even when the precursors are stacked without interleaving sheets, handling property is excellent.

### EXAMPLES

The invention will be described in detail below by way of Examples, but the invention is not limited to them.

### Synthesis Example 1

### Synthesis of Long-Chain Alkyl Group-Containing Polymer A

A 1000 ml three-neck flask equipped with a condenser and a stirrer was charged with 59 g of 1-methoxy-2-propanol, and this was heated to 80° C. Under a nitrogen stream, a solution containing 42.0 g of stearyl n-methacrylate, 16.0 g of methacrylic acid, 0.714 g of a polymerization initiator V-601 (manufactured by Wako Pure Chemical Industries, Ltd.) and 59 g of 1-methoxy-2-propanol was added dropwise over two and a half hours. Further, the mixture was reacted at 80° C. for 2 hours. The reaction mixed solution was cooled to room temperature, and the reaction solution was poured into 1000 ml of water. After decantation, the reaction solution was washed with methanol, and the resulting liquid product was dried under reduced pressure to obtain 73.5 g of a long-chain alkyl group-containing polymer A shown below. A mass average molecular weight was measured by a gel permeation chromatography method (GPC) using polystyrene as a standard substance, and was found to be 66,000.

Long-chain alkyl group-containing polymer A 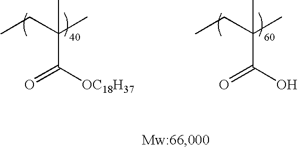
[Preparation of Support]
(Aluminum Plate)

Using an aluminum alloy containing Si: 0.06% by mass, Fe: 0.30% by mass, Cu: 0.026% by mass, Mn: 0.001% by mass, Mg: 0.001% by mass, Zn: 0.001% by mass and Ti: 0.02% by mass, in which the balance is Al and unavoidable impurities, a molten metal was prepared, molten metal treatment and filtration were performed, and an ingot having a thickness of 500 mm and a width of 1200 mm was prepared by a DC casting method. A surface was cut off at an average thickness of 10 mm with a plane cutting apparatus, the ingot was uniformly thermally retained at 550° C. for about 5 hours, and at the time when the temperature was lowered to 400° C., the ingot was converted into a rolled plate of a thickness of 2.7 mm using a hot rolling apparatus. Further, heat treatment was performed at 500° C. using a continuous annealing apparatus, and the plate was finished to a thickness of 0.24 mm by cold rolling to obtain an aluminum plate of JIS 1050 material. A short diameter of an average crystal particle diameter of the resulting aluminum was 50 μm, and a long diameter was 300 μm. This aluminum plate was converted into a width of 1030 mm, and was subjected to surface treatment.

In surface treatment, various treatments of the following (a) to (k) were continuously performed. After each treatment and washing with water, a liquid was removed with a nip roller.

(a) Mechanical Roughening Treatment

Using a suspension of a polishing agent (pumice) and water of a specific gravity of 1.12 as a polishing slurry liquid, mechanical roughening treatment was performed with rotating roller-type nylon brushes while the slurry liquid was supplied to the surface of the aluminum plate. The average particle diameter of the polishing agent was 30 μm, and the maximum particle diameter was 100 μm. The material of the nylon brushes was 6·10 nylon, the bristle length of the brushes was 45 mm, and the bristle diameter of the brushes was 0.3 mm. In the nylon brushes, bristles were filled densely in perforated stainless cylinders of φ300 mm. Three rotation brushes were used. The distance between two supporting rollers (φ200 mm) under each of the brushes was 300 mm. The brush rollers were pushed against the aluminum plate until the load of the driving motor rotating the brush became 7 kW larger than the load before the brush rollers were pressed against the aluminum plate. The rotating direction of the brush was the same as the direction of movement of the aluminum plate. The rotation number of the brush was 200 rpm.

(b) Alkali Etching Treatment

The above-obtained aluminum plate was subjected to etching treatment by spraying using an aqueous solution having a concentration of sodium hydroxide of 2.6% by mass and a concentration of aluminum ion of 6.5% by mass at a temperature of 70° C., to dissolve 10 g/m2 of the aluminum plate. Thereafter, the plate was washed with water by spraying.

(c) Desmut Treatment

Desmut treatment was performed by spraying with an aqueous solution having a nitric acid concentration of 1% by mass (containing 0.5% by mass of aluminum ion) at a temperature of 30° C. and, thereafter, the plate was washed with water by spraying. As a nitric acid aqueous solution used in desmut treatment, a waste solution in the step of performing electrochemical surface roughening treatment using alternating current in a nitric acid aqueous solution was used.

(d) Electrochemical Surface Roughening Treatment

Using 60 Hz alternating voltage, electrochemical surface roughening treatment was performed continuously. At that time, the electrolytic solution was a nitric acid 10.5 g/L aqueous solution (containing 5 g/L of aluminum ion and 0.007% by mass of ammonium ion), and the solution temperature was 50° C. At TP (a time from zero of a current value to a peak of a current value) of 0.8 msec and the duty ratio of 1:1 and using trapezoid wave alternating current, electrochemical surface roughening treatment was performed with a carbon electrode as a counter electrode. As an auxiliary anode, ferrite was used. As an electrolysis tank, a radial cell type was used.

The current density was 30 A/dm² when the current was at the peak, and the quantity of electricity was 220 C/dm² as expressed by a sum of a quantity of electricity when the aluminum plate was an anode. 5% of the current flown from an electric source was flown into the auxiliary anode. Thereafter, washing with water was performed by spraying.

(e) Alkali Etching Treatment

The aluminum plate was subjected to etching treatment by spraying at 32° C. using an aqueous solution having a concentration of sodium hydroxide of 26% by mass and a concentration of aluminum ion of 6.5% by mass, to dissolve 0.50 g/m² of the aluminum plate, a smut component mainly containing aluminum hydroxide generated at the previous electrochemical surface roughening treatment using alternating current was removed, and an edge part of a produced pit was dissolved to make the edge part smooth. Thereafter, washing with water was performed by spraying.

(f) Desmut Treatment

Desmut treatment was performed by spraying with an aqueous solution having a sulfuric acid concentration of 15% by mass (containing 4.5% by mass of aluminum ion) at a temperature of 30° C. and, thereafter, washing with water was performed by spraying. As a nitric acid aqueous solution used in the desmut treatment, a waste solution of a step of performing electrochemical surface roughening treatment using alternating current in a nitric acid aqueous solution was used.

(g) Electrochemical Surface Roughening Treatment

Using 60 Hz alternating voltage, electrochemical surface roughening treatment was performed continuously. At that time, the electrolytic solution was a hydrochloric acid 5.0 g/L aqueous solution (containing 5 g/L of aluminum ion), and the temperature was 35° C. At TP (a time from a zero of a current value to a peak of a current value) of 0.8 msec and a duty ratio of 1:1 and using trapezoid wave alternating current, electrochemical surface roughening treatment was performed using a carbon electrode as a counter electrode. As an auxiliary anode, ferrite was used. As an electrolysis tank, a radial cell type was used.

The current density was 25 A/dm² when the current was at the peak, and the quantity of electricity was 50 C/dm as expressed by a sum of a quantity of electricity when the aluminum plate was an anode. Thereafter, washing with water was performed by spraying.

(h) Alkali Etching Treatment

The aluminum plate was subjected to etching treatment by spraying at 32° C. using an aqueous solution having a concentration of sodium hydroxide of 26% by mass and a concentration of aluminum ion of 6.5% by mass, to dissolve 0.10 g/m² of the aluminum plate, a smut component mainly containing aluminum hydroxide generated at the previous electrochemical surface roughening treatment using alternating current was removed, and an edge part of a produced pit was dissolved to make the edge part smooth. Thereafter, washing with water was performed by spraying.

(i) Desmut Treatment

Desmut treatment was performed by spraying with an aqueous solution having a sulfuric acid concentration of 25% by mass (containing 0.5% by mass of aluminum ion) at a temperature of 60° C. and, thereafter, washing with water was performed by spraying.

(j) Anode Oxidation Treatment

Using an anode oxidation device (first and second electrolysis part length each 6 m, first and second electricity supplying part length each 3 m, first and second electricity supplying electrode part length each 2.4 m) of a two-step electricity supplying electrolysis treating method, anode oxidation treatment was performed. As an electrolytic solution to be supplied to first and second electrolysis parts, sulfuric acid was used. All electrolytic solutions had a sulfuric acid concentration of 50 g/L (containing 0.5% by mass of aluminum ion), and the temperature was 20° C. Thereafter, washing with water was performed by spraying. A final oxide film amount was 2.7 g/m².

(k) Alkali Metal Silicate Salt Treatment

Alkali metal silicate salt treatment (silicate treatment) was performed by immersing the aluminum support obtained by the anode oxidation treatment in a treating tank containing a No. 3 sodium silicate 1 mass % aqueous solution at a temperature of 30° C. for 10 seconds. Thereafter, washing with water was performed by spraying using well water, to obtain an aluminum support having a silicate hydrophilization-treated surface.

### Example 1

(Formation of a Back Coating Layer)

The following <back coating layer A> was provided on a back surface of the above-obtained support which had been surface-treated.

<Back Coating Layer A>

A back coating solution A having the following composition was coated while adjusting the Wet amount with a bar coater so as to obtain a thickness after drying of 10 μm, and this was dried at 100° C. for 60 seconds.

—Back Coating Solution A—

m-cresol/p-cresol novolak resin (m/p=6/4): 12 g
Surfactant (fluorine type surfactant B, following structure): 0.05 g
Solvent: methyl ethyl ketone/1-methoxy-2-propanol=5/5: 100 g 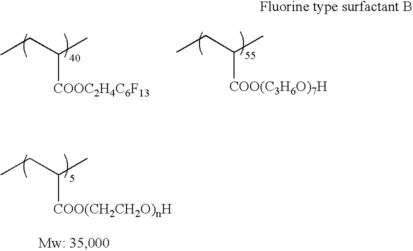
   <Formation of an Organic Undercoating Layer>

The following organic undercoating liquid was coated on the support at the surface-treated side opposite to the side at which the back coating layer was formed with a bar coater, and dried at 80° C. for 15 seconds to provide an organic undercoating layer so that the coating amount after drying became 17 mg/m².

—Organic Undercoating Liquid—

Following polymer compound Z 0.3 g
Methanol 100.0 g
Water 1.0 g 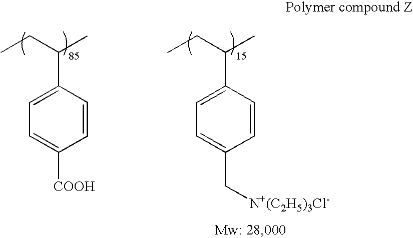
   [Formation of a Recording Layer]

The following recording layer coating liquid 1 was coated on the aluminum support on which the organic undercoating layer had been formed, with a bar coater so that the coating amount after drying became 0.85 g/m², this was dried at 160° C. for 44 seconds, and immediately cooled with cold wind at 17 to 20° C. so that the temperature of the support became 35° C., to form a recording layer 1 (lower layer). Thereafter, the following recording layer coating liquid 2 was coated with a bar coater so that the coating amount after drying became 0.22 g/m², and this was dried at 148° C. for 25 seconds, and gradually cooled with wind at 20 to 26° C. to form a recording layer 2 (upper layer).

By the above procedure, the infrared-sensitive planographic printing plate precursor of Example 1 was obtained.

(Recording Layer Forming Coating Liquid 1)

N-(4-aminosulfonylphenyl)methacrylamide/acrylonitrile/methyl methacrylate (36/34/30 wt %: weight average molecular weight 50000, acid value 2.65) 2.1 g
Cyanine dye A (following structure): 0.13 g
4,4′-bishydroxyphenylsulfone: 0.13 g
Cis-Δ⁴-tetrahydrophthalic anhydride: 0.19 g
p-toluenesulfonic acid: 0.008 g
3-Methoxy-4-diazodiphenylamine hexafluorophosphate: 0.032 g
Ethyl violet in which the counterion had been changed to
6-hydroxy-2-naphthalenesulfonic acid: 0.078 g
Fluorine type surfactant B (aforementioned structure): 0.007 g
Methyl ethyl ketone: 25.0 g
1-Methoxy-2-propanol: 13.0 g
γ-Butyrolatone: 13.0 g 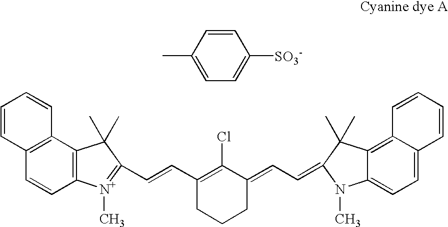
   (Recording Layer Forming Coating Liquid 2)

m,p-cresol novolak (m/p ratio=6/4, weight average molecular weight 4500, containing 0.8 mass % of unreacted cresol, Tg 75° C.): 0.35 g
Acryl resin C (following structure): 0.042 g
Long-chain alkyl group-containing polymer A: 0.022 g
Cyanine dye A (aforementioned structure): 0.019 g
Ammonium compound D (following structure): 0.004 g
Fluorine type surfactant B (aforementioned structure): 0.0045 g
Fluorine type surfactant E (following structure): 0.0033 g
Methyl ethyl ketone: 10.0 g
1-Methoxy-2-propanol: 20.0 g

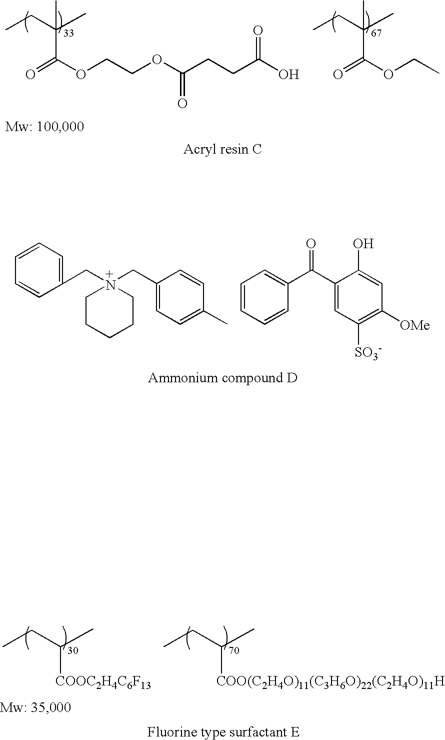

### Example 2

According to the same manner as that of Example 1 except that the <back coating layer A> formed in Example 1 was changed to the following <back coating layer B>, the infrared-sensitive planographic printing plate precursor of Example 2 was obtained.

<Back Coating Layer B>

A back coating liquid B having the following composition was coated while adjusting the Wet amount with a bar coater so that the thickness after drying became 10 μm, and this was dried at 100° C. for 60 seconds.

—Back Coating Liquid B—

Polystyrene: 12 g
Surfactant (fluorine type surfactant B, aforementioned structure) 0.05 g
Solvent: methyl ethyl ketone/1-methoxy-2-propanol=5/5: 100 g

### Example 3

According to the same manner as that of Example 1 except that the <back coating layer A> formed in Example 1 was changed to the following <back coating layer C>, the infrared-sensitive planographic printing plate precursor of Example 3 was obtained.

<Back Coating Layer C>

A back coating liquid C having the following composition was coated while adjusting the Wet amount with a bar coater so that the thickness after drying became 10 μm, and this was dried at 100° C. for 60 seconds.

—Back Coating Liquid C—

Saturated polymerized polyester resin (Kemit K-588, manufactured by Toray Industries, Inc.): 12 g
Surfactant (fluorine type surfactant B, aforementioned structure) 0.05 g
Solvent: methyl ethyl ketone/1-methoxy-2-propanol=7/3: 100 g

### Example 4

According to the same manner as that of Example 1 except that the <back coating layer A> formed in Example 1 was changed to the following <back coating layer D>, the infrared-sensitive planographic printing plate precursor of Example 4 was obtained.

<Back Coating Layer D>

A back coating liquid D having the following composition was coated while adjusting the Wet amount with a bar coater so that the thickness after drying became 10 μm, and this was dried at 100° C. for 60 seconds.

—Back Coating Liquid D—

Phenoxy resin (Phenote YP-50, manufactured by Tokyo Kasei Kogyo Co., Ltd.): 12 g
Surfactant (fluorine type surfactant B, aforementioned structure) 0.05 g
Solvent: Methyl ethyl ketone/1-methoxy-2-propanol=7/3: 100 g

### Example 5

According to the same manner as that of Example 1 except that the <back coating layer A> formed in Example 1 was changed to the following <back coating layer E>, the infrared-sensitive planographic printing plate precursor of Example 5 was obtained.

<Back Coating Layer E>

A back coating liquid E having the following composition was coated while adjusting the Wet amount with a bar coater so that the thickness after drying became 10 μm, and this was dried at 100° C. for 60 seconds.

—Back Coating Liquid E—

Polyvinyl butyral resin
(Denka Butyral 3000-K, manufactured by Denki Kagaku Kogyo Kabushiki Kaisha): 12 g
Surfactant (fluorine type surfactant B, aforementioned structure) 0.05 g
Solvent: Methyl ethyl ketone/1-methoxy-2-propanol=7/3: 100 g

### Example 6

According to the same manner as that of Example 1 except that the <back coating layer A> formed in Example 1 was changed to the following <back coating layer F>, the infrared-sensitive planographic printing plate precursor of Example 6 was obtained.

<Back Coating Layer F>

A back coating liquid F having the following composition was coated while adjusting the Wet amount with a bar coater so that the thickness after drying became 10 μm, and this was dried at 100° C. for 60 seconds.

—Back Coating Liquid F—

Vinylidene chloride-acrylonitrile copolymer resin
(Saran F-310, manufactured by Asahi-Dow Ltd.): 12 g
Surfactant (fluorine type surfactant B, aforementioned structure) 0.05 g
Solvent (methyl ethyl ketone/1-methoxy-2-propanol=7/3): 100 g

### Example 7

According to the same manner as that of Example 3 except that the thickness of the <back coating layer C> formed in Example 3 was changed from 10 μm to 1 μm, the infrared-sensitive planographic printing plate precursor of Example 7 was obtained.

### Example 8

According to the same manner as that of Example 3 except that the thickness of the <back coating layer C> formed in Example 3 was changed from 10 μm to 20 μm, the infrared-sensitive planographic printing plate precursor of Example 8 was obtained.

### Comparative Example 1

According to the same manner as that of Example 1 except that the recording layer forming coating liquid 2 used for forming a recording layer 2 (upper layer) did not contain a long-chain alkyl group-containing polymer A, and formation of the <back coating layer A> was not performed in Example 1, the infrared-sensitive planographic printing plate precursor of Comparative Example 1 was obtained.

### Comparative Example 2

According to the same manner as that of Example 3 except that the recording layer forming coating liquid 2 used for forming a recording layer 2 (upper layer) did not contain a long-chain alkyl group-containing polymer A, and the thickness of the <back coating layer C> was changed from 10 μm to 0.2 μm in Example 3, the infrared-sensitive planographic printing plate precursor of Comparative Example 2 was obtained.

### Comparative Example 3

According to the same manner as that of Example 3 except that the thickness of the <back coating layer C> was changed from 10 μm to 0.2 μm in Example 3, the infrared-sensitive planographic printing plate precursor of Comparative Example 3 was obtained.

### Comparative Example 4

According to the same manner as that of Example 1 except that the recording layer forming coating liquid 2 used for forming a recording layer 2 (upper layer) did not contain a long-chain alkyl group-containing polymer A, formation of the <back coating layer A> was not performed, a copolymerized polymer aqueous solution having the following composition was adjusted to a solid matter concentration of 20%, and this was coated with an electrostatic air type sprayer, and dried at 60° C. for 5 seconds in Example 1, the infrared-sensitive planographic printing plate precursor of Comparative Example 4 was obtained.

-Composition of Copolymerized Polymer of Comparative Example 4—

Methyl methacrylate: 68% by mass
Ethyl acrylate: 20% by mass
Sodium acrylate: 12% by mass

### Comparative Example 5

According to the same manner as that of Example 1 except that the recording layer forming coating liquid 2 used for forming a recording layer 2 (upper layer) did not contain a long-chain alkyl group-containing polymer A, and the following back coating liquid G was used in place of the back coating liquid A used for forming the <back coating layer A> to form <back coating layer G> in Example 1, the infrared-sensitive planographic printing plate precursor of Comparative Example 5 was obtained.

—Back Coating Liquid G—

Styrene/methyl methacrylate copolymer: 10 g
Silica gel (particle diameter 4 μm): 4 g
Solvent: methyl ethyl ketone: 100 g

The following Table 1 summarizes the kind of an organic polymer and the like contained in the back coating layer, the thickness of the back coating layer (μm), and the presence or the absence of a long-chain alkyl group-containing polymer in the recording layer in Examples and Comparative Examples.

TABLE 1

| | | | Presence or |
|---|---|---|---|
| | | | absence of a |
| | | | long-chain |
| | | | alkyl group- |
| | | | containing |
| | Back coating layer | | polymer in |
| | | Thickness | the recording |
| | Organic polymer | (μm) | layer |
| Example 1 | m-cresol/p-cresol | 10 | Present |
| | novolak resin | | |
| | m/p = 6/4 | | |
| Example 2 | Polystyrene | 10 | Present |
| Example 3 | Saturated polymerized | 10 | Present |
| | polyester resin | | |
| | (Kamit K-588, | | |
| | manufactured by | | |
| | Toray Industries, Inc.) | | |
| Example 4 | Phenoxy resin | 10 | Present |
| | (Phenote YP-50, | | |
| | manufactured by | | |
| | Tokyo Kasei Kogyo | | |
| | Co., Ltd.) | | |
| Example 5 | Polyvinyl butyral resin | 10 | Present |
| | (Denka Butyral 3000-K, | | |
| | manufactured by | | |
| | Denki Kagaku Kogyo | | |
| | Kabushiki Kaisha) | | |
| Example 6 | Vinylidene chloride- | 10 | Present |
| | acrylonitrile copolymer | | |
| | resin (Saran F-310, | | |
| | manufactured by | | |
| | Asahi-Dow Ltd.) | | |
| Example 7 | Saturated polymerized | 1 | Present |
| | polyester resin | | |
| | (Kemit K-588, | | |
| | manufactured by | | |
| | Toray Industries, Inc.) | | |
| Example 8 | Saturated polymerized | 20 | Present |
| | polyester resin | | |
| | (Kemit K-588, | | |
| | manufactured by | | |
| | Toray Industries, Inc.) | | |
| Comparative | — | — | Absent |
| Example 1 | | | |
| Comparative | Saturated polymerized | 0.2 | Absent |
| Example 2 | polyester resin | | |
| | (Kemit K-588, | | |
| | manufactured by | | |
| | Toray Industries, Inc.) | | |
| Comparative | Saturated polymerized | 0.2 | Present |
| Example 3 | polyester resin | | |
| | (Kemit K-588, | | |
| | manufactured by | | |
| | Toray Industries, Inc.) | | |
| Comparative | — | 0.3 | Absent |
| Example 4 | | (Matte | |
| | | height) | |
| Comparative | Styrene/methyl | 10 | Absent |
| Example 5 | methacrylate copolymer | | |
| | Silica gel (particle | | |
| | diameter 4 μm) | | |

### Examples 11 to 16, Comparative Examples 11 to 14

[Formation of a Back Coating Layer (Organic Polymer Layer)]

Regarding Examples 11 to 16, a back coating liquid containing an organic polymer, an organic matte surface-forming agent (long-chain alkyl group-containing polymer A), a surfactant (fluorine type surfactant B) and a solvent was prepared, and the liquid was coated on the above obtained support at a side (back surface side) opposite to a side at which a recording layer was coated, while adjusting the Wet amount with a bar coater so that the thickness after drying became 1 μm, 10 μm, or 20 μm, respectively, and this was dried at 100° C. for 60 seconds.

—Back Coating Liquid—

Organic polymer (kind described in Table 2): Amount described in Table 2
Organic matte surface-forming agent (kind described in Table 2): 1 g
Surfactant (fluorine type surfactant B, aforementioned structure) 0.05 g
Solvent (kind described in Table 2): 100 g

Regarding Comparative Example 11, formation of a back coating layer was not performed.

Regarding Comparative Examples 12 and 13, using a back coating liquid having a composition described in Table 2, formation of a back coating layer was performed.

Regarding Comparative Example 14, in place of coating of a back coating liquid, a copolymerized polymer aqueous solution having the following composition was adjusted to a solid matter concentration of 20%, and this was coated by an electrostatic air type sprayer, and dried at 60° C. for 5 seconds.

—Composition of Copolymerized Polymer of Comparative Example 14—

Methyl methacrylate: 68% by mass
Ethyl acrylate: 20% by mass

Sodium acrylate: 12% by mass

TABLE 2

| | | Organic matte | | |
|---|---|---|---|---|
| | Organic polymer for a back | surface-forming | | |
| | coating layer | agent | Surfactant | Solvent |
| Example 11 | m-cresol/p-cresol novolak resin | Long-chain alkyl | Fluorine type | Methyl ethyl |
| | m/p = 6/4 | group-containing | surfactant B | ketone/1-methoxy-2-propanol = 5/5 |
| | 12 g | polymer A | 0.05 g | 100 g |
| | | 1 g | | |
| Example 12 | Polystyrene | Long-chain alkyl | Fluorine type | Methyl ethyl |
| | 12 g | group-containing | surfactant B | ketone/1-methoxy-2-propanol = 9/1 |
| | | polymer A | 0.05 g | 100 g |
| | | 1 g | | |
| Example 13 | Saturated polymerized polyester | Long-chain alkyl | Fluorine type | Methyl ethyl |
| | resin | group-containing | surfactant B | ketone/1-methoxy-2-propanol = 7/3 |
| | (Kemit K-588, manufactured | polymer A | 0.05 g | 100 g |
| | by Toray Industries, Inc.) | 1 g | | |
| | 12 g | | | |
| Example 14 | Phenoxy resin | Long-chain alkyl | Fluorine type | Methyl ethyl |
| | (Phenote YP-50, manufactured | group-containing | surfactant B | ketone/1-methoxy-2-propanol = 7/3 |
| | by Tokyo Kasei Kogyo Co., Ltd.) | polymer A | 0.05 g | 100 g |
| | 12 g | 1 g | | |
| Example 15 | Polyvinyl butyral resin | Long-chain alkyl | Fluorine type | Methyl ethyl |
| | (Denka Butyral 3000-K, | group-containing | surfactant B | ketone/1-methoxy-2-propanol = 7/3 |
| | manufactured by Denki Kagaku | polymer A | 0.05 g | 100 g |
| | Kogyo Kabushiki Kaisha) | 1 g | | |
| | 12 g | | | |
| Example 16 | Vinylidene | Long-chain alkyl | Fluorine type | Methyl ethyl |
| | chloride-acrylonitrile-copolymer | group-containing | surfactant B | ketone/1-methoxy-2-propanol = 7/3 |
| | resin | polymer A | 0.05 g | 100 g |
| | (Saran F-310, manufactured | 1 g | | |
| | by Asahi-Dow, Ltd.) | | | |
| | 12 g | | | |
| Comparative | None | None | None | None |
| Example 11 | | | | |
| Comparative | Saturated polymerized polyester | None | Fluorine type | Methyl ethyl |
| Example 12 | resin | | surfactant B | ketone/1-methoxy-2-propanol = 7/3 |
| | (Kemit K-588, manufactured | | 0.05 g | 100 g |
| | by Toray Industries, Inc.) | | | |
| | 12 g | | | |
| Comparative | Styrene/methyl methacrylate | None | None | Methyl ethyl ketone |
| Example 13 | copolymer | | | 100 g |
| | 10 g | | | |
| | Silica gel (particle diameter 4 μm) | | | |
| | 4 g | | | |
| Comparative | None | Electrostatically | — | — |
| Example 14 | | coated polymer | | |

<Formation of an Organic Undercoating Layer>

The following organic undercoating liquid was coated on the support at the surface-treated side opposite to the side at which the organic polymer layer had been formed, with a bar coater, and dried at 80° C. for 15 seconds, to provide an organic undercoating layer so that the coating amount after drying became 18 mg/m².

—Organic Undercoating Liquid—

Aforementioned polymer compound Z: 0.3 g
Methanol: 100 g
   [Formation of a Recording Layer]

The following lower layer coating liquid was coated on the aluminum support on which the organic undercoating layer had been formed with a bar coater so that the coating amount after drying became 0.85 g/m², and this was dried at 160° C. for 44 seconds, and immediately cooled with cold wind at 17 to 20° C. so that the temperature of the support became 35° C., to form a lower layer. Thereafter, the following upper layer coating liquid was coated with a bar coater so that the coating amount after drying became 0.22 g/m², and this was dried at 148° C. for 25 seconds, and gradually cooled with wind at 20 to 26° C. to form an upper layer.

<Lower Layer Coating Liquid Composition>

N-(4-aminosulfonylphenyl)methacrylamide/acrylonitrile/methyl methacrylate (36/34/30 wt %: weight average molecular weight 50000, acid value 2.65) 2.1 g
Cyanine dye A (aforementioned structure): 0.13 g
4,4′-Bishydroxyphenylsulfone: 0.13 g
Tetrahydrophthalic anhydride: 0.19 g
p-toluene sulfonic acid: 0.008 g
3-Methoxy-4-diazodiphenylamine hexafluorophosphate: 0.032 g
Ethyl violet in which the counterion was changed to 6-hydroxy-2-naphthalenesulfonic acid: 0.078 g
Fluorine type surfactant B (aforementioned structure): 0.007 g
Methyl ethyl ketone: 25.0 g
1-Methoxy-2-propanol: 13.0 g
γ-butyrolactone: 13.0 g
   <Upper Layer Coating Liquid Composition>
m,p-cresol novolak (m/p ratio=6/4, weight average molecular weight 4500, containing 0.8 mass % unreacted cresol, Tg75° C.): 0.35 g
Acryl resin C (aforementioned structure): 0.042 g
Cyanine dye A (aforementioned structure): 0.019 g
Ammonium compound D (aforementioned structure): 0.004 g
Fluorine type surfactant B (aforementioned structure): 0.0045 g
Fluorine type surfactant E (aforementioned structure): 0.0033 g
Methyl ethyl ketone: 10.0 g
1-Methoxy-2-propanol: 20.0 g

### Examples 21 to 34, Comparative Examples 21 to 25

[Formation of a Back Coating Layer (Organic Polymer Layer)]

Regarding Examples 21 to 34 and Comparative Example 22, a back coating liquid having the following composition was prepared, and the liquid was coated on the above obtained support at a side (back surface side) opposite to a side at which a recording layer was coated, with a bar coater so that the thickness after drying became 0.2 μm and, thereafter, this was dried at 100° C. for 60 seconds.

—Back Coating Liquid—

Organic polymer (compound described in Table 3): 10 g
Surfactant (fluorine type surfactant B, aforementioned structure) 0.05 g
Solvent (compound described later): 100 g

In the back coating liquid, in Example 21, Examples 23 to 27, Examples 29 to 33 and Comparative Example 22, as a solvent, a mixed solution of methyl ethyl ketone/1-methoxy-2-propanol=7/3 (mass ratio) was used.

In addition, in the back coating liquid, in Example 22, Example 28 and Example 34, as a solvent, hexafluoroisopropanol was used.

Further, in the back coating liquid, in Comparative Example 25, as a solvent, methyl ethyl ketone was used.

In Comparative Examples 21, 23 and 24, formation of a back coating layer was not performed.

Regarding Comparative Example 25, according to the same manner as that of Example 21 except that the composition of the back coating liquid was changed to a composition in which an organic polymer described in Table 3 was used, and 0.5 g of silica gel (particle diameter 4 μm) was added, a back coating layer was formed.

<Formation of an Organic Undercoating Layer>

The following organic undercoating liquid was coated on the support at the surface-treated side opposite to the side at which the organic polymer layer had been formed, with a bar coater, and this was dried at 80° C. for 15 seconds to provide an organic undercoating layer so that the coating amount after drying became 18 mg/m².

—Organic Undercoating Liquid—

Aforementioned polymer compound Z: 0.3 g
Methanol: 100 g
   [Formation of a Recording Layer]

The following lower layer coating liquid was coated on the aluminum support on which the organic undercoating layer had been formed, with a bar coater so that the coating amount after drying became 0.85 g/m², and this was dried at 160° C. for 44 seconds, and immediately cooled with cold wind at 17 to 20° C. so that the temperature of the support became 35° C., to form a lower layer. Thereafter, the following upper layer coating liquid was coated with a bar coater so that the coating amount after drying became 0.22 g/m², and this was dried at 148° C. for 25 seconds, and gradually cooled with wind at 20 to 26° C. to form an upper (most) layer.

<Lower Layer Coating Liquid Composition>

N-(4-aminosulfonylphenyl)methacrylamide/acrylonitrile/methyl methacrylate: 2.1 g (36/34/30 wt %: weight average molecular weight 50000, acid value 2.65)
Cyanine dye A (aforementioned structure): 0.13 g
4,4′-Bishydroxyphenylsulfone: 0.13 g
Tetrahydrophthalic anhydride: 0.19 g
p-toluenesulfonic acid: 0.008 g
3-Methoxy-4-diazobiphenylamine hexafluorophosphate: 0.032 g
Ethyl violet in which the counterion was changed to 6-hydroxy-2-naphthalene sulfonic acid: 0.078 g
Fluorine type surfactant B (aforementioned structure): 0.007 g
Methyl ethyl ketone: 25.0 g
1-Methoxy-2-propanol: 13.0 g
γ-Butyrolactone: 13.0 g
   <Upper Layer Coating Liquid Composition>
m,p-cresol novolak: 0.35 g
(m/p ratio=6/4, weight average molecular weight 4500, containing 0.8 mass % unreacted cresol, Tg 75° C.)
Acryl resin C (aforementioned structure): 0.042 g
Cyanine dye A (aforementioned structure): 0.019 g
Ammonium compound D (aforementioned structure): 0.004 g
Fluorine type surfactant B (aforementioned structure): 0.0045 g
Fluorine type surfactant E (aforementioned structure): 0.0033 g
Methyl ethyl ketone: 10.0 g
1-Methoxy-2-propanol: 20.0 g
   [Formation of a Matte Surface on an Organic Polymer Layer Surface]

A resin-containing aqueous solution of the following composition having a solid matter concentration of 20% by mass was applied onto the organic polymer layer surface of Examples 21 to 26 and Examples 33 and 34, and directly onto the support of Comparative Example 24 at a side (back surface side) opposite to the side at which a recording layer had been coated, whereby a matte surface was formed according to the following method.

That is, the resin solution was coated using a rotation atomization electrostatic coating apparatus at a atomization head rotation number of 15,000 rpm, a resin-containing aqueous solution supplying amount of 65 ml/min, a voltage applied to the atomization head of −75 kv, a surrounding temperature of 25° C., and a relative humidity of 50%. 1.5 seconds after the coating, steam was blown to the coated surface to swell the coated surface, and three seconds after that, a warm air at a temperature of 60° C. and a humidity of 10% was blown thereto for 5 seconds for drying.

The coating amount of this matte surface was 130 mg/m².

—Resin-Containing Aqueous Solution—

Methyl methacrylate: 68% by mass
Ethyl acrylate: 20% by mass
Sodium acrylate: 12% by mass
   [Formation of a Matte Surface on a Recording Layer Surface]

Subsequently, using the same resin-containing aqueous solution and the same method as those used for the above described formation of a matte surface on the organic polymer layer surface, a matte surface was formed on a recording layer surface of Examples 27 to 34, and Comparative Example 23.

<Measurement of Matte Surface (Fine Projections Formed of Matte Surface-Forming Material)>

Regarding the resulting respective infrared-sensitive planographic printing plate precursors of Examples and Comparative Examples, fine projections formed on a recording layer surface and/or an organic polymer layer surface was measured. Measurement results are also described in Table 3. Using an electron microscope or a metal microscope for measurement, a diameter and a density (number per 1 mm²) of a fine projection were obtained by observation from a front (inclination angle 0°) at a magnification of 50 to 300, and a fine projection height was obtained by observation from a side (inclination angle 80 to 90°).

TABLE 3

| | Fine projections on a recording | | | Fine projections on organic polymer | |
|---|---|---|---|---|---|
| | layer surface | | | layer surface | |
| | Presence | Diameter (μm), | | Presence | Diameter (μm), |
| | or | density (number/mm²), | Polymer contained in an organic | or | density (number/mm²), |
| | absence | height (μm) | polymer layer | absence | height (μm) |
| Example 21 | Absent | — | m-cresol/p-cresol novolak resin | Present | 10-50, 10-50, 4-6 |
| | | | (m/p = 6/4) | | |
| Example 22 | Absent | — | Polystyrene | Present | 10-50, 10-50, 4-6 |
| Example 23 | Absent | — | Saturated polymerized polyester | Present | 10-50, 10-50, 4-6 |
| | | | resin (Kemit K-588, manufactured | | |
| | | | by Toray Industries, Inc.) | | |
| Example 24 | Absent | — | Phenoxy resin | Present | 10-50, 10-50, 4-6 |
| | | | (Phenote YP-50, manufactured by | | |
| | | | Tokyo Kasei Kogyo Co., Ltd.) | | |
| Example 25 | Absent | — | Polyvinyl butyral resin | Present | 10-50, 10-50, 4-6 |
| | | | (Denka Butyral 3000-K, | | |
| | | | manufactured by Denki Kagaku | | |
| | | | Kogyo Kabushiki Kaisha) | | |
| Example 26 | Absent | — | Vinylidene chloride-acrylonitrile | Present | 10-50, 10-50, 4-6 |
| | | | copolymer resin (Saran F-310, | | |
| | | | manufactured by Asahi-Dow, Ltd.) | | |
| Example 27 | Present | 10-50, 10-50, 4-6 | m-cresol/p-cresol novolak resin | Absent | — |
| | | | (m/p = 6/4) | | |
| Example 28 | Present | 10-50, 10-50, 4-6 | Polystyrene | Absent | — |
| Example 29 | Present | 10-50, 10-50, 4-6 | Saturated polymerized polyester | Absent | — |
| | | | resin (Kemit K-588, manufactured | | |
| | | | by Toray Industries, Inc.) | | |
| Example 30 | Present | 10-50, 10-50, 4-6 | Phenoxy resin | Absent | — |
| | | | (Phenote YP-50, manufactured by | | |
| | | | Tokyo Kasei Kogyo Co., Ltd.) | | |
| Example 31 | Present | 10-50, 10-50, 4-6 | Polyvinyl butyral resin | Absent | — |
| | | | (Denka Butyral 3000-K, | | |
| | | | manufactured by Denki Kagaku | | |
| | | | Kogyo Kabushiki Kaisha) | | |
| Example 32 | Present | 10-50, 10-50, 4-6 | Vinylidene chloride-acrylonitrile | Absent | — |
| | | | copolymer resin | | |
| | | | (Saran F-310, manufactured by | | |
| | | | Asahi-Dow, Ltd.) | | |
| Example 33 | Present | 10-50, 10-50, 4-6 | m-cresol/p-cresol novolak resin | Present | 10-50, 10-50, 4-6 |
| | | | (m/p = 6/4) | | |
| Example 34 | Present | 10-50, 10-50, 4-6 | Polystyrene | Present | 10-50, 10-50, 4-6 |
| Comparative | Absent | — | — | Absent | — |
| Example 21 | | | | | |
| Comparative | Absent | — | Saturated copolymerized polyester | Absent | — |
| Example 22 | | | resin (Kemit K-588, manufactured | | |
| | | | by Toray Industries, Inc.) | | |
| Comparative | Present | 10-50, 10-50, 4-6 | — | Absent | — |
| Example 23 | | | | | |
| Comparative | Absent | — | — | Present | 20-200, 10-50, 0.5-2 |
| Example 24 | | | | | |
| Comparative | Absent | — | Styrene/methyl methacrylate | Absent | — |
| Example 25 | | | copolymer + silica gel | | |
| | | | (particle diameter 4 μm) | | |

<Evaluation>

Regarding the resulting respective infrared-sensitive planographic printing plate precursors of Examples 1 to 8 and 11 to 16, and Comparative Examples 1 to 5 and 11 to 14, respective items of “1. occurrence of rubbing abrasion due to transportation”, “2. adhesiveness under high humidity condition” and “3. occurrence of rubbing abrasion with autoloader” were evaluated. Regarding the resulting respective infrared-sensitive planographic printing plate precursors of Examples 21 to 34 and Comparative Examples 21 to 25, respective items of “1. occurrence of rubbing abrasion due to transportation” and “3. occurrence of rubbing abrasion with autoloader” were evaluated.

1. Evaluation of Occurrence of Rubbing Abrasion Due to Transportation

Each of the resulting infrared-sensitive planographic printing plate precursors was cut into a 1030 mm×800 mm size, 30 sheets of which were stacked without interleaving sheets. Cardboard having a thickness of 0.5 mm was placed on each of the top and bottom of the stack, and then each of the four corners of the stack was fixed with tape. After that, the stack was wrapped with aluminum craft paper, enclosed in a cardboard casing, and taped to obtain an interleaving sheet-less packaging form. This was placed on a palette, transported 2000 km by a truck, and opened. After being opened, the infrared-sensitive plangraphic printing plate precursor was development-treated at a development temperature of 32° C. for a development time of 12 seconds in a developer DT-2 manufactured by Fuji Photo Film Co., Ltd. diluted at 1:8 using an automatic developing apparatus LP-940HII manufactured by Fuji Photo Film Co., Ltd. At that time, the electric conductivity of the developer was 43 mS/cm. The presence or the absence of missing portions in an image area of the developed planographic printing plate resulting from abrasion of a recording layer generated during transportation was visually observed for evaluation.

Absence of missing portions in an image area is designated by “A”, and presence of missing portions in an image area is designated by “B”. Results are shown in Table 4.

2. Evaluation of Adhesiveness Under High Humidity Conditions

1500 sheets of the planographic printing plate precursors having the same size as that described above were stacked without interleaving sheets. An iron plate was placed on each of the top and bottom of the stack. The stack was then fixed with bolts, and allowed to stand in a storehouse in a large scale transportation form for a month in summer (July). Thereafter, the bolts were removed, and the presence or the absence of adhesiveness between planographic printing plate precursors was evaluated.

Absence of adhesion is designated by “A”, and presence of adhesion is designated by “B”. Results are Shown in Table 4.

3. Evaluation of Occurrence of Rubbing Abrasion in an Autoloader

Ten sheets of the planographic printing plate precursors having the same size as that described above were set in a cassette of a Luxel T-9800CTP single autoloader without interleaving sheets, automatically supplied onto a drum, and conveyed out without exposure. After that, a developer DT-2 (diluted at 1:8) manufactured by Fuji Photo Film Co., Ltd. and a finisher FG-1 (diluted at 1:1) manufactured by Fuji Photo Film Co., Ltd. were placed into an automatic developing apparatus LP-940HII manufactured by Fuji Photo Film Co., Ltd., and the above precursors were development-treated in the apparatus at a developing temperature of 32° C. for a developing time of 12 seconds. At that time, the electrical conductivity of the developer was 43 mS/cm. The developed planographic printing plates were observed visually, and occurrence of rubbing abrasion due to loading and unloading was evaluated.

The absence of occurrence of rubbing abrasion is designated by “A”, and the presence of occurrence of rubbing abrasion is designated by “B”. Results are shown in Table 4.

TABLE 4

| | | High humidity | Autoloader |
|---|---|---|---|
| | Transportation rubbing | adhesiveness | abrasion |
| | abrasion evaluation | evaluation | evaluation |
| Example 1 | A | A | A |
| Example 2 | A | A | A |
| Example 3 | A | A | A |
| Example 4 | A | A | A |
| Example 5 | A | A | A |
| Example 6 | A | A | A |
| Example 7 | A | A | A |
| Example 8 | A | A | A |
| Comparative | B | A | B |
| Example 1 | | | |
| Comparative | A | A | B |
| Example 2 | | | |
| Comparative | A | A | B |
| Example 3 | | | |
| Comparative | A | B | A |
| Example 4 | | | |
| Comparative | B | A | A |
| Example 5 | | | |

As shown in Table 4, the infrared-sensitive planographic printing plate precursors of Examples 1 to 8 are excellent in transportation suitability and storage suitability even when stacked and packaged without interleaving sheets, and at the same time, are excellent in suitability for a light exposure apparatus equipped with an autoloader.

TABLE 5

| | | | Transpor- | | |
|---|---|---|---|---|---|
| | | | tation | | |
| | Organic | | rubbing | High humidity | Autoloader |
| | polymer layer | | abrasion | adhesiveness | abrasion |
| | thickness | | evaluation | evaluation | evaluation |
| Example 11 | 1 | μm | A | A | A |
| | 10 | μm | A | A | A |
| | 20 | μm | A | A | A |
| Example 12 | 1 | μm | A | A | A |
| | 10 | μm | A | A | A |
| | 20 | μm | A | A | A |
| Example 13 | 1 | μm | A | A | A |
| | 10 | μm | A | A | A |
| | 20 | μm | A | A | A |
| Example 14 | 1 | μm | A | A | A |
| | 10 | μm | A | A | A |
| | 20 | μm | A | A | A |
| Example 15 | 1 | μm | A | A | A |
| | 10 | μm | A | A | A |
| | 20 | μm | A | A | A |
| Example 16 | 1 | μm | A | A | A |
| | 10 | μm | A | A | A |
| | 20 | μm | A | A | A |
| Comparative | — | | B | A | B |
| Example 11 | | | | | |
| Comparative | 1 | μm | A | A | B |
| Example 12 | 10 | μm | A | A | B |
| | 20 | μm | A | A | B |
| Comparative | 1 | μm | B | A | B |
| Example 13 | 10 | μm | B | A | B |
| | 20 | μm | B | A | B |

| | | | | |
|---|---|---|---|---|
| Comparative | — | A | B | A |
| Example 14 | | | | |

As shown in Table 5, the infrared-sensitive planographic printing plate precursors of Examples 11 to 16 are excellent in transportation suitability and storage suitability even when stacked and packaged without interleaving sheets, and at the same time, are excellent in suitability for a light exposure apparatus equipped with an autoloader.

TABLE 6

| | Transportation rubbing | Autoloader abrasion |
|---|---|---|
| | abrasion evaluation | evaluation |
| Example 21 | A | A |
| Example 22 | A | A |
| Example 23 | A | A |
| Example 24 | A | A |
| Example 25 | A | A |
| Example 26 | A | A |
| Example 27 | A | A |
| Example 28 | A | A |
| Example 29 | A | A |
| Example 30 | A | A |
| Example 31 | A | A |
| Example 32 | A | A |
| Example 33 | A | A |
| Example 34 | A | A |
| Comparative | B | B |
| Example 21 | | |
| Comparative | B | B |
| Example 22 | | |
| Comparative | B | A |
| Example 23 | | |
| Comparative | B | B |
| Example 24 | | |
| Comparative | B | A |
| Example 25 | | |

As shown in Table 6, in the infrared-sensitive planographic printing plate precursors of Examples 21 to 34, abrasion of a recording layer due to transportation is not observed even when stacked and packaged without interleaving sheets, and thus the precursors are excellent in transportation suitability and storage suitability, and at the same time, are excellent in suitability for a light exposure apparatus equipped with an autoloader.

The present invention provides at least the following embodiments 1 to 20.

1. An infrared-sensitive planographic printing plate precursor comprising:

a support;

a recording layer on one surface of the support, which recording layer contains a water-insoluble and alkali-soluble resin, an infrared absorber and a long-chain alkyl group-containing polymer, and is capable of forming an image by infrared irradiation; and

a back coating layer on the other surface of the support, which back coating layer contains an organic polymer and has a thickness of 0.3 μm or more.

2. The infrared-sensitive planographic printing plate precursor of embodiment 1, wherein:

the recording layer has a multi-layered structure comprising a lower layer containing the water-insoluble and alkali-soluble resin, and an uppermost layer containing the water-insoluble and alkali-soluble resin and the long-chain alkyl group-containing polymer; and

at least one of the lower layer and/or the uppermost layer contains the infrared absorber.

3. The infrared-sensitive planographic printing plate precursor of embodiment 1, wherein the long-chain alkyl group-containing polymer is a copolymer of at least a monomer having a long-chain alkyl group and a vinyl monomer having a carboxyl group.

4. The infrared-sensitive planographic printing plate precursor of embodiment 1, wherein a long-chain alkyl group contained in the long-chain alkyl group-containing polymer has 6 or more carbon atoms.

5. The infrared-sensitive planographic printing plate precursor of embodiment 1, wherein the recording layer contains particles of the long-chain alkyl group-containing polymer, and projections are formed of the particles on a surface of the recording layer.

6. The infrared-sensitive planographic printing plate precursor of embodiment 5, wherein an average particle diameter of the particles is 0.05 to 50 μm.

7. The infrared-sensitive planographic printing plate precursor of embodiment 1, wherein the recording layer contains the long-chain alkyl group-containing polymer in an amount of 0.5 to 30% by mass based on the total solid matter of the recording layer.

8. An infrared-sensitive planographic printing plate precursor comprising:

a support;

a recording layer on one surface of the support, which recording layer contains a water-insoluble and alkali-soluble resin and an infrared absorber, and is capable of forming an image by infrared irradiation; and

an organic polymer layer on the other surface of the support, which organic polymer layer contains a long-chain alkyl group-containing polymer and an organic polymer that is different from the long-chain alkyl group-containing polymer.

9. The infrared-sensitive planographic printing plate precursor of embodiment 8, wherein the recording layer has a multi-layered structure including a layer nearest to the support and a layer furthest from the support, and at least one of the layer nearest to the support and/or the layer furthest from the support contains the infrared absorber.

10. The infrared-sensitive planographic printing plate precursor of embodiment 8, wherein the long-chain alkyl group-containing polymer is a copolymer of at least a monomer having a long-chain alkyl group and a vinyl monomer having a carboxyl group.

11. The infrared-sensitive planographic printing plate precursor of embodiment 8, wherein a long-chain alkyl group contained in the long-chain alkyl group-containing polymer has 6 or more carbon atoms.

12. The infrared-sensitive planographic printing plate precursor of embodiment 8, wherein the organic polymer layer contains particles of the long-chain alkyl group-containing polymer, and projections are formed of the particles on a surface of the organic polymer layer.

13. The infrared-sensitive planographic printing plate precursor of embodiment 12, wherein an average particle diameter of the particles is 0.05 to 50 μm.

14. The infrared-sensitive planographic printing plate precursor of embodiment 8, wherein the organic polymer layer contains the long-chain alkyl group-containing polymer in an amount of 0.01 to 30% by mass based on the total solid matter of the organic polymer layer.

15. An infrared-sensitive planographic printing plate precursor comprising:

a support;

a recording layer on one surface of the support, which recording layer contains a water-insoluble and alkali-soluble resin and an infrared absorber, and is capable of forming an image by infrared irradiation; and

an organic polymer layer on the other surface of the support,

wherein the precursor comprises a matte surface on at least one of a surface of the recording layer and/or a surface of the organic polymer layer.

16. The infrared-sensitive planographic printing plate precursor of embodiment 15, wherein the recording layer has a multi-layered structure.

17. The infrared-sensitive planographic printing plate precursor of embodiment 15, wherein the matte surface is a surface with fine projections.

18. The infrared-sensitive planographic printing plate precursor of embodiment 17, wherein an average diameter of the fine projections is 0.1 to 50 μm.

19. The infrared-sensitive planographic printing plate precursor of embodiment 17, wherein the fine projections contain a resin.

20. The infrared-sensitive planographic printing plate precursor of embodiment 17, wherein a density of the fine projections is 1 to 1000/mm².

Therefore, according to the invention, an infrared-sensitive positive-type planographic printing plate precursor, in which rubbing abrasion due to transportation or adhesion problems during storage in a recording layer is not caused even when stacked without using interleaving sheets, and which is suitably used in a light exposure apparatus equipped with an autoloader, can be provided.

What is claimed is:

1. An infrared-sensitive planographic printing plate precursor comprising:
a support;
a recording layer on one surface of the support, which recording layer contains a water-insoluble and alkali-soluble resin, an infrared absorber and a long-chain alkyl group-containing polymer, and is capable of forming an image by infrared irradiation; and
a back coating layer on the other surface of the support, which back coating layer contains an organic polymer and has a thickness of 0.3 μm or more.

2. The infrared-sensitive planographic printing plate precursor of claim 1, wherein:
the recording layer has a multi-layered structure comprising a lower layer containing the water-insoluble and alkali-soluble resin, and an uppermost layer containing the water-insoluble and alkali-soluble resin and the long-chain alkyl group-containing polymer; and
at least one of the lower layer and/or the uppermost layer contains the infrared absorber.

3. The infrared-sensitive planographic printing plate precursor of claim 1, wherein the long-chain alkyl group-containing polymer is a copolymer of at least a monomer having a long-chain alkyl group and a vinyl monomer having a carboxyl group.

4. The infrared-sensitive planographic printing plate precursor of claim 1, wherein a long-chain alkyl group contained in the long-chain alkyl group-containing polymer has 6 or more carbon atoms.

5. The infrared-sensitive planographic printing plate precursor of claim 1, wherein the recording layer contains particles of the long-chain alkyl group-containing polymer, and projections are formed of the particles on a surface of the recording layer.

6. The infrared-sensitive planographic printing plate precursor of claim 5, wherein an average particle diameter of the particles is 0.05 to 50 μm.

7. The infrared-sensitive planographic printing plate precursor of claim 1, wherein the recording layer contains the long-chain alkyl group-containing polymer in an amount of 0.5 to 30% by mass based on the total solid matter of the recording layer.

8. An infrared-sensitive planographic printing plates precursor comprising:
a support;
a recording layer on one surface of the support, which recording layer contains a water-insoluble and alkali-soluble resin and an infrared absorber, and is capable of forming an image by infrared irradiation; and
an organic polymer layer on the other surface of the support, which organic polymer layer contains a long-chain alkyl group-containing polymer and an organic polymer that is different from the long-chain alkyl group-containing polymer.

9. The infrared-sensitive planographic printing plate precursor of claim 8, wherein the recording layer has a multi-layered structure including a layer nearest to the support and a layer furthest from the support, and at least one of the layer nearest to the support and/or the layer furthest from the support contains the infrared absorber.

10. The infrared-sensitive planographic printing plate precursor of claim 8, wherein the long-chain alkyl group-containing polymer is a copolymer of at least a monomer having a long-chain alkyl group and a vinyl monomer having a carboxyl group.

11. The infrared-sensitive planographic printing plate precursor of claim 8, wherein a long-chain alkyl group contained in the long-chain alkyl group-containing polymer has 6 or more carbon atoms.

12. The infrared-sensitive planographic printing plate precursor of claim 8, wherein the organic polymer layer contains particles of the long-chain alkyl group-containing polymer, and projections are formed of the particles on a surface of the organic polymer layer.

13. The infrared-sensitive planographic printing plate precursor of claim 12, wherein an average particle diameter of the particles is 0.05 to 50 μm.

14. The infrared-sensitive planographic printing plate precursor of claim 8, wherein the organic polymer layer contains the long-chain alkyl group-containing polymer in an amount of 0.01 to 30% by mass based on the total solid matter of the organic polymer layer.

15. An infrared-sensitive planographic printing plate precursor comprising:
a support;
a recording layer on one surface of the support, which recording layer contains a water-insoluble and alkali-soluble resin and an infrared absorber, and is capable of forming an image by infrared irradiation; and
an organic polymer layer on the other surface of the support,
wherein the precursor comprises a matte surface on at least one of a surface of the recording layer and/or a surface of the organic polymer layer.

16. The infrared-sensitive planographic printing plate precursor of claim 15, wherein the recording layer has a multi-layered structure.

17. The infrared-sensitive planographic printing plate precursor of claim 15, wherein the matte surface is a surface with fine projections.

18. The infrared-sensitive planographic printing plate precursor of claim 17, wherein an average diameter of the fine projections is 0.1 to 50 μm.

19. The infrared-sensitive planographic printing plate precursor of claim 17, wherein the fine projections contain a resin.

20. The infrared-sensitive planographic printing plate precursor of claim 17, wherein a density of the fine projections is 1 to 1000/mm².
